(19) United States
(12) Patent Application Publication
(10) Pub. No.: US 2014/0104724 A1
(43) Pub. Date: Apr. 17, 2014

(54) PERPENDICULAR MAGNETIC RECORDING MEDIUM AND MAGNETIC STORAGE DEVICE

(71) Applicant: HITACHI. LTD., Tokyo (JP)

(72) Inventors: Yoshihiro SHIROISHI, Tokyo (JP); Yoshiyuki HIRAYAMA, Tokyo (JP); Hiroshi FUKUDA, Tokyo (JP); Yo SATO, Tokyo (JP)

(73) Assignee: HITACHI, LTD., Tokyo (JP)

(21) Appl. No.: 14/055,012

(22) Filed: Oct. 16, 2013

(30) Foreign Application Priority Data
Oct. 17, 2012 (JP) 2012-230239

(51) Int. Cl. G11B 5/65

(52) U.S. Cl. CPC G11B 5/65
USPC 360/75; 428/829

(57) ABSTRACT

Provided are a magnetic recording medium suitable for use with a microwave assisted magnetic recording head and suitable for such recording and a method for manufacturing the same. A perpendicular magnetic recording medium includes a recording layer including a plurality of magnetic layers. A magnetic layer as an uppermost layer of the recording layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer. The magnetic layer as the uppermost layer includes a plurality of lamination unit layers having different composition of sub-layers at least one sub-layer among the lamination unit layers and/or a different film thickness of sub-layers at least one sub-layer among the lamination unit layers.

### CLAIM OF PRIORITY

The present application claims priority from Japanese patent application JP 2012-230239 filed on Oct. 17, 2012, the content of which is hereby incorporated by reference into this application.

### TECHNICAL FIELD

The present invention relates to a perpendicular magnetic recording medium for high density recording that is suitable for microwave assisted magnetic recording and a method for manufacturing the same, and relates to a magnetic storage device including the perpendicular magnetic recording medium mounted thereon.

### BACKGROUND ART

The growth of the Internet environment and newly provided data centers along with penetration of cloud computing have increased the amount of information generated rapidly in recent years. There is no doubt that magnetic storage devices such as a magnetic disk device (HDD) having the highest recording density and excellent bit cost play the leading role for storage in the “big-data era.” Magnetic storage devices then have to have larger capacity, and higher recording density is must to support them. To this end, research and development have been conducted actively to realize magnetic recording heads having high recording ability and high-Ku and high-Hk magnetic recording media having excellent read/write characteristics.

For a higher recording density, a perpendicular magnetic recording medium (hereinafter this may be simply referred to as a magnetic recording medium or a medium) has to have small volume V of crystalline grains. In order to achieve thermal stability of recording for a long time, the magneto crystalline anisotropic energy (Ku×V) per crystalline grain has to be sufficiently larger than the thermal agitation energy (k_{B}×T). That is, it is essential for higher recording density to perform magnetic recording on a magnetic material having high Ku (=Ms×Hk/2 where Ms: saturation magnetization, Hk: magnetic anisotropy field).

Many studies and inventions have been made for high-Ku magnetic materials. For instance, known high-Ku magnetic materials include a CoCrPt alloy, a L1₂ type Co_{0.75}Pt_{0.25} based ordered alloy, a L1₂ type (CoCr)_{0.75}Pt_{0.25} based ordered alloy, a L1₁ type Co_{0.5}Pt_{0.5} based ordered alloy, a m-D0₁₉ type Co_{0.8}Pt_{0.2} based ordered alloy, a magnetic superlattice thin film such as [CoB/Pd] or [Co/Pt], a L1₀ type FePt ordered alloy and the like.

For a magnetic recording medium including these magnetic materials, Patent Document 1 proposes a magnetic recording medium including as a recording layer a [Co/Ni] superlattice film in which a Co layer and a Ni layer are alternately and periodically stacked. Patent Document 2 proposes a perpendicular magnetic recording medium having a low noise characteristic to achieve high recording density of 30 Gb/in² or more, and the perpendicular magnetic recording medium is configured to include a two-layer structured perpendicular magnetic film, in which a perpendicular magnetic film of high Ku is provided on the upper layer side and a perpendicular magnetic film of low Ku and including crystalline grains, among which magnetic separation is promoted, is provided on the lower layer side. On the upper-layer perpendicular magnetic film, a periodic lamination film (magnetic superlattice thin film) of 0.1 nm to 5 nm in thickness including Pt, Pd, Ir, Re, Ru or an alloy including these elements as a main component, Co or a Co alloy, or Pt, Pd, Ir, Re, Ru or an alloy including these elements as a main component, or an amorphous magnetic material film including a rare-earth element is provided, thus reducing reverse magnetic domains existing at the surface of the medium and micro magnetization fluctuation of the medium.

Meanwhile, as a structure based on a different concept from the above, an exchange coupled composite (ECC) medium is known (Patent Document 3), in which a granular-structured CoCrPt alloy film of low Hk is stacked on a granular-structured [Co/Pt] magnetic superlattice thin film having high magnetic anisotropy field, thus making a grain boundary width on the medium surface side smaller than a grain boundary width on the substrate side. According to this structure, the recordability for a high-density medium is greatly improved in the surface-side recording layer (magnetic layer) having a smaller grain boundary width by appropriately controlling the exchange interaction between magnetic grains, and so such a structure has been a standard structure for a conventional perpendicular magnetic recording medium (of 1 Tb/in² or lower).

However, a conventional perpendicular magnetic recording technique using such an ECC medium and a main pole-shield type magnetic recording head is approaching to the practical limit of 1 Tb/in². Then microwave assisted magnetic recording (MAMR) is proposed as a new high-density recording technique, in which high-frequency magnetic field in a microwave band is applied to a magnetic recording medium so as to excite precession movement of the medium magnetization for magnetic recording on a high-Hk medium while reducing the switching field. Recently a practical microstructured spin-torque type high-frequency oscillation element (STO: Spin Torque Oscillator) is proposed by Patent Document 4, for example, which is the application of a spintronics technique to generate high-frequency magnetic field by rotating spins of a high-frequency magnetic field generation layer (FGL: Field Generation Layer) rapidly by spin torque of spins injected from a spin injection layer driven by a DC power supply. In this way, research and development are becoming active for practical microwave assisted magnetic recording.

For instance, Patent Document 5 describes a magnetic recording device as a magnetic storage device based on the microwave assisted magnetic recording, including a magnetic recording head having a main pole and a spin-flip type STO disposed adjacent to the main pole and including at least two magnetic layers of a spin injection layer and a high-frequency magnetic field generation layer, and a magnetic recording medium including two magnetic layers of a recording layer and an antenna layer. This magnetic recording medium includes the recording layer made of a high-Hk hard magnetic material suitable for high density recording and the antenna layer made of a magnetic material having lower Hk, which is formed at a position closer to the magnetic recording head than the recording layer, where the recording layer and the antenna layer ferromagnetically coupled to each other. This structure of the medium can be said to have the same configuration and be based on the same concept of an ECC medium that is typically used in a conventional perpendicular magnetic recording.

### CITATION LIST

### Patent Document

Patent Document 1: JP 3011918 B2
Patent Document 2: JP 2011-113604 A
Patent Document 3: JP 05-315135 A
Patent Document 4: U.S. Pat. No. 7,616,412 B2
Patent Document 5: JP 4960319 B2

### SUMMARY OF INVENTION

### Technical Problem

The Hk of CoCrPt alloys that are currently used as a material of media has the practical limit of about 22 kOe. For larger Hk, the material has to be processed at a film-formation temperature from 300 to 700° C., followed by a further heat treatment to order almost the entire atomic arrangement. However, such processing at about 300° C. or higher causes crystallization and magnetization of NiP, and so a NiP plated Al alloy substrate cannot be used, and a glass substrate also may be deformed.

Meanwhile, the above-mentioned magnetic superlattice film techniques (Patent Documents 1 and 2) propose two types of ultra-thin magnetic layers (sub-layers) as a lamination unit (corresponding to one period) that are periodically laminated. This magnetic superlattice thin film, even formed at 300° C. or lower, can generate large magnetic anisotropy at the interface due to the specific property of the electronic state and the band structure at the interface. It can be considered that the magnetic superlattice lamination film as a whole can realize Hk exceeding the aforementioned limit relatively easily. Actually some magnetic films achieving magnetic anisotropy field Hk larger than that of the CoCrPt alloy have been reported, including a magnetic superlattice thin film realizing Hk of 37 kOe, which includes the periodic lamination of one to several atomic layers of Co thin layers (Co sub-layers) and one to several atomic layers of Pt thin layers (Pt sub-layers), a magnetic superlattice thin film achieving Hk of 29.2 kOe, which includes B and CoO₂ in addition to Co so as to have a columnar structure (granular structure), and an ECC medium using the same (Patent Document 3).

Then, to evaluate the read/write characteristics of these high-Hk media, a microwave assisted magnetic recording head shown in FIG. 1 described later was prepared as a prototype, and its high-frequency oscillation characteristics were evaluated. The result shows that, when current (bias recording current) at −60˜60 mA was applied to a recording pole, the oscillation frequency changed about ±10% in accordance with the recording current. Herein, the most of frequency changes included a change when the sign of the current changes (the polarity of the STO driving magnetic field changes). Further considering variations of the oscillation frequency for each magnetic recording head, then large oscillation frequency distribution up to ±25% was found as a whole.

Next, ECC media having various structures and characteristics were prepared as a prototype using these high-Hk magnetic superlattice thin films, and their characteristics were evaluated using the above-mentioned microwave assisted magnetic recording head whose read/write characteristics were selected and optimized beforehand. The result shows that the gain from the recording when the high-frequency oscillation element was turned OFF was only about 0.5 dB, and the recording track width also was substantially determined by the main pole width. Selective magnetization reversal function (microwave assisting effect described later) of the high-frequency oscillation element was hardly found, and it was difficult to increase the recording density limit to 1 Tb/in² or higher even when microwave assisted recording (MAMR) was performed for the ECC medium including the high-Hk magnetic superlattice thin films.

Then it is an object of the present invention to find the reason of a failure in achieving a remarkable MAMR effect (effect to increase the recording density limit) for ECC media and its counter measure, to provide a magnetic recording medium having high Hk necessary for higher recording density of 1 Tb/in² or higher, even subjected to film-formation at 300° C. or lower as the substrate temperature, and suitable for a microwave assisted magnetic recording head having distribution in the oscillation frequency and such a recording method and a method for manufacturing the magnetic recording medium, and to provide a large-capacity magnetic storage device and a method for controlling the same.

### Solution to Problem

A perpendicular magnetic recording medium of the present invention includes a recording layer including a plurality of magnetic layers. A magnetic layer as an uppermost layer of the recording layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer, and the magnetic layer as the uppermost layer includes a plurality of lamination unit layers each having different composition of sub-layers or a different film thickness of sub-layers.

A magnetic storage device of the present invention includes: the magnetic recording medium of the present invention; a recording head including: a recording pole to generate recording field to write information on the magnetic recording medium; a high frequency magnetic field oscillation element disposed in the vicinity of the recording pole; and a magnetic read element to read information from the magnetic recording medium; and a controller that controls a recording operation by the recording pole and the high frequency magnetic field oscillation element and a reading operation by the magnetic read element.

A method for manufacturing the perpendicular magnetic recording medium of the present invention includes the steps of: forming the first sub-layer using a first multi-sputtering target; and forming the second sub-layer using a second multi-sputtering target. An interval between ending time of the step to form the first sub-layer and starting time of the step to form the second sub-layer is 0.5% or longer of shorter time between film formation time of the first sub-layer and film formation time of the second sub-layer.

Another method for manufacturing the perpendicular magnetic recording medium of the present invention includes the steps of: forming a first sub-layer by co-sputtering of a first sputtering target including a major element of the first sub-layer as a major component and a second sputtering target including a non-magnetic material including an oxide, a nitride, a carbide or a boride of at least one type of element selected from the group consisting of Si, Ta, Ti, Zr and Hf or a mixture of the foregoing; and forming the second sub-layer by co-sputtering of a third sputtering target including a major element of the second sub-layer as a major component and the second sputtering target. In the step of forming the first-sub layer, film formation starting time by the second sputtering target is later than film formation starting time by the first sputtering target, and film formation ending time by the second sputtering target is earlier than film formation ending time by the first sputtering target. In the step of forming the second-sub layer, film formation starting time by the second sputtering target is later than film formation starting time by the third sputtering target, and film formation ending time by the second sputtering target is earlier than film formation ending time by the third sputtering target.

### Advantageous Effects of Invention

A magnetic recording medium of the present invention includes a magnetic superlattice thin film as an uppermost layer having two or more types of lamination unit layers and such Hk values. Such a recording medium used with a microwave assisted magnetic recording head having greatly attenuation in the microwave assisted magnetic field intensity in the thickness direction of the medium and having oscillation frequency varying with bias recording current and having large fluctuations by mass production achieves a high selective magnetization reversal function and a high assist effect. Therefore the magnetic recording medium of the present invention enables recording of information at high yield, a narrow track width and high S/N, and so a magnetic storage device of a microwave assisted recording type with high density, large capacity and high reliability can be provided at high manufacturing yield.

Problems, configurations, and advantageous effects other than those described above will be made clear by the following description of embodiments.

### BRIEF DESCRIPTION OF DRAWINGS

FIG. 1 is a conceptual diagram to show exemplary microwave assisted magnetic recording head and perpendicular magnetic recording medium.

FIG. 2 is a schematic bottom view of a microwave assisted magnetic recording head in the vicinity of a recording gap.

FIG. 3 is a schematic cross-sectional view taken along the line AA′ of FIG. 2.

FIG. 4 describes quasi-static type microwave assisted magnetic recording procedure of a multilayer medium.

FIG. 5 describes resonant type microwave assisted magnetic recording procedure of a multilayer medium.

FIG. 6 describes forced oscillation type microwave assisted magnetic recording procedure of a multilayer medium.

FIG. 7 schematically shows a ring-shaped multi cathode for forming a magnetic multilayer film.

FIG. 8 schematically shows a rotatable cathode for forming a magnetic multilayer film.

FIG. 9 shows magnetic characteristics of a magnetic superlattice film.

FIG. 10 shows magnetic characteristics of a magnetic superlattice film.

FIG. 11 shows magnetic characteristics of a magnetic superlattice film.

FIG. 12 schematically shows a film formation sequence by a multi-target sputtering apparatus.

FIG. 13 schematically shows another film formation sequence by a multi-target sputtering apparatus.

FIG. 14 is a schematic cross-sectional view of a magnetic superlattice thin film including two types of lamination units.

FIG. 15 shows a relationship of anisotropy energy and a lattice constant of an underlayer (intermediate layer).

FIG. 16 is a conceptual diagram of a three-layer structured medium, where the uppermost magnetic layer has the least grain boundary segregation.

FIG. 17 is another conceptual diagram of a three-layer structured medium, where the uppermost magnetic layer has the least grain boundary segregation.

FIG. 18 shows exemplary structures of a three-layer structured medium having a nearly monotonic decrease type Hk distribution.

FIG. 19 shows a structure of a STO having intense high frequency magnetic field.

FIG. 20 is a conceptual diagram of a three-layer structured medium, where the intermediate magnetic layer has the least grain boundary segregation.

FIG. 21 is another conceptual diagram of a three-layer structured medium, where the intermediate magnetic layer has the least grain boundary segregation.

FIG. 22 shows exemplary structures of a three-layer structured medium having a nearly V-shaped Hk distribution.

FIG. 23 is another conceptual diagram to show exemplary microwave assisted magnetic recording head and perpendicular magnetic recording medium.

FIG. 24 is a schematic cross-sectional view of a STO having intense high-frequency magnetic field component in the STO travelling direction.

FIG. 25 is a conceptual diagram of a three-layer structured medium, where the lowermost magnetic layer has the least grain boundary segregation.

FIG. 26 is another conceptual diagram of a three-layer structured medium, where the lowermost magnetic layer has the least grain boundary segregation.

FIG. 27 shows exemplary structures of a three-layer structured medium having a nearly uniform Hk distribution.

FIG. 28 shows exemplary structures of a two-layer structured medium of the present invention.

FIG. 29 shows exemplary structures of four-layer and five-layer structured media of the present invention.

FIG. 30 is a conceptual diagram showing an exemplary configuration of a magnetic storage device.

### DESCRIPTION OF EMBODIMENTS

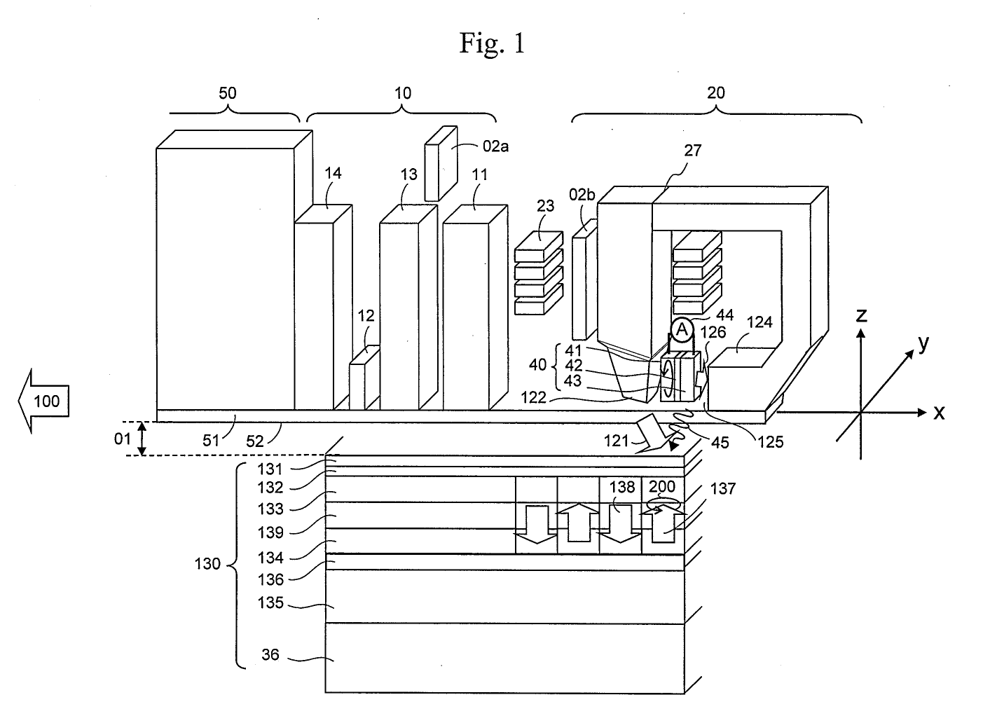

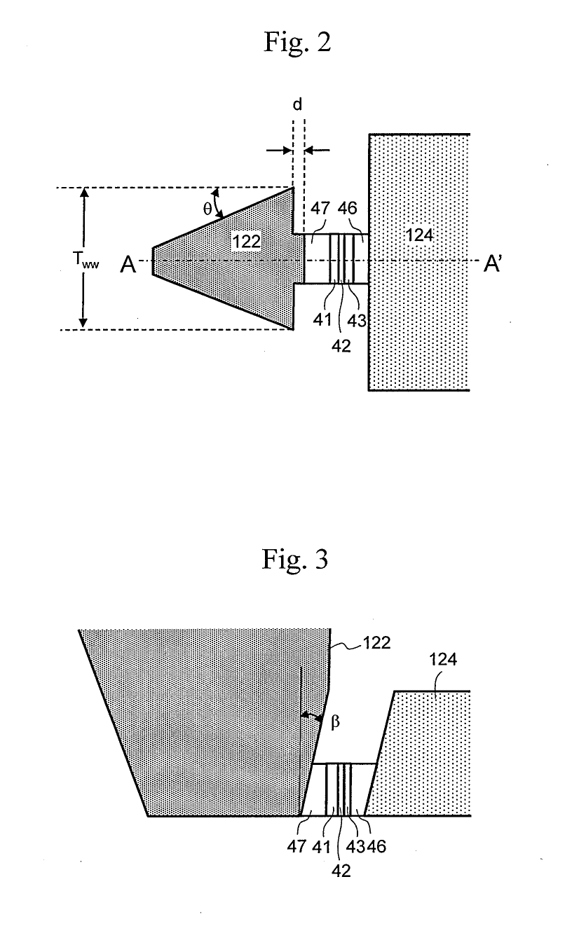

To begin with, the following describes microwave assisted magnetic recording (MAMR) using a magnetic recording medium and a microwave assisted magnetic recording head having a configuration as shown in FIGS. 1 to 3, problems of the combination of an ECC medium and the MAMR and a result of detailed considerations for its countermeasure by simulation. FIG. 1 is a conceptual diagram to show exemplary microwave assisted magnetic recording head and perpendicular magnetic recording medium. FIG. 2 schematically shows a spin-torque type high-frequency oscillation element viewed from the nearby ABS face. FIG. 3 is a schematic cross-sectional view taken along the line AA′ of FIG. 2. Detailed structures of a microwave assisted magnetic recording head and a perpendicular magnetic recording medium are described later by way of examples. For the microwave assisted magnetic recording, recording is performed on a magnetic recording medium 130 by high-frequency magnetic field 45 from a high-frequency oscillation element (STO) 40 and bias recording field 121 from recording poles 122 and 124, and reading is performed by a read element 10.

(Recording Procedure to a Perpendicular Magnetic Recording Medium)

Firstly, for the perpendicular magnetic recording medium of FIG. 1 including three-layered magnetic recording layers 133, 139 and 134 as a recording layer, genetic algorithm (GA) and LLG analysis are combined using a 3-spin model and a 4-spin model, and the following describes a result of an automatic analysis of every feasible combination of parameters for the optimum solution for the recording procedure and for the magnetic recording head and the medium system. Herein, the 3-spin model refers to a conventional perpendicular magnetic recording model to a three-layered medium including the lamination of three spins of 4-nm square (or 4-nm thickness). The 4-spin model refers to a recording model in which the degree of freedom 1 for spins of the high-frequency oscillation element is added to conventional perpendicular magnetic recording medium (3-spin model) in the vertical direction, thus setting the degree of spin freedom at 4 (microwave assisted recording to a three-layered medium). Herein, the gap (magnetic spacing) 01 between the high-frequency oscillation element and the surface of the medium was 8 nm.

As a result, the reversal procedure of medium magnetization 137 in any case can be divided into two stages of (1) the step where the magnetization direction is brought closer to the medium plane (xy plane), and (2) medium magnetization becoming substantially parallel to the medium plane receives torque from the in-plane component of the perpendicular recording field for reversal. As a result of a detailed analysis of the GA, thermal stability, i.e., the limit of recording density is determined by whether or not the procedure of (1) is performed effectively or not. It was further found that the assisting effects and functions of the high-frequency magnetic field include (A) the function to contribute for improved thermal stability of the medium and for improved recording density limit, and (B) the selective magnetization reversal function to enable a magnetization reversal region of a minute region to be determined by high-frequency magnetic field only. It was further found that the latter selective magnetization reversal can be obtained by assisting any one of (1) and (2).

Especially according to a 3-spin model corresponding to conventional perpendicular magnetic recording, a medium having high thermal stability and high effect to improve the recording density limit includes three types of (a) a forward characteristic graded medium (graded medium: Ku increases on a lower side in the recording layer), (b) a medium having a reversed V-shaped distribution structure where the intermediate layer has the maximum Hk, and (c) a medium where Hk at the lower layer increases in (b), each of which has an ECC structure having low Hk at the surface of the medium. Herein, Ku increases in the order of (a), (b) and (c), and the distribution of Ms is substantially constant. This is because a conventional reversal mechanism in a multi-layered medium is based on quasi-static propagation of magnetization reversal via exchange-coupling field and demagnetization field, and so once the outermost layer can be reversed, then magnetization reversal of the second and the third magnetic layers having higher Hk than that of the outermost layer can be generated by the recording field by using the help of the exchange-coupling field and the demagnetization field. That is, it was reconfirmed that, in the case of conventional perpendicular magnetic recording using a main pole/shield structured magnetic recording head, a magnetic recording medium having an ECC structure having the smallest Hk at the outermost layer is the best.

On the other hand, in the case of a 4-spin model corresponding to microwave assisted recording to a three-layered medium, a medium structure corresponding to an ECC medium having small Hk at the outermost layer will implement the aforementioned procedure (1) in the quasi-static procedure where perpendicular magnetic recording is performed by a recording pole in the microwave assisted recording as well. Then, although a magnetization reversal region can be decided by selective magnetization reversal of the STO when magnetization reversal in the above procedure (2) is implemented by a y-component of the high frequency magnetic field, thermal stability and limit for recording density cannot be improved.

That is, although microwave assisted recording has the excellent selective magnetization reversal function capable of deciding the magnetization reversal micro area by high-frequency magnetic field only, such a technique is considered as an alternative technique of the ECC medium from the viewpoint of improvement of the limit for recording density (thermal stability of the medium). Therefore, it was clarified that a large effect to improve the limit for recording density cannot be expected from the recording on an ECC medium by microwave assisted recording as described in the above about the problem to be solved by the present invention. That is, in order to improve thermal stability and limit for recording density, it is essential to implement the magnetization reversal procedure of the above (1) with high-frequency magnetic field.

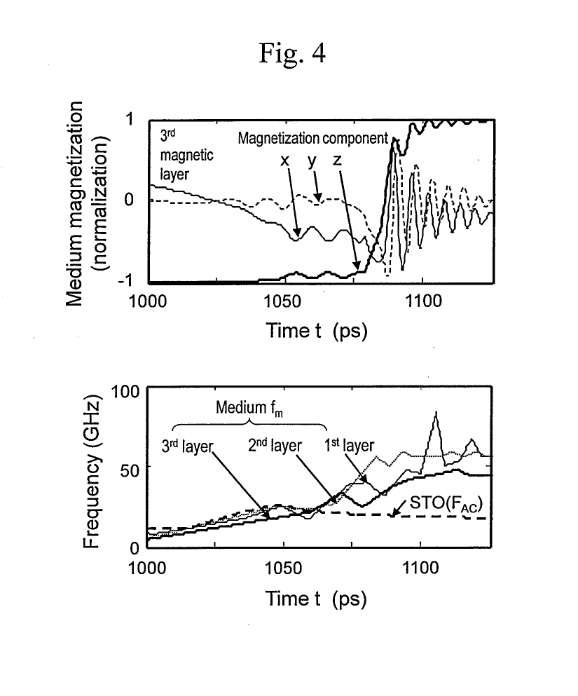

Then, as a solution for the medium, from which the effect to improve thermal stability and limit for recording density, the solution for medium to allow at least the first magnetic layer (133 of FIG. 1) to be reversed by the assist from the high-frequency magnetic field was found by GA, and further the details of the reversal mechanism were analyzed. As a result, it was clarified that the procedure for subsequent magnetization reversal of the second magnetic layer 139 and the third magnetic layer 134 includes three types of (i) quasi-static, (ii) resonant and (iii) forced oscillation shown in FIGS. (4) to (6). Herein in FIGS. 4 to 6, the upper part of the drawing shows a time change (time dependency of x, y and z components of the magnetization) of the magnetization of the third magnetic layer (the lowest layer) when bias recording field H_{DC} is reversed during the application of high-frequency magnetic field, and the lower part shows a time change of oscillation frequency F_{AC} of the high-frequency magnetic field oscillation element and the precession movement frequency fₘ of the magnetization of the first, the second and the third magnetic layers of the medium recording layer.

(i) Damping-Dominated Quasi-Static Magnetization Reversal (FIG. 4)

The reversal mechanism at each layer is as follows.

The first magnetic layer: Due to influences from reduced effective field in the medium and forced oscillation by high-frequency magnetic field, precession movement of the medium magnetization and the frequency of the high-frequency magnetic field are synchronized, and magnetization reversal occurs by assisting of the high-frequency magnetic field.

The second and third magnetic layers: Reversal occurs by quasi-static propagation via exchange-coupling field and demagnetization field.

Along with the magnetization reversal at the upper layer, the exchanging magnetic field is reversed, and the effective magnetic field changes rapidly. Then, the medium magnetization is inclined toward x-direction following this due to damping, but cannot follow that and is inclined toward y-direction due to torque in y-direction acting on the medium magnetization generated (quasi-static). Then the magnetization direction approaches the medium x-y plane while performing precession movement. High-frequency magnetic field is not involved in this mechanism.

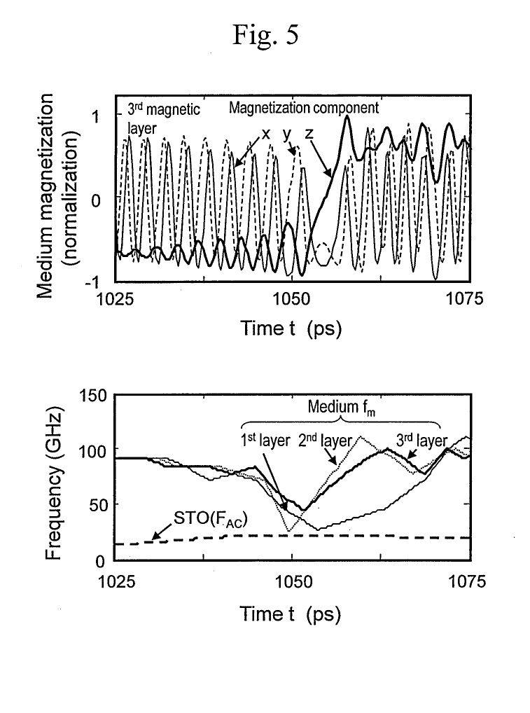

(ii) Resonant Type Magnetization Reversal (FIG. 5)

The reversal mechanism at each layer is as follows.

The first magnetic layer: Due to influences from reduced effective magnetic field in the medium and forced oscillation by high-frequency magnetic field, precession movement of the medium magnetization and the frequency of the high-frequency magnetic field are synchronized, and reversal occurs by assisting of the high-frequency magnetic field.

The second and third magnetic layers: Magnetization oscillation increases like resonance, and when precession movement becomes slow, reversal occurs by head magnetic field.

Due to resonance between layers (displacement in the precession movement symmetry that is synchronized between layers is positive fed back to vibration in z-direction and is amplified), vibration amplitude in z-direction of the medium magnetization increases, and the medium magnetization direction approaches the medium plane. High-frequency magnetic field is not involved in this mechanism as well. Presumably this phenomenon hardly occurs in the actual medium having magnetic anisotropic dispersion or the like.

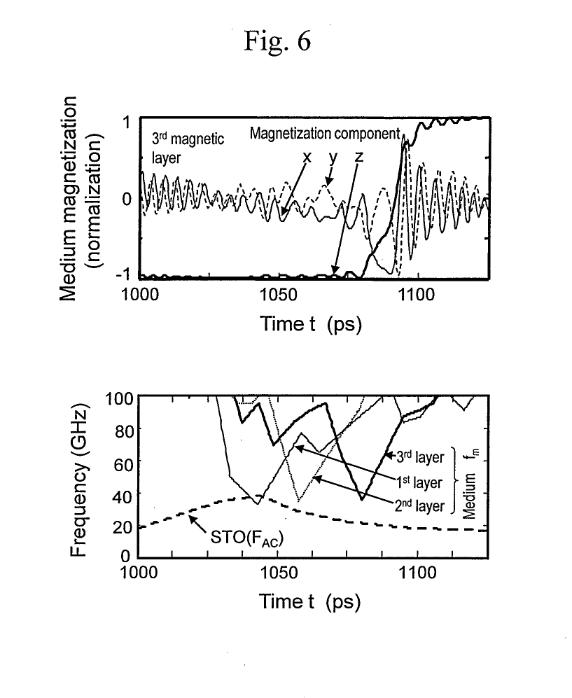

(iii) Forced Oscillation Type Magnetization Reversal (FIG. 6)

The reversal mechanism at each layer is as follows.

The first magnetic layer: Due to influences from reduced effective magnetic field in the medium and forced oscillation by high-frequency magnetic field, precession movement of the medium magnetization and the frequency of the high-frequency magnetic field are synchronized, and reversal occurs by assisting of the high-frequency magnetic field.

The second and third magnetic layers: Precession movement stops in the reversal procedure, and reversal occurs by assisting of forced oscillation due to the high-frequency magnetic field.

Intense high-frequency magnetic field acts independently at each layer. Magnetization at each layer generates forced oscillation due to high-frequency magnetic field, and the magnetization direction approaches the medium plane.

In order to improve thermal stability and recording density limit (function (A)), the procedure (1) has to be assisted by high-frequency magnetic field, and especially at a lower layer part of the medium, the recording procedure of (1) has to be implemented (in addition to any interlayer interaction). In the case of a medium whose reversal mechanism is dominated by the above (i) and (ii) mechanisms, high-frequency magnetic field does not contribute to the reversal at a lower layer of the medium in FIGS. 4 and 5, and so the high-frequency magnetic field applied thereto does not lead to improvement in the thermal stability and the recording density limit. On the other hand, in the case of (iii) of FIG. 6, since high-frequency magnetic field acts on each layer independently, thermal stability and recording density limit thereof can be improved most effectively, and so it was found that this mechanism can provide the best medium structure for microwave assisted recording. Then, the following describes more detailed studies on the feature of (iii).

In order to obtain thermal stability and improve recording density limit, the medium has to have high Hk. To this end, the frequency of the precession movement thereof becomes high at about a few tens GHz or higher. Increased high-frequency magnetic field intensity will implement the medium magnetization reversal mechanism of (iii) effectively as described below. That is, in the magnetization reversal mechanism of (iii), the medium magnetization 137 performs precession movement even when the recording field 121 is applied thereto. Then when the medium magnetization is inclined toward the in-plane direction due to reversal of the recording field, the effective magnetic field of the medium decreases and the frequency fₘ of the precession movement is lowered. Further, when the high-frequency magnetic field 45 causes the forced oscillation of the medium magnetization, the precession movement frequency becomes equal to the oscillation frequency F_{AC} of the high-frequency magnetic field oscillation element at the valley of the precession movement frequency fₘ of the medium magnetization. Then when phase matching occurs in the frequency region, the medium magnetization is reversed due to reversal torque due to the recording field and the high-frequency magnetic field. When the medium magnetization is reversed, the precession movement returns to the original frequency. In many cases, when this matching condition holds, the reversal itself ends within one period of the precession movement. Herein, this frequency change involves two factors of (a) effective magnetic field change due to a change in the inclination of the recording field 121 and the medium magnetization, and (b) magnetic interaction between FGL and the medium (forced oscillation of the medium magnetization 137 due to high-frequency magnetic field 45), and when the intensity of the high-frequency magnetic field 45 increases, the influence of (b) can be made large, so that the medium magnetization reversal mechanism of (iii) can be easily caused.

Further detailed studies on the medium magnetization reversal mechanism of (iii) using GA in the range of feasible physical property parameters of medium materials show that assist-reversal type medium structures achieving thermal stability and recording density limit better than those of a conventional ECC medium includes the following three types:

(a) Nearly Hk monotonic decrease type: medium structure having Hk distribution where Hk generally decreases from the upper layer to the lower layer of the recording layer.

(b) V-shaped Hk distribution type: medium structure, where Hk of the magnetic layer decreases once from the surface of the recording layer to the substrate side and then increases again (strong high-frequency assist effect in the vicinity of the surface and the ECC effect at a lower layer are mixed).

(c) Nearly uniform Hk type: medium structure having a flat Hk distribution closer to a single layer.

In principle, high-frequency magnetic field attenuates relatively quickly in the medium thickness direction compared with the recording field from the recording pole, and so the structure of decreasing Hk in the direction from the surface to the substrate, i.e., the structure (a) is a basic one. Meanwhile, when the first magnetic layer causes magnetization reversal by microwave assisted recording, exchange-coupling field and demagnetization field of the first magnetic layer act on the second magnetic layer, and so the effective Hk value of the second magnetic layer becomes small. When this value is smaller than the value enabling reversal with the recording field by the assist effect of the high-frequency magnetic field, the magnetization of the second magnetic layer also is reversed. Conversely, Hk of the second layer can be made higher by the value corresponding to the exchange-coupling field and the demagnetization field. The same applies for the third magnetic layer. This means that the values of Hk of the second and third magnetic layers become larger than those assumed for the case when there is no interaction of the exchange-coupling field, demagnetization field and the like, and so it was found that the Hk distribution will be the V-shaped Hk distribution type of (b) or the nearly uniform Hk type of (c) in the range of feasible physical property parameters of medium materials. Strictly speaking, the nearly Hk monotonic decrease type of (a) also reflects this effect, and the nearly Hk monotonic decrease type can be a result of raising the values of the Hk of the second and third magnetic layers. Therefore, considering the effects of the exchange-coupling field and the demagnetization field of the first magnetic layer in the magnetic recording medium whose Hk distribution is of the nearly uniform Hk type or the nearly Hk monotonic decrease type, the value of Hk of the second magnetic layer can be made larger than that of the first magnetic layer by about 10% and the value of Hk of the third magnetic layer can be made larger than that of the second magnetic layer by about 10%. As described in Examples 4 and 2, this case also is classified into the nearly uniform Hk type or the nearly Hk monotonic decrease type in the present invention.

Based on the above analysis results, studies using GA and experimental studies were conducted on materials realizing magnetic recording media of the structures (a), (b) and (c) and microstructures of magnetic layers of the media, which are suitable for microwave assisted recording when the assist magnetic field intensity in the medium thickness direction attenuates greatly (having strong head-medium spacing dependency) and its oscillation frequency has variation. As a result, it was found that a very favorable structure is a magnetic superlattice film including the lamination of sub-layers of one to several atomic layer level thickness on the outermost layer of the medium, from which intense assist magnetic field and assist effect can be obtained, which further includes at least two types of lamination units in the magnetic superlattice film so as to have a plurality of Hks at one to several atomic layer level in the thickness direction.

This structure is favorable because it can increase the probability of frequency matching and phase matching with the lamination unit having a plurality of Hk values and a plurality of precession movement frequencies fₘ when assist recording is performed using a microwave assisted magnetic recording head whose high-frequency magnetic field intensity has strong head-medium spacing dependency and whose oscillation frequency has a variation. That is, when frequency and phase matching is achieved at a certain lamination unit and so magnetization reversal occurs, the magnetization reversal will be forcibly propagated rapidly to other layers by strong exchange interaction between layers, as can be understood from the magnetization reversal mechanism of FIG. 6. This mechanism can absorb variations in oscillation frequency of the magnetic recording head and can provide a medium for high density having small switching field distribution (SFD) and such a magnetic transition region, and so the mechanism is especially preferable. Further the magnetic superlattice thin film of the present invention can be formed easily at a substrate temperature of 300° C. or lower by suppressing mixture of sub-layer materials at the interface of sub-layers having a thickness at an atomic layer level, and so such a magnetic superlattice thin film is especially preferable.

In this way, the uppermost layer (first magnetic layer) of the recording layer of the magnetic recording medium includes a magnetic superlattice made up of two types or more of lamination units, whereby the uppermost layer of the recording layer, which plays the most important role for microwave assisted recording, can have Hk distribution suitable for oscillation frequency distribution and steep attenuation of the magnetic field intensity of a microwave assisted recording head, and so such a configuration is especially preferable. Note here that although the term of magnetic superlattice is often used for a periodic structure, the term in the present specification refers to a multilayered film structure of the lamination units as well, which is also denoted by [A/B], etc. The following describes specific structures, compositions and advantageous effects of the present invention.

### Example 1

This example describes the structure and materials of a high-Hk magnetic layers and an intermediate layer (corresponding to an underlayer of the magnetic layers) for microwave assisted recording, which are obtained from the studies based on the above concept, and a method for manufacturing a magnetic recording medium.

(Method for Manufacturing Magnetic Recording Medium)

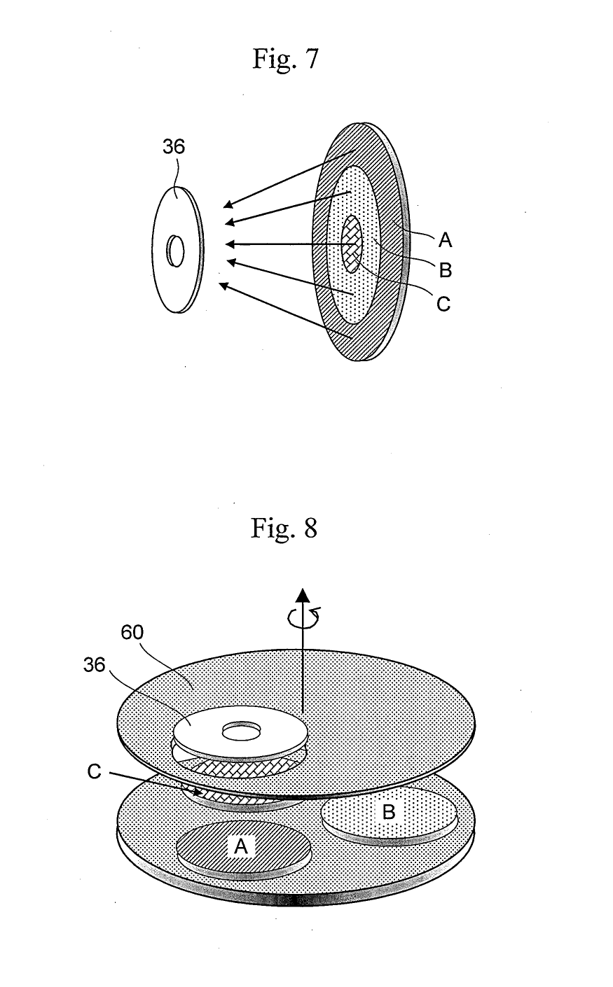

As shown in FIG. 7 or FIG. 8, a magnetic multilayered film making up a magnetic recording medium was formed on a substrate 36 by mounting a multi sputtering target including different materials of A, B and C, for example, on a ring-shaped multi cathode or a rotatable cathode. Herein, reference numeral 60 denotes a shutter rotating simultaneously with the substrate 36. FIG. 8 shows an example including one substrate, but three substrates may be used. The following describes a method for manufacturing a magnetic recording medium by a multi cathode type apparatus of FIG. 7 capable of more precise control for film formation.

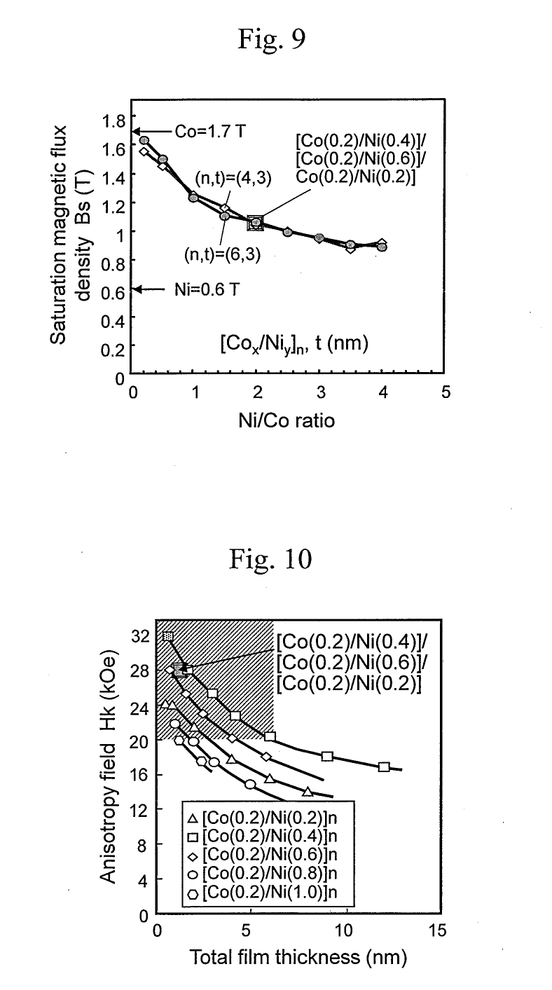

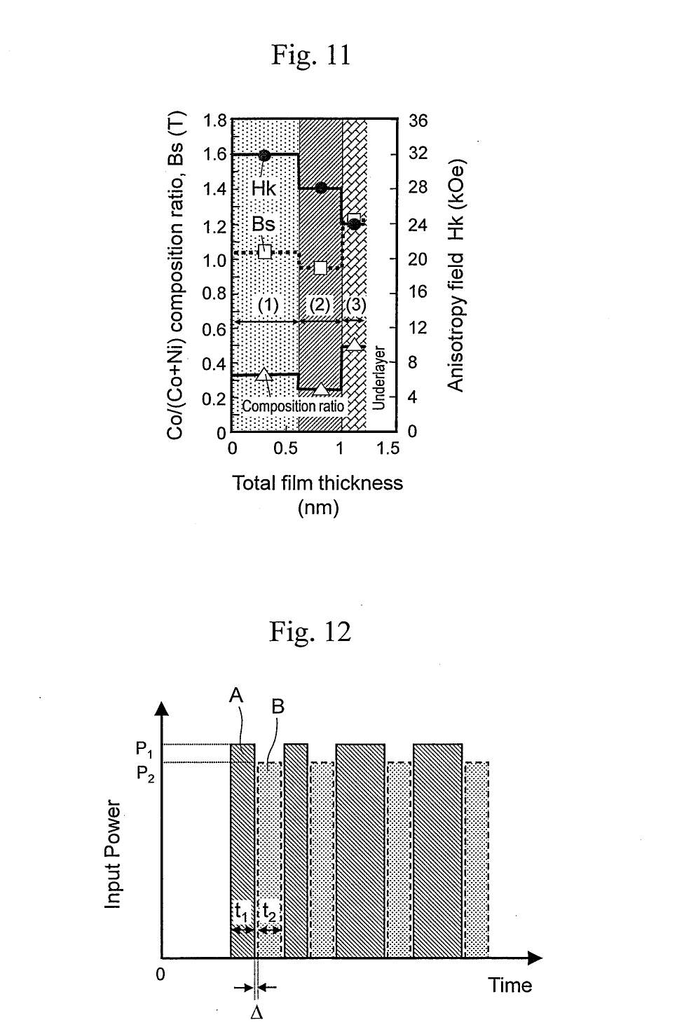

In FIG. 7, target A was Co and target B was Ni, and a substrate temperature Ts during film formation, gas pressure during film formation and applied power were variously changed, and thus magnetic superlattices including sub-layers of Co, Ni were formed (see FIGS. 9 to 11). At this time, it was found that setting the timing of turning ON and OFF of the applied power to A, B cathodes and their interval Δ (see FIG. 12) at 0.5% or more of the shorter one between the film formation time t₁ and t₂ of each layer is very important to keep the value of Hk high. It was confirmed by observing the cross-section of samples using a TEM that setting Δ at 0.5% or more prevents the mixture of sub-layer atoms at the interface of sub-layers, thus leading to a uniform interface and accordingly high magnetic anisotropy field Hk. The superlattice thin film at this time was fcc(111) oriented.

Then, Δ was set at 2%, and Ar gas pressure during film formation, the substrate temperature and the film formation rate (corresponding to the applied power) were set at 1 Pa, 100° C. and 0.2 nm/s, respectively, whereby a magnetic superlattice film including a Co sub-layer of 0.2 to 0.8 nm and a Ni sub-layer of 0.2 to 0.8 nm and having the period n=2 to 20 was formed. Herein, the underlayer used was Pt_{0.8}Ru_{0.2} of 5 nm in thickness.

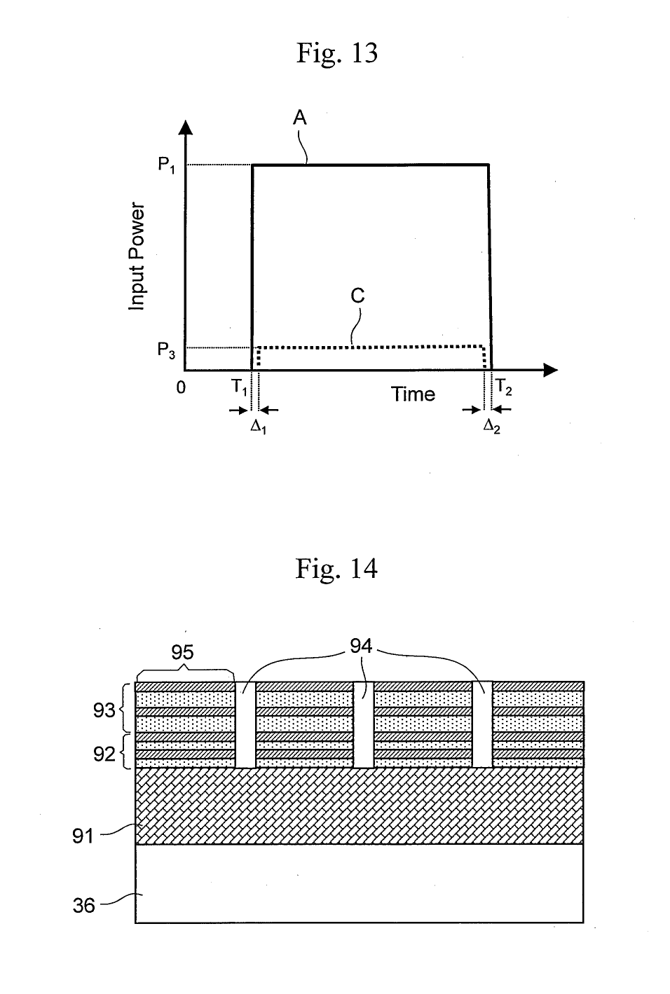

As described in details in Example 2, for increased S/N during recording, a magnetic superlattice film for use in a magnetic recording medium has to segregate its non-magnetic material at the grain boundaries of magnetic crystalline grains and separate and isolate magnetic crystalline grains. However, when an superlattice magnetic thin film medium is formed using a target material containing a non-magnetic material by a conventional technique, the non-magnetic material may be accumulated on the surface of the underlayer depending on the wettability and the content of the non-magnetic material, thus inhibiting the film growth of the magnetic superlattice and degrading Hk in some cases. Then in the present example, a film was formed using C of FIG. 7 as a multi-target including a non-magnetic material and in accordance with the power control sequence schematically shown in FIG. 13 during co-sputtering of A and C. That is, in order to promote heteroepitaxial growth between sub-layers and heteroepitaxial growth of an superlattice magnetic thin film on the underlayer, the film formation starting time of C was delayed by Δ₁ from the film formation starting time T₁ of A and B, and when another sub-layer or an overcoat on the outermost surface is to be formed subsequently, the film formation ending time is advanced by Δ₂ for T₂ so as to promote the heteroepitaxial growth or adhesiveness. Similarly to Δ, Δ₁ and Δ₂ are preferably set larger than 0.5% of T₂−T₁ of film formation time. Δ₁ and Δ₂ set longer than 10% of T₂−T₁ of film formation time makes the grain boundaries in a sub-layer insufficient, and so 10% or less is preferable. FIG. 13 describes the case of forming a film having uniform compositions of A and C in the film, and applied power may be increased or decreased with the film formation time, and co-sputtering with B may be performed as well, whereby any composition distribution can be obtained.

Such a method enables the formation of a magnetic superlattice film having high Hk and excellent adhesiveness with an overcoat or an underlayer, which was confirmed by the evaluation of magnetic properties, the scratch test or the like. This method can be used to form an underlayer or a granular layer as well, and in such a case, Δ₁ and Δ₂ set at 0 to 5% led to a favorable result. Then, the following studies were performed.

(Magnetic Layer)

Firstly magnetic properties of a magnetic superlattice thin film of [Co(0.2 to 0.8)/Ni(0.2 to 0.8)]ₙ₌₂₋₂₀/Pt0.8Ru0.2(5)/glass substrate, which was manufactured by the optimum film formation condition for the maximum Hk, was evaluated using a vibrating sample magnetometer (VSM), for example. FIGS. 9 and 10 show exemplary Ni/Co film thickness ratio dependency of the saturation magnetic flux density Bs and overall film thickness dependency of its magnetic anisotropy field Hk. Herein, the figure in ( ) represents a film thickness in the units of nm, and the value of n represents the number of stacked films. It was confirmed from FIG. 10 that the thickness of a Ni sub-layer of 1 nm or more and the lamination unit of 1.2 nm or more yield Hk of 20 kOe or less, and the thickness of a sub-layer of 1 nm or less enables Hk of 20 kOe more, which is necessary to achieve recording density of 1 Tb/in² or more, and so a favorable Hk for a recording layer (magnetic layer) of magnetic recording medium suitable for microwave assisted recording of 1 Tb/in² or more can be obtained.

Then, based on this basic data, {Co(0.2)/Ni(0.4)}/{Co(0.2)/Ni(0.6)}/{Co(0.2)/Ni(0.2)}/Pt_{0.8}Ru_{0.2}(5), which is the composition of the present example, was formed on a glass substrate by the aforementioned optimum condition. FIG. 11 shows Hk for each unit of one lamination unit layer (n=1) and Bs(=4πMs) in the present example. Herein, { } represents the structure of one lamination unit layer (n=1). Hk was 32 kOe for {Co(0.2)/Ni(0.4)} as the lamination unit (1), was 28 kOe for {Co(0.2)/Ni(0.6)} as the lamination unit (2) and was 24 kOe for {Co(0.2)/Ni(0.2)} as the lamination unit (3). That is, in the structure of the present example, Hk was ±14% for 28 kOe of the intermediate part (2), and so it was confirmed that the structure having high Hk on the surface side in the lamination unit layer of several atomic layers as well, which is effective for a 4-spin model, was realized. Then, its average saturation magnetic flux density was 1.05 T and the average magnetic anisotropy field Hk was 28 kOe, and so it was confirmed that a magnetic film having very excellent Bs and Hk can be obtained as a perpendicular magnetic recording medium. These magnetic films had an average damping constant α of 0.03 to 0.04, which was sufficiently small and favorable. In this way, the structure of the present example achieved high Hk and Bs, and had Hk distribution of ±14% in the lamination unit layer in the thickness direction.

As stated above, the present example has the structure having high average Ku (=Ms·Hk/2), and further having high Hk on the surface side in a lamination unit layer of several atomic layers and high degree of matching with strong head-medium spacing dependency of high-frequency magnetic field. Especially since the structure has a plurality of Hks at an area of atomic layer level, matching is achieved during forced oscillation for high-frequency magnetic field having distribution, and it was confirmed that the structure has a high assist effect and high magnetic recording head yield, which have not been achieved conventionally, as described later in details for the advantageous effect. Further a [Co based alloy/No based alloy] magnetic superlattice thin film has a small damping constant α and has high probability of forced oscillation and phase matching, and so the magnetization reversal mechanism described referring to FIG. 6 can be performed in a short time and quickly. It was further confirmed that, when Kr gas was used instead of Ar gas and a film was formed at a low gas pressure larger than 0.05 Pa and 0.5 Pa or less, Hk was improved by about 5 to 10%, and so a further potential of the present structure also was confirmed. Similar effects were found from mixture gas of Kr and Ar gas or Kr and Ne gas as well.

However, for use of the [Co/Ni] magnetic superlattice thin film as a magnetic recording medium, such a medium has poorer corrosion resistance than conventional media, and so improvement is required, which was found by a high-temperature/high-humidity test at 60° C. and 90% RH and a 0.1 mol % salt spray test. Then, studies were performed on an additive to improve corrosion resistance without impairing Hk. As for the lamination structure at an atomic layer level of a Co-based alloy, noble metals such as Pt, Pd and these alloys and the magnetic superlattice thin films thereof, as the lattice constant of a Co-based magnetic film increases, the wave function of 3d electrons of Co becomes symmetrical, and so perpendicular magnetic anisotropy thereof increases. Then, using such finding for a [Co/Ni] magnetic superlattice thin film as well, additive elements were examined by a multi cathode sputtering shown in FIG. 7. That is, Co was provided at cathode A, Ni was provided at cathode B, and Ti, Zr, Hf, V, Nb, Ta, Cr, Mo, W, Fe, Ru, Os, Ni, Pd, Pt, Co, Rh, Ir, Al, Ga, In, Ge, Nd, C, Re or the like was provided at cathode C. Then, simultaneous discharge (co-sputtering) was performed for cathode A and C to form a Co-based alloy thin film, and then simultaneous discharge was performed for B and C to form a Ni-based alloy thin film as the lamination on a Pt_{0.8}Eu_{0.2} underlayer film of 5 nm, thus forming a [Co based alloy/Ni based alloy] magnetic superlattice thin film. Then, magnetic properties thereof, its film structure, corrosion resistance and the like were evaluated. Herein, the magnetic layer had a thickness of 0.4 to 2.4 nm, the underlayer had a thickness of 1 to 8 nm, and simultaneous film formation using the same elements was not performed.

For instance, 10 at % of Pt, Rh was used as additives, and one layer to three layers of CoPt alloy and NiRh alloy each having a thickness of 0.2 nm, 0.4 nm, 0.6 nm or 0.8 nm was formed on a glass substrate via a non-magnetic (CoCr)_{0.8}Pt_{0.2} thin film of 2 nm in thickness and a Pt_{0.8}Cr_{0.2} alloy underlayer of 2 nm in thickness. The corrosion resistance of them was evaluated by a high-temperature/high-humidity test at 60° C. and 90% RH and a 0.1 mol % salt spray test, and then it was confirmed that the corrosion resistance was improved to the level of the conventional CoCrPt base media or higher. Further, its properties were evaluated by an X-ray diffraction device, a Kerr effect hysteresis evaluation apparatus, a vibrating sample magnetometer (VSM) and the like. Then, all magnetic films were fcc(111) oriented, and had perpendicular magnetic anisotropy that was higher than that of a conventional CoCrPt media by 20% or more.

Additives other than Pt and Rh, including Si, Ti, Zr, Hf, V, Nb, Ta, Mo, W, Fe, Ru, Os, Ni, Pd, Co, Ir, Al, Ga, In, Ge, Nd, C, Re, Au, Cr and Rh also were examined. As a result, it was confirmed from the viewpoint of corrosion resistance, Hk, Ms, coercive force and the like that at least one type of element from a second group selected from Au, Cr, Ti, Zr, Hf, V, Nb, Ta, Ru, Os, Pd, Pt, Rh and Ir that is added in the amount of 0.1 at % or more in total can improve corrosion resistance greatly and can realize the magnetic property of Hk ≧25 kOe. Herein, the addition of 25 at % or more causes degradation of Hk and saturation magnetization greatly, and so the additive amount is preferably 25 at % or lower singly.

It was further confirmed by analyzing the structure and the composition of the surface and cross-section of thin films using an electronic microscope or the like that a 2A element group consisting of Cr, Ti, Zr, Hf, V, Nb and Ta among the above second additive elements show strong corrosion resistance especially for the salt spray test or the like because these elements segregate as an oxide at the grain boundaries or at the surface so as to protect the inside. Such segregation at the grain boundaries is non-magnetic or weak ferromagnetic, and so decreases magnetic interaction between crystalline grains, which was confirmed by the evaluation of a magnetization curve, read/write characteristics and the like. On the other hand, it was confirmed that a 2B element group consisting of Au, Ru, Os, Pd, Pt, Rh and Ir as additive elements does not preferentially segregate at the grain boundaries, but these elements improve the corrosion potential of magnetic crystals, and so show strong corrosion resistance especially for a high-temperature/high-humidity test. It was further confirmed that these additive elements have a feature of widening the lattice parameter of magnetic elements and so having the effect of increasing perpendicular magnetic anisotropy. Such effects were found also in the magnetic superlattice thin film including magnetic alloys as in a Co-based alloy and a Fe-based alloy or a Fe-based alloy and a Ni-based alloy.

When such a magnetic superlattice thin film including a corrosion resistive magnetic metal alloy is used in a magnetic recording medium, it is important to let a non-magnetic material or a weak ferromagnetic material segregate more intensely at the grain boundaries of magnetic crystalline grains, thus isolating magnetic crystalline grains magnetically, and disconnecting interaction between magnetic crystalline grains substantially completely and reducing a magnetic transition region width and medium noise. To this end, it is effective to let a compound having stoichiometrically strong bonding at the grain boundaries in addition to such a metal-base non-magnetic substance. Then studies were conducted to let a non-magnetic compound such as an oxide, a nitride, a carbide, a boride or the mixture of the foregoing, which easily segregate at the brain boundaries, segregate at the grain boundaries of magnetic layers.

(A) Pure Magnetic Metal Superlattice Including a Non-Magnetic Compound

Firstly a [Co/Ni] multilayer film including a non-magnetic compound and having the same sub-layer configuration as that of the above example was stacked on a Pt_{0.8}Ru_{0.2} underlayer of 5 nm. That is, an oxide, a carbide, a nitride, a boride of Ta, Ti, Nb, Zr, Hf, Ag, Mg, Si, Al, Cu or Cr or the mixture of the foregoing was mounted at a cathode of C as a sputtering target, and Co, Ni were mounted at A, B cathodes. Finally as described in FIGS. 12 and 13, the timing of power application for each of A, B and C cathodes was adjusted so that elements of A and B were not mixed at the interface between sub-layer thin films, and the magnetic superlattice was grown heteroepitaxially on the alloy underlayer at the interface with the underlayer, thus performing co-sputtering, so that the magnetic superlattice thin film sample including 0.1 volume % to 40 volume % of the aforementioned oxide, carbide, nitride, boride or the mixture of the foregoing and having the same configuration as the above example was formed.

The thus manufactured multilayer thin film was cut in the cross-sectional direction, and the segregation state at grain boundaries of them was observed from its cross-sectional image using a cross-sectional image transmission electron microscope. As a result, it was found that 1 volume % or more, preferably 2 volume % or more of an oxide, a nitride, a carbide, a boride of an element selected from a first group consisting of Si, Ta, Ti, Zr and Hf or the mixture of the foregoing added to both of the sub-layers was especially effective to separate magnetic crystalline grains of the [Co/Ni] magnetic superlattice multilayered film. On the other hand, an oxide of Cr or Mg had a small effect for the magnetic superlattice. This is because in the case of the addition of a Ta, Si, Ti, Zr or Hf oxide, such an effective additive has a stoichiometric composition ratio in the film, for example, which was confirmed by X-ray photoelectron spectroscopy (XPS), thus indicating that this non-magnetic compound was strongly segregated at the grain boundaries. On the other hand, in the case of Cr or Mg, the film structure was oxygen rich, which is due to the oxidation of the magnetic film itself and so degradation of the magnetic properties. Herein, the crystalline grain separation effect (thickness of a non-magnetic layer that segregates at the grain boundaries) was the maximum when a non-magnetic substance was added to both layers, followed by the case of Co added and next the case of Ni added. Similar effects were found for a nitride, a carbide, a boride or the mixture of the foregoing.

Dispersion of the magnetic crystalline grain size at the magnetic superlattice film of the present example was the minimum at the thin film including a Ti, Zr or Hf oxide added thereto, and as schematically shown in FIG. 14 as an image with a transmission electron microscope, it was confirmed that the oxide grain boundary was stably formed at the magnetic superlattice thin film from the initial stage of the growth and the magnetic superlattice thin film was separated by its non-magnetic segregation 94 in the magnetic film as a whole. Further observation of a high resolution crystalline lattice image showed that a part 95 corresponding to crystalline grains of a high-Hk magnetic layer did not have mutual diffusion between a Co atomic layer and a Ni atomic layer and mixture at the interface, and so two sub-layers were formed alternately in a favorable state. Dispersion of the crystalline grain size also was the minimum at the superlattice magnetic film including TiO₂, ZrO₂, or HfO₂ added thereto, from which Bs of 0.75 T and Hk of 22 kOe or more were obtained as the average in the film. Further similarly to FIG. 11, the structure having high Hk on the film surface side was achieved. The addition of the above Ta, Si, Ti, Zr and Hf oxides of 35 volume % or more degraded corrosion resistance, flyability and mechanical properties (anti-wear reliability) from those of a conventional CoCrPt base granular medium, and 35 volume % or less achieved these properties equal to or less than those of a conventional granular medium, and so such a structure is preferable.

Conventionally studies have been performed to increase Ar gas pressure during film formation so as to separate crystalline grains and to increase coercive force, and so in a comparative example, gas pressure was increased to be 2 Pa or higher to form a magnetic superlattice thin film. However, the resultant film had a sparse film structure, and its corrosion resistance, flyability and mechanical properties (anti-wear reliability) were degraded from those of a CoCrPt base granular medium, and so such a structure is not preferable.

In this way, it was confirmed that a magnetic superlattice film suitable for microwave assisted recording was formed by film formation of [Co/Ni] including the aforementioned compounds of 1 volume % to 35 volume % at low gas pressure of 2 Pa or less, preferably 0.05 Pa or more and 0.5 Pa or less, while suppressing mutual diffusion and mixture of elements constituting sub-layers at the interface. Addition of a nitride, a carbide and a boride of elements such as Ta, Nb, Si, Ti, Zr or Hf or the mixture of the foregoing also led to a similar high Hk and Bs of 0.85 T or more, which is also preferable.

Further analysis of a cross section using a TEM showed that the magnetic superlattice film of the present example including at least 1 volume % to 35 volume % of the above non-magnetic materials as average in the magnetic superlattice thin film had 0.5 to 2 nm of segregation of the non-magnetic material at its magnetic grain boundaries. It was clarified that such a state was due to the above-stated first group elements having a property of easily segregating at the grain boundaries of magnetic crystalline grains as an oxide, a nitride, a carbide or a boride of stoichiometric composition or the mixture of the foregoing.

(B) Magnetic Alloy Superlattice Including Non-Magnetic Compound

Finally, studies were performed similarly to the above (A) for a magnetic superlattice obtained by adding an oxide, a nitride, a carbide or a boride or the mixture of the foregoing of an element selected from a first element group consisting of Si, Ta, Ti, Zr and Hf to a magnetic alloy including at least one type of element selected from the above 2A and 2B additive groups of 0.1 at % or more in total and 25 at % or less singly.

In a magnetic alloy including an element of the group 2B consisting of Au, Ru, Os, Pd, Pt, Rh and Ir, such an additive element has low reactivity with oxygen or the like. Therefore a synergistic effect of the segregation effect of a non-magnetic compound including the first group element at magnetic grain boundaries, an increase in lattice constant of the magnetic layer due to a group 2B element, an increase in perpendicular magnetic anisotropy due to this and the effect of improving Hk was found, and increased Hk (enabling improved thermal stability and higher recording density) as well as high medium S/N were achieved, whereby the most favorable medium properties were obtained. On the other hand, an additive element of the group 2A consisting of Cr, Ti, Zr, Hf, V, Nb and Ta has high reactivity with oxygen or the like, and favorable S/N was obtained when co-sputtering was performed with a multi-target (multi-target (1) described later) including the first group element only. However, in combination with an oxide of the first group element of 35 volume % or more in one target, the segregation promotion effect as a non-magnetic (or weak ferromagnetic) alloy material including a group 2A addition element during film formation of a magnetic layer was lost, and so this is not preferable. Herein, in combination with the oxide, a nitride, a carbide, a boride or the mixture of the foregoing of 35 volume % or less in one multi sputtering target (multi-target (4) described later), 50% or more of the segregation effect including the group 2A additive element was kept during film formation of a magnetic film, and so the problem was small practically.

A magnetic superlattice was produced similarly to FIG. 10 using the above materials (A) and (B), and its Hk, Bs, corrosion resistance and adhesiveness were evaluated. Then, similarly to FIG. 10, 20 kOe or more of Hk was obtained when the thickness of sub-layers were 1 nm or less, and such a structure achieved corrosion resistance, adhesiveness and the like as well, and so such a structure was preferable.

Although the above-description mainly deals with an oxide as an example, similar effects were found for a nitride, a carbide, a boride or the mixture of the foregoing such as Si₃N₄, TaN, TiN, ZrN, (TiZr)N, TiBN, SiC, TaC, TiC, ZrC, HfC, (TiZr)C, SiB, TaB₂, TiB₂, ZrB₂ or HfB₂ as well. The lamination order of [A/B] magnetic superlattice may be reversed as in [B/A], from which similar magnetic properties or the like was obtained.

(Intermediate Layer and Non-Magnetic Sub-Layer)

In this section, studies further were performed on an intermediate layer 136 as well, which is an underlayer of the magnetic film (recording layer), by a similar method to the above. As the magnetic layer, (1) the lamination structure including a Co-based alloy sub-layer and a sub-layer including noble metals such as Pt and Pd or an alloy thereof as the lamination unit, and (2) a magnetic superlattice film including a Fe based alloy sub-layer and a Pt sub-layer as the lamination unit were considered, in addition to the aforementioned magnetic superlattice structure.

Using the multi-target (1) to (4) described later, firstly [Co based alloy/Pt based alloy] and [Co based alloy/Pd based alloy] magnetic superlattice thin films having different compositions and/or thicknesses were formed via an underlayer of 4 nm in thickness including metals such as Pt, Rh, Si, Ti, Zr, Hf, V, Nb, Ta, Mo, W, Ru, Os, Ni, Pd, Co, Ir, Al, Au, Cr and Rh or an alloy of them as stated above, and their Hk was evaluated. The underlayer was formed on a substrate in another chamber including a multi cathode by co-sputtering using a multi-target including various elements similarly to the magnetic layers, on which the superlattice thin film was then formed.

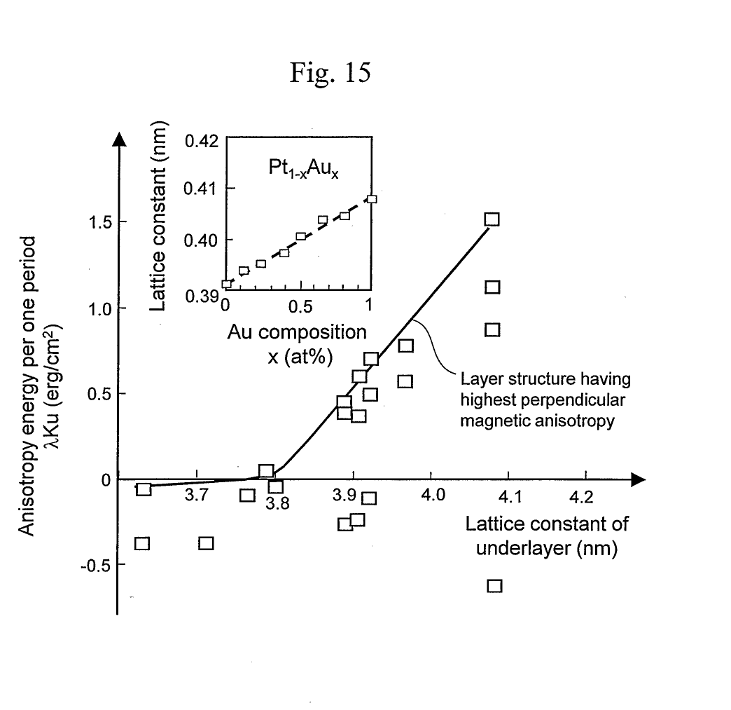

For instance, the relationship of the lattice constants of the thus formed Pt₁₋ₓAuₓ alloy underlayer and the Au composition x is shown additionally in FIG. 15. FIG. 15 further shows the relationship of anisotropy energy Ku of the manufactured thin films having various structures and the lattice constants of the underlayer (intermediate layer). It was confirmed that, when the lattice constant of the underlayer (intermediate layer) is 3.8 nm or more, the maximum magnetic anisotropy (of the layer structure, from which the highest magnetic anisotropy is obtained) becomes perpendicular magnetic anisotropy. In this way, it was confirmed that the material of the underlayer (intermediate layer) whose maximum magnetic anisotropy becomes perpendicular magnetic anisotropy includes 50% or more of at least one type element of Rh, Ir, Pd, Pt, Ag, Au, Ru and Os, and at this time the magnetic superlattice magnetic layer is (111) oriented in the fcc structure, and so high perpendicular magnetic anisotropy is generated at the interface of the magnetic superlattice.

Next, an alloy underlayer including Pt, Pd, Rh and Ru as a base, to which the aforementioned metal element was added, was formed, and then adhesiveness with a substrate by a scratch test, mechanical properties such as film strength, crystal orientation were evaluated. The result showed that, by adding 0.1 at % or more in total of at least one type of element selected from the aforementioned second additive group, from which elements overlapping with them are excluded, the adhesiveness, film strength and orientation are improved, and corrosion resistance of the magnetic film is equal to or more of that of a conventional perpendicular magnetic recording medium, and perpendicular magnetic anisotropy of 20 kOe or more, which is a necessary property to achieve recording density of 1 Tb/in² or more, can be obtained. Herein, addition of an element selected from the second additive group exceeding 25 at % degraded the fcc(111) orientation and the perpendicular magnetic anisotropy of a magnetic layer formed thereon greatly, and so this is not preferable. A similar effect as the additive was obtained from Os, Ir, Ag and Au as well.

It was confirmed from these results that the underlayer (intermediate layer 136) including 50% or more of at least one type of a third group consisting of Ru, Os, Rh, Ir, Pd, Pt, Ag and Au and 0.1 at % or more in total and 25 at % or less singly of at least one type of element selected from the aforementioned second additive group, from which elements overlapping with them are excluded, achieves Hk of 20 kOe or more that is necessary for the application of a magnetic superlattice thin film in a magnetic recording medium and for implementation of recording density of 1 Tb/in² or more, corrosion resistance, adhesiveness and the like, and such an underlayer is especially preferable.

The intermediate layer 136, which is the underlayer of the magnetic film in the structure of a magnetic recording medium, has a function of controlling the crystalline grain size of the magnetic layer and its dispersion. That is, the crystalline grains of the magnetic layer grow heteroepitaxially on the underlayer, while following the crystalline grains of the underlayer. Therefore, the crystalline grains at the intermediate layer also preferably include an additive material to separate and isolate the crystalline grains therein. It was found from the studies based on the finding on the material for segregation at the grain boundaries of a magnetic layer that, by including 1 volume % or more and 35 volume % or less of an oxide, a nitride, a carbide or a boride of an element selected from the elements in the first group or the mixture of the foregoing in the material of the intermediate layer as well, stoichiometric additive elements are segregated at the grain boundaries but hardly is segregated at the outermost surface, and the heteroepitaxial growth of the magnetic layer on it is hardly inhibited. It was further confirmed that, due to this intermediate layer (corresponding to the underlayer of the magnetic layer), a clear granular structure is obtained where the underlayer and the magnetic layer have the crystalline grain size of 3 to 9 nm in average. Thereby, in addition to Hk, corrosion resistance and adhesiveness, low noise and high S/N properties, which are necessary to implement recording density of 1 Tb/in² or more, can be realized.

Such an effect of the intermediate layer was found similarly for the aforementioned magnetic superlattice thin films including, as the lamination unit layer, a Co-based alloy sub-layer and a Ni-based alloy sub-layer, a Co-based alloy sub-layer and a Fe-based alloy sub-layer, and a Fe-based alloy sub-layer and Ni-based alloy sub-layer and for a thin film including the aforementioned intermediate layer materials as a sub-layer and a Co-based alloy, a Fe-based alloy or a Ni-based alloy as another sub-layer. In the case of using a conventional medium material such as CoCrPt—SiO₂ as a part of the magnetic recording medium of the present invention as well, the effectiveness of the method to control the interface state at the intermediate layer in the present example was found.

It was further confirmed that a layer including 50% or more of at least one type of the third group elements and 0.1 at % or more in total and 25 at % or less singly of at least one type of element selected from the aforementioned second additive group, from which elements overlapping with them are excluded, are used for a material for the non-magnetic sub-layer of the magnetic superlattice as well, and the thickness of the layer is 1 nm or less, whereby Hk of 20 kOe or more can be achieved, and corrosion resistance, adhesiveness and the like can be realized, and so such a structure is especially preferable.

(Multi-Target Material)

Using an inline type multi-target sputtering apparatus including at least one chamber having a multi cathode for formation of a magnetic superlattice thin film, the perpendicular magnetic recording medium of the present example was manufactured based on the aforementioned findings. In the following, targets for multi-target sputtering including materials (1) to (7) were combined appropriately, and films were formed in accordance with the sequence of FIGS. 12 and 13 by DC magnetron sputtering in Ar gas or Kr gas or by RF magnetron sputtering as needed when an oxide, a nitride or the like was included.

(1) A non-magnetic material including an oxide, a nitride, a carbide or a boride of at least one type of element selected from the aforementioned first group or the mixture of the foregoing;

(2) a material including any one of Co, Ni and Fe and (a) 1 volume % to 35 volume % or (b) 2 volume % to 10 volume % of a non-magnetic material including an oxide, a nitride, a carbide or a boride of at least one type of element selected from the aforementioned first group or the mixture of the foregoing;

(3) a material including any one of Co, Ni and Fe and 0.1 at % or more in total and 25 at % or less singly of at least one type of element selected from the aforementioned second additive group;

(4) a material including any one of Co, Ni and Fe, (a) 1 volume % to 35 volume % or (b) 2 volume % to 10 volume % of a non-magnetic material including an oxide, a nitride, a carbide or a boride of at least one type of element selected from the aforementioned first group or the mixture of the foregoing, and 0.1 at % or more in total and 25 at % or less singly of at least one type of element selected from the aforementioned second additive group;

(5) a material including 50 at % or more of at least one type of element selected from the aforementioned third group and 0.1 at % or more in total and 25 at % or less singly of at least one type of element selected from the aforementioned second additive group, the selected element not overlapping with the elements selected from the third group;

(6) a material including 50 at % or more of at least one type of element selected from the aforementioned third group and, (a) 1 volume % to 35 volume % or (b) 2 volume % to 10 volume % of a non-magnetic material including an oxide, a nitride, a carbide or a boride of at least one type of element selected from the aforementioned first group or the mixture of the foregoing; and

(7) a material including 50 at % or more of at least one type of element selected from the aforementioned third group, (a) 1 volume % to 35 volume % or (b) 2 volume % to 10 volume % of a non-magnetic material including an oxide, a nitride, a carbide or a boride of at least one type of element selected from the aforementioned first group or the mixture of the foregoing, and 0.1 at % or more in total and 25 at % or less singly of at least one type of element selected from the aforementioned second additive group.

Herein, these multi-targets may be used as follows. That is, (1) is used for a non-magnetic material for segregation at grain boundaries, (2) is used for a material of a magnetic sub-layer of a magnetic superlattice thin film, including the first additive group only, (3) is used for a material of a magnetic sub-layer of a magnetic superlattice thin film, including the second additive group only, (4) is used for a material of a magnetic sub-layer of a magnetic superlattice thin film, including the additive first and second groups, and (5) to (7) are used for a material of a non magnetic sub-layer of a magnetic superlattice thin film, or for a material of an intermediate layer (underlayer), for example. In the above (2), (4), (6) and (7), the materials (b) including 2 volume % to 10 volume % of a non-magnetic material including an oxide, a nitride, a carbide or a boride of at least one type of element from the aforementioned first group or the mixture of the foregoing are described in Example 3, in which 2 volume % or more of the non-magnetic material composition is to promote segregation, and 10 volume % or less of the non-magnetic material composition is to achieve heteroepitaxial growth and adhesiveness substantially equal to that of a pure metal material even for single use thereof for film formation. These target materials for multi cathode can lower the permeability as well, can prevent localization of an erosion area and so can increase the usage efficiency by controlling crystalline grain size and residual stress appropriately. Using the multi-cathode targets having the below-described compositions, the film composition can be easily adjusted by changing the power applied during multi-target co-sputtering appropriately, thus improving the heteroepitaxial film growth, adhesiveness and Hk and enabling the formation of a film having a compositionally modulated structure as well, which is especially preferable for a multi cathode target for a magnetic recording medium including a magnetic superlattice film formed thereon.

They may be used specifically as follows. That is, the multi-target materials of (1), (2), (4), (6) and (7) including a compound of the first group requires a RF magnetron sputtering cathode that is expensive and is difficult to control, because DC magnetron sputtering capable of high-speed film formation will fail to form a film stably. Then, (1) may be provided at a RF magnetron sputtering cathode, and a multi-target including (3) or (5) not including the material of (1) may be provided at a DC magnetron sputtering cathode for co-sputtering, whereby the number of RF sputtering cathodes that are expensive and difficult to control can be made minimum. Co-sputtering of the material (1) and the material (3) or (5) further enables covering of a part such as an oxide that cannot be covered with the material (1) with a non-magnetic alloy including the metal (3) or (5), whereby the segregation effect can be obtained at a complementary magnetic grain boundary. This leads to high medium S/N by about 0.3 dB, and so is preferable. In this way, the combination of these target materials (1) to (7) with multi-target sputtering can improve the throughput for film formation, the film structure, adhesiveness and the like at a low cost, and can form a magnetic superlattice film having small variation in read/write characteristics and excellent anti-wear reliability, and so they are especially preferable for a target material and a manufacturing method of a magnetic superlattice type magnetic recording medium. Examples of them are described later.

A magnetic superlattice film can be formed by a rotatable cathode method also. However, when the film is formed by a multi-target co-sputtering method, while controlling the distance between electrodes, the power applied, the gas pressure and the magnetic field applied to a cathode appropriately, whereby a sputtering area and a composition can be controlled electrically and quickly, and a film that is excellent in throughput and having more excellent quality can be formed, and so such a method is preferable.

(Magnetic Recording Medium)

A perpendicular magnetic recording medium 130 shown in FIG. 1 includes the lamination on a super-smooth and heat-resistive non-magnetic substrate 36 made of glass, Si, plastics, a NiP plated Al alloy or the like, and the lamination includes a soft magnetic underlayer 135 made of FeCoTaZr or the like, at least one layer of an intermediate layer 136 for property control, first, second and third magnetic layers 133, 139 and 134, an overcoat 132 made of filtered cathodic arc carbon (FCAC), C and the like, and a lubricant layer 131 including lubricant made of perfluoroalkylpolyether (PFPE), at main chain of which a terminal group having a property of absorbing the overcoat is provided, for example. The non-magnetic intermediate layer is provided to control the crystalline grain size of the three-layered magnetic layers 133, 139 and 134 making up a recording layer, and to improve the crystal orientation, magnetic property and the uniformity, to which an intermediate layer including a non-magnetic material made of NiW, Ru, Ru alloy or the like or a magnetic material made of CoFeTa or the like may be additionally provided. Such a provision of the magnetic intermediate layer for orientation control is especially preferable because the magnetic field of STO can be drawn deeply into the medium. Between the soft magnetic underlayer 135 and the substrate 36, at least one layer of non-magnetic layer for controlling of a property such as adhesiveness, e.g., NiTa amorphous thin film may be provided, and the soft magnetic underlayer 135 may be two-layer structured to laminate via Ru, a Ru alloy or the like to improve its soft magnetic property and uniformity. These thin films were formed by an inline type multi-target sputtering apparatus including at least one chamber having a multi cathode for formation of a magnetic superlattice thin film and having a function to adjust the film formation timing as stated above, where DC sputtering in Ar gas or Kr gas or RF sputtering if needed, for example, was performed.

As the multi-sputtering target, the multi-target materials of (1) to (7) as stated above were used for film formation. Especially as described in FIGS. 12 and 13, (a) mixture of sub-layer atoms at the interface between sub-layers of the magnetic superlattice is suppressed, and (b) deposition of the target material of (1) is suppressed at the interface with the underlayer (intermediate layer) and the overcoat, whereby orientation and Hk of the magnetic superlattice can be made the maximum. Further, deposition of the target material of (1) is suppressed at the interface with the overcoat, whereby adhesiveness with the overcoat can be increased, and so even in the configuration of providing the magnetic superlattice at the outermost layer of the magnetic recording medium, high anti-wear reliability equal to or more of a conventional medium was achieved. Note here that the target material (1) has strong stoichiometric bonding and is stable during sputtering for film formation, and so in the case of the target material (4) in which the target material (1) is included in a magnetic alloy or the target materials (6) and (7) in which the target material (1) is included in an under or sub-layer metal, the film formation thereof will degrade the value of Hk by several %, but the number of cathodes can be reduced, and so a magnetic superlattice thin film medium suitable for high-density recording of 1 Tb/in² or more was obtained at a low cost. Herein, the average Hk of the magnetic film was increased for high coercive force, thus preventing sufficient recording by magnetic field from a recording pole only, thus enabling a structure suitable for narrow-track magnetic recording in a forced oscillation mode in combination with microwave assisted recording.

The perpendicular magnetic recording layer of the present example has a three-layer structure. However, this is not a limiting one, and it may be a multilayer structure including two layers, four layers or five layers or more as described in Example 5, as long as it has distribution of Hk in the atomic layer level in the thickness direction and has high coercive force at the surface of the medium. An intermediate layer to control magnetic bonding may be provided between the magnetic layers, if needed. FIG. 1 shows the example including the magnetic layers 133, 139 and 134 provided on a single side of the substrate 36, which may be provided on double sides of the substrate 36. It was confirmed that, when a magnetic pattern of 600 nm² in dot area was formed at the magnetic recording medium of the present example by pattern etching, non-magnetic ion implantation or the like, thus forming a bit pattern medium, the sharp recording field gradient of microwave assisted recording was utilized, and so high-density of 1 to 2 Tb/in² or more was easily achieved. Herein, addition of a non-magnetic material of 10 volume % or more at the grain boundaries may cause the formation of magnetic domains in the magnetic dots, which may cause an error unfavorably, and so the amount of a non-magnetic material added is preferably 10 volume % or less.

In the present example, the magnetic recording medium having the following structure where a [Co/Ni] base magnetic superlattice thin film of the structure shown in FIG. 11 and including a non-magnetic material was provided at the uppermost layer, and its read/write characteristics were evaluated using a microwave assisted recording head described in Example 2.
Medium substrate: 2.5″ glass substrate
Medium structure: lubricant layer (1 nm)/C (2 nm)/{Co—TiO₂ (0.2 nm)/Ni—Ta₂O₅ (0.4 nm)} {Co—Ta₂O₅ (0.2 nm)/Ni—TiO₂ (0.6 nm)} {Co—SiO₂ (0.2 nm)/Ni—ZrO₂ (0.2 nm)}/Co_{0.68}Cr_{0.11}Pt_{0.21}−(SiTa)O₂ (6 nm)/Co_{0.70}Cr_{0.12}Pt_{0.18}—Ta₂O₅ (6 nm)/Ru—SiO₂ (5 nm)/Ru (5 nm)/CoFeTaZr (10 nm)/Ru (0.5 nm)/CoFeTaZr (10 nm)

The perpendicular magnetic recording medium 130 was formed, on the glass substrate 36, as a magnetic superlattice thin film including a CoFeTaZr/Ru/CoFeTaZr lamination magnetic layer as the soft magnetic underlayer 135, Ru (second intermediate layer) and Ru—SiO₂ (first intermediate layer) as the non-magnetic intermediate layer (underlayer of the magnetic layer) for property control 136, Co_{0.70}Cr_{0.12}Pt_{0.18}—Ta₂O₅ as the third magnetic layer 134, Co_{0.68}Cr_{0.11}Pt_{0.21}—(SiTa)O₂ as the second magnetic layer 139 and the first magnetic layer 133 including the following three types of lamination unit layers (1) to (3). That is, the lamination unit layer (1) includes {Co—TiO₂(0.2 nm)/Ni—Ta₂O₅(0.4 nm)}, the lamination unit layer (2) includes {Co—Ta₂O₅(0.2 nm)/Ni—TiO₂(0.6 nm)} and the lamination unit layer (3) includes {Co—SiO₂(0.2 nm)/Ni—ZrO₂(0.2 nm)}. Finally, the overcoat 132 was C or FCAC, and the lubricant layer 131 was a substantially monomolecular layer as the overall structure, including a lubricant in which perfluoroalkylpolyether (PFPE) of 500 to 5,000 in average molecular weight was a main chain, including one to sixteen terminal groups such as —OH group or —OCH₂C(—OH)HCH₂—OH group. Herein, (—OH) represents a side chain. The lubricant was formed on the overcoat whose surface was subjected to an ion treatment using N₂ or the like, which was then subjected to a UV-ray treatment at a high temperature so that the adhesion coefficient of the lubricant to the overcoat was 70 to 98%. Further in order to reduce flying space of the magnetic recording head, the lubricant preferably has the distribution of molecular weight of ±50% or less, and in order to suppress a change in the adhesion coefficient by microwave radiation, the total number of —OH groups that easily bond with water molecules (easily attract water molecules inside the lubricant) excited by microwave radiation is preferably 8 or less per one molecule of the lubricant.

In the above, 2 volume % of non-magnetic oxide TiO₂, Ta₂O₅, SiO₂ or ZrO₂ was added to the sub-layers of the lamination unit layers (1), (2) and (3) in the first magnetic layer, and 8 volume % and 15 volume % of non-magnetic oxides (SiTa)O₂ and Ta₂O₅, respectively, were added to the second and the third magnetic layers 139 and 134. The first intermediate layer in contact with the third magnetic layer preferably is made of a material and has a structure to assist to let the third magnetic layer have intense perpendicular magnetic anisotropy and have a predetermined crystalline grain separation structure. To this end, the material includes an element of the aforementioned third group such as Pt or Ru or an alloy thereof, which has the effect of widening a lattice constant at least in the range of lattice matching of the third magnetic layer, to which an element of the second group and/or an oxide of an element selected from the first group is added. In the present example, Ru, to which 2 volume % of non-magnetic oxide SiO₂ was added, was used for the first intermediate layer. Then, the average Hk of the magnetic layers 133, 139 and 134 were 28 kOe, 20 kOe and 18 kOe, respectively.

(Advantageous Effect)

A microwave assisted element practically has high-frequency magnetic field intensity attenuating in the medium thickness direction, and fluctuates and varies in oscillation frequency. The magnetic recording medium of the present example is configured so that its first magnetic layer has high Hk on the surface side and includes a magnetic superlattice thin film having dispersion of Hk at an atomic level in the thickness direction, and so magnetization of the lamination units having appropriate Hk generates forced oscillation for such microwave assisted high-frequency magnetic field having fluctuation and variation, and the probability of phase matching with the high-frequency magnetic field increases, whereby a magnetic recording layer suitable for microwave assisted recording can be realized. This enables recording with small effective SFD during recording and with high density and high medium S/N while suppressing expansion of a magnetic transition region width.

In the present example, the recording/reproduction properties of the perpendicular magnetic recording medium made of the above materials and having the structure was evaluated actually using a microwave assisted magnetic recording head. As a result, as compared with a medium as a comparative example that was formed by a conventional technique, including the first magnetic layer made up of five periods of sub-layers of 2 nm in total thickness, where a single period of Co—TiO₂ and Ni—Ta₂O₅ was (0.2 nm, 0.2 nm), or 2 periods of 1.6 nm in total thickness, where a single period was (0.4 nm, 0.4 nm), the medium of the present example had higher S/N by 0.8 dB or 1.5 dB, respectively. The medium of the present example further had high adhesiveness and mechanical properties of the film and good flyability of the magnetic recording head compared with the comparative example, and further the track width during recording was determined by the STO width of a narrow track (selective magnetization reversal effect). Further, the magnetic recording medium of the present example including the overcoat and lubricant film of the present example provided on the magnetic films showed excellent anti-wear reliability equal to that of a conventional medium.

Further 2 dB or more of assisting effect was achieved for the magnetic recording medium having the present structure irrespective of variations in oscillation frequency in the manufacturing process of the microwave assisted recording head, and so as compared with the combination with the conventional medium as the comparative example, the yield of the magnetic recording head was improved by 25%.

The above effects were for the structure where Hk decreased monotonously in the film thickness direction, where the lamination unit layers were (1), (2) and (3). Then, in the case of the lamination order of (1), (3) and (2), then the magnitude of Hk would be a V-letter-shape in the film thickness direction. In this case, a layer having low Hk (in this case, Bs is high and so preferable) was located on the surface of the medium, i.e., was located closer to the microwave assisted head, and so the assist effect was exerted for weaker high-frequency magnetic field and a low frequency as well, and assisted recording at high yield was enabled for a magnetic recording head having large property variations. Further as compared with the lamination order of (1), (2) and (3), the medium achieved high S/N by 0.2 dB and yield of the magnetic recording head also increased by 30% compared with the comparative example, and so this was preferable.

### Example 2

The present example describes a perpendicular magnetic recording medium having a nearly monotonic decrease type Hk distribution.

(Microwave Assisted Magnetic Recording Head)

FIG. 1 is a conceptual diagram showing an exemplary microwave assisted magnetic recording head and such a perpendicular magnetic recording medium. A magnetic recording head includes a reading head part 10, a recording head part 20 and a thermal expansion element portions (TFC) 02a, 02b for clearance control or the like formed on a slider 50 traveling in the direction of an arrow 100 while keeping clearance 01 over a perpendicular magnetic recording medium 30. Herein, the TFCs 02a, 02b include a heat-generation resistive element thin film of about 50 to 150Ω made of a material having high specific resistance and a high thermally expandable property, such as NiCr or W and insulated with alumina film, and has a function of adjusting the clearance between the recording head part 20 or the reading head part 10 and the perpendicular magnetic recording medium 30 to be about 0.5 to 2 nm. The TFC may be provided at two or more positions, and in such a case, wiring for connection of the TFCs may be provided independently or in series. Wiring for power supply is not illustrated in the drawing. A head overcoat 51 is made of Chemical Vapor Deposition Carbon (CVDC), FCAC or the like, and a bottom plane 52 is an Air Bearing Surface (ABS) of the magnetic recording head.

The slider 50 is made of Al₂O₃—TiC ceramic or the like and is subjected to etching, thus allowing the flyability of the pole part of the magnetic recording head to be about 5 to 10 nm across the entire perimeter of the perpendicular magnetic recording medium.

The slider 50 is mounted on a suspension having element driving wiring, and is mounted at the magnetic storage device as a Head Gimbal Assembly (HGA). The present example uses a slider of femto-type measuring 0.85 mm×0.7 mm×0.23 mm, which may be a thin femto type measuring about 0.2 mm in height or a long femto type measuring about 1 mm in length depending on its use. The perpendicular magnetic recording medium 30 of the present example moves relative to the magnetic recording head so that the reading head part 10 is on the leading side and the recording head part 20 is on the rear side, which may be reversed, and the head overcoat may be omitted.

The reading head part 10 includes: a magnetic shield layer 11 that provides magnetically shielding from the recording head part 20; a reproduction sensor element 12; an upper magnetic shield 13 and a lower magnetic shield 14 to enhance reproduction resolution. The reproduction sensor element 12 plays a role of reproducing a signal from the medium, and may be configured to exert a Tunneling Magneto-Resistive (TMR) effect, a Current Perpendicular to Plane (CPP)—Giant Magneto-Resistance (GMR) effect or an Extraordinary Magneto-Resistive (EMR) effect or may be a sensor utilizing a Spin Torque Oscillator (STO) effect or of a Co₂Fe(Al_{0.5}Si_{0.5})/Ag/Co₂Fe(Al_{0.5}Si_{0.5}) or CO₂Mn(Ge_{0.75}Ga_{0.25})/Ag/CO₂Mn(Ge_{0.75}Ga_{0.25}) scissors type including the lamination of a Heusler alloy thin film or a differential type. The element width, the element height and the shield gap (read gap) may be designed or processed suitably for recording track density and recording density as a target, and the element width may be about 50 nm to 5 nm, for example. FIG. 1 does not illustrate a leading terminal of the reproduction output.

In the recording part 20, the STO 40 includes: a high-frequency magnetic field generation layer (FGL) 41; an intermediate layer 42, a spin injection layer 43 to give spin torque to the FGL and the like. The FGL 41 is made of soft magnetic alloy such as FeCo or NiFe, hard magnetic alloy such as CoPt or CoCr, magnetic alloy having negative perpendicular magnetic anisotropy such as Fe_{0.4}Co_{0.6}, Fe_{0.01}Co_{0.99} or Co_{0.8}Ir_{0.2}, Heusler alloy such as CoFeAlSi, CoFeGe, CoMnGe, CoFeAl, CoFeSi or CoMnSi, Re-TM amorphous alloy such as TbFeCo, or a magnetic superlattice this film such as [Co/Fe], [Co/Ir], [Co/Ni] or [CoFeGe/CoMnGe]. The intermediate layer 42 is made of a non-magnetic conductive material such as Au, Ag, Pt, Ta, Ir, Al, Si, Ge, Ti, Cu, Pd, Ru, Cr, Mo or W or an alloy of the foregoing.

Herein, both of the magnetic easy axes of the FGL 41 and the spin injection layer 43 are perpendicular to the film plane, and in the standard mode, current is supplied from the spin injection layer side to the FGL side to drive the STO. Alternatively, when the spin injection layer is designed so that the magnitude of magnetic anisotropy field resulting from materials and the magnitude of the effective demagnetizing field in the direction perpendicular of the film surface of the spin injection layer 43 are substantially the same in opposite directions, then current may be supplied from the FGL side to the spin injection layer side to drive the STO so that negative magnetic anisotropy field exists effectively and magnetization of both layers follows magnetization reversal and instantly leads to high-speed large rotation. The spin injection layer 43 may have a two-layered lamination structure where magnetization states of the magnetic layers are mutually antiparallelly coupled, and a layer closer to the FGL may have a smaller magnetization/film thickness product to enhance the spin injection efficiency.

Materials, compositions and magnetic anisotropy of these magnetic layers are decided so that the spin injection efficiency, the high-frequency magnetic field intensity, the oscillation frequency, effective magnetic anisotropy including demagnetization field and the like can be the most suitable for microwave assisted recording. For instance, since high-frequency magnetic field increases in proportion to the saturation magnetization of the FGL, the FGL layer preferably has higher saturation magnetization Ms. Although a larger thickness of the FGL leads to higher high-frequency magnetic field, a too thick film makes the magnetization receptive to disturbance, and so the thickness of 1 to 100 nm is preferable. It was confirmed that intense STO oscillation control magnetic field applied using the above-stated main pole/shield type magnetic pole enables stable oscillation with any of a soft magnetic material, a hard magnetic material and a negative perpendicular magnetic anisotropy material.

The FGL 41 may have a width W_{FGL} that is designed and processed suitably for the recording field and the recording density as targets, and the width was 50 nm to 5 nm. For a larger W_{FGL}, more intense STO oscillation control magnetic field 126 is preferable. When the FGL has a height larger than the width, a closed magnetic circuit of magnetic flux easily is formed due to recording field from a deeper part of the perpendicular magnetic recording medium and the part of the element corresponding to its extra height, and so a high-frequency magnetic field component can reach a deeper part of the perpendicular magnetic recording medium and can enhance the assist effect, and so such a structure is especially preferable. In the case of combination with Shingled Magnetic Recording (SMR), W_{FGL} is preferably two or three times the recording track width.

The non-magnetic intermediate layer 42 preferably has a thickness of about 0.2 to 4 nm for high spin injection efficiency. The spin injection layer 43 preferably is made of a magnetic superlattice thin film material such as [Co/Pt], [Co/Ni], [Co/Pd] or [CoCrTa/Pd] because such a material having perpendicular magnetic anisotropy enables stable oscillation of the FGL. For stabilization of high-frequency magnetization rotation of the FGL 41, a rotation guide ferromagnetic layer having a structure similar to that of the spin injection layer 43 may be provided adjacent to the FGL 41. The stacking order of the spin injection layer 43 and the FGL 41 may be reversed.

FIGS. 2 and 3 show a detailed state in the vicinity of the STO. FIG. 2 is a bottom view from the ABS, and FIG. 3 is a cross-sectional view taken along the line AA′ of FIG. 2. Although not illustrated in FIG. 1, an underlayer 47 and a cap layer 46 may be further provided in this way to improve the controllability of film properties and film characteristics of the spin injection layer and the FGL, the oscillation efficiency and reliability, where these layers may be made of a single layer thin film of Cu, Pt, Ir, Ru, Cr, Ta and Nb or an alloy of the foregoing, or a lamination thin film of them.

In FIG. 1, a driving current source (or voltage source) and an electrode part of the STO are schematically represented with reference numeral 44, and the recording poles 122 and 124 may be used as electrodes by magnetically coupling the recording poles 122 and 124 at the rear-end part 27 of the recording head but electrically insulating and further by electrically connecting them with the side face of the STO at the gap. Except under the special circumstances, current is applied to the STO from a DC power supply (voltage driven or current driven) 44 from the side of the spin injection layer, thus driving microwave oscillation of the FGL. FIG. 1 exemplifies current driving, and constant-voltage driving is preferable for improved reliability because the current density can be made constant.

As in FIG. 2 showing the structure of the magnetic pole part in the vicinity of the gap part viewed from the ABS face, the recording pole of the recording head part 20 includes a wide recording pole (main pole) 122 that is formed by etching to have a substantially same width as the STO and is shaped so as to generate perpendicular recording field 121 having a substantially same width as that of high-frequency magnetic field; a shield magnetic pole 124 to control a magnetization rotating direction or the like of the high-frequency magnetic field oscillation element 40; and a coil 23 made of Cu or the like to excite the recording pole. The etching depth d is about 1 to 40 nm, preferably 5 to 20 nm in terms of balance between magnetic field distribution and magnetic field intensity. A magnetic gap 125 is provided between the recording pole 122 and the shield magnetic pole 124, and oscillation control magnetic field 126 controls the magnetization direction and the magnetization rotating direction of the high-frequency magnetic field oscillation element 40.

The recording pole (main pole) 122 includes a high-saturation magnetic flux soft magnetic film made of FeCoNi, CoFe alloy or the like, which is formed by plating, sputtering or the like so as to have a trapezoidal shape having a bevel angle of 10 to 20 degrees and have a cross-sectional area decreasing with increasing proximity to the ABS face. As shown in FIGS. 2 and 3, the main pole of the present example was narrowed from four directions in the magnetic recording head traveling direction and the track direction so as to achieve intense recording field. The width T_{ww} of the recording element on the wider side of the trapezoidal recording pole is designed and processed suitably for the target recording field and such recording density, and the size thereof is about 10 nm to 160 nm. The recording pole 122 may have a so-called Wrap Around Structure (WAS), in which the recording pole 122 and the shield magnetic pole 124 are formed with a soft magnetic alloy thin film such as CoNiFe alloy or NiFe alloy, and the recording pole 122 is surrounded via a non-magnetic layer. In this magnetic pole structure, the footprint of the recording pole depends on the main pole, to which the most intense recording field concentrates.

As shown in FIGS. 1 to 3, the main pole 122 of the present example has the four faces narrowed, which means that the face where the STO is to be formed is inclined by angle of 10 to 20° as shown in FIG. 3. When the high-frequency magnetic field oscillation element STO including the FGL 41 is formed at such an inclined face, magnetic anisotropy will be generated in the direction perpendicular to the inclining direction, and the high-frequency oscillation efficiency of the STO will be degraded by 10 to 20%. To cope with this, as shown in FIGS. 2 and 3, a non-magnetic filling layer 47 was formed on the main pole 122 of the present example, which was then flattened, thus forming the STO similarly to Examples 1 to 4. Herein, the stacking order of the spin injection layer 43, the FGL 41, the non-magnetic underlayer and the non-magnetic cap layer may be reversed in FIGS. 2 and 3. However, since the STO is preferably provided in the vicinity of the main pole, the most preferable structure of the STO is such that the high-frequency magnetic field oscillation element is made of the same material as that of the underlayer, and the FGL 41 is firstly formed on this underlayer 47, on which then the non-magnetic intermediate layer 42, the spin injection layer 43 and the cap layer 46 are stacked one by one as shown in FIGS. 2 and 3.

(Perpendicular Magnetic Recording Medium)

In the recording layer of the perpendicular magnetic recording medium shown in FIG. 1, influences of the uppermost layer (first magnetic layer) 133 on the magnetization reversal of the second magnetic layer 139 and the third magnetic layer 134 increases in proportion to the saturation magnetization of the uppermost layer. Therefore materials of the uppermost layer 133 and the intermediate layer 139 preferably have relatively high saturation magnetization Ms. As described in Example 1, the materials of the magnetic superlattice thin film are high in design flexibility for Hk and Ms, and so are preferable to adjust them, and so a Co-base material that has high axial symmetry of crystalline lattice and is easy for perpendicular magnetization orientation is preferably used for materials of the magnetic superlattice thin film. For instance, a magnetic superlattice thin film made of [Co-based alloy/Ni-based alloy] including a magnetic alloy as a sub-layer, [Co-based alloy/Pt-based alloy] or [Fe-based alloy/Pt-based alloy] having relatively high magnetization and Hk is especially preferable. Among them, [Co-based alloy/Ni-based alloy] is especially preferable because the thin film made of this has a small damping constant α of about 0.03 to 0.04 and resists rotation brake, and so is easy to have phase matching with high-frequency magnetic field while keeping margin. For elements as additives, as described in Example 1, a larger lattice constant of a Co-base magnetic film enables a symmetric wave function of 3d electrons of Co, thus increasing its interface magnetic anisotropy and perpendicular magnetic anisotropy thereof and improving thermal fluctuation, which is suitable for higher-density recording.

For instance, 20 at % of Pt and Rh were used as additives, and one layer to three layers of each of CoPt alloy and NiRh alloy, each having a thickness of 0.2 nm, 0.4 nm, 0.6 nm or 0.8 nm, was formed on a glass substrate via Pt of 2 nm in thickness and a TaCr alloy layer of 2 nm in thickness. Then, the properties thereof were evaluated using an X-ray diffraction device and a VSM. The evaluation showed that all magnetic films were fcc(111) oriented, and had very favorable perpendicular magnetic anisotropy of Hk 25 KOe. As the additives other than Pt and Rh, 0.1 at % or more in total and 25 at % or less singly of at least one type of element selected from the additive group consisting of Au, Ru, Os, Ir and Nb is preferably added as stated above. Then as described in Example 1, 1 volume % to 35 volume % of an oxide of an element selected from the first group consisting of Si, Ta, Ti, Zr and Hf, an oxide, a nitride, a carbide or a boride of the compound thereof, or the mixture of the foregoing was added to both of the sub-layers so as to separate magnetic crystalline grains of the magnetic superlattice multilayered film.

In this way, the composition and the amount of the non-magnetic additives were adjusted, and the orientation, the structure and the like of the underlayer were optimized, whereby the magnetic film had a crystalline structure of about 3 nm to 9 nm in average grain size. Herein, the average grain size of the crystalline grains is preferably changed suitably for the required recording density, and 4 nm to 7 nm yields particularly favorable properties in terms of balance between crystalline grain separation and magnetic properties degradation. When a granular magnetic film is used for the second and the third magnetic layers, the film formation condition may be adjusted during film formation so as to modulate the composition in the film thickness direction to be a composition graded structure, which is especially preferable because it enables fine adjustment for the high-frequency magnetic field/frequency distribution or the like. The same applies for a Fe-based alloy.

The overcoat 132 was made of C or FCAC, on which the aforementioned lubricant layer was formed. These layers are formed by magnetron sputtering facility including an ultrahigh vacuum chamber, overcoat formation facility, lubricant layer formation facility and the like. Arrows 137, 138 indicate upward and downward magnetization recorded in the perpendicular magnetic recording medium, respectively. The magnetic film has increased average magnetic anisotropy field and so has a high coercive force, which can prevent sufficient recording only with magnetic field from a recording pole, and so the configuration is particularly suitable for narrow track magnetic recording in combination with microwave assisted recording.

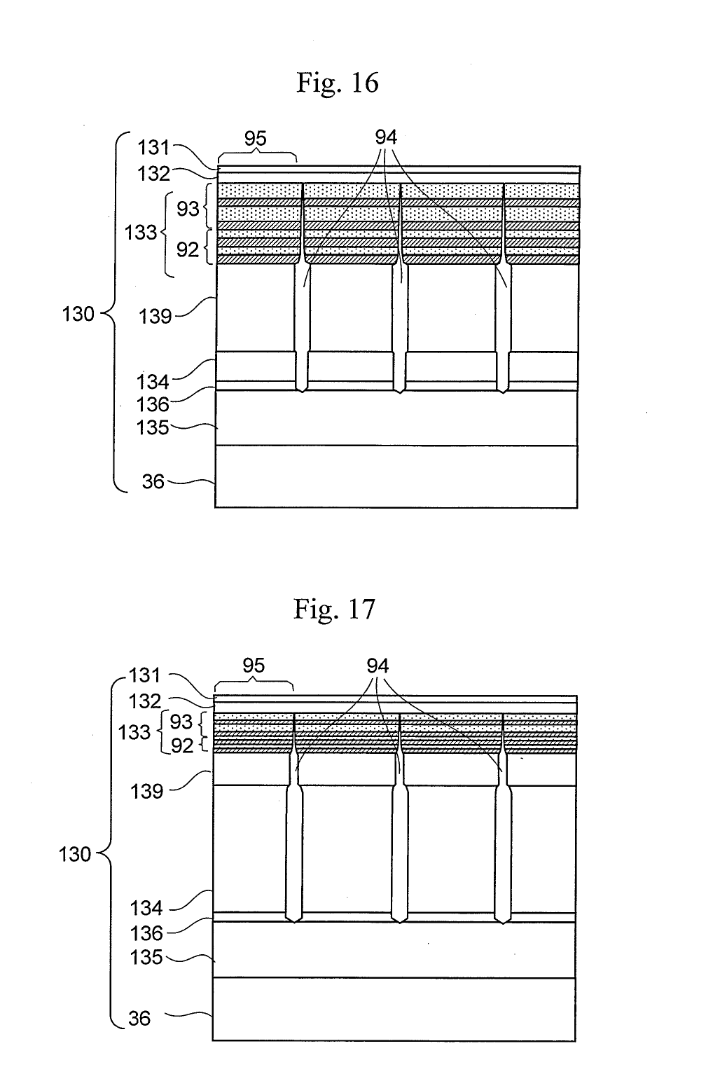

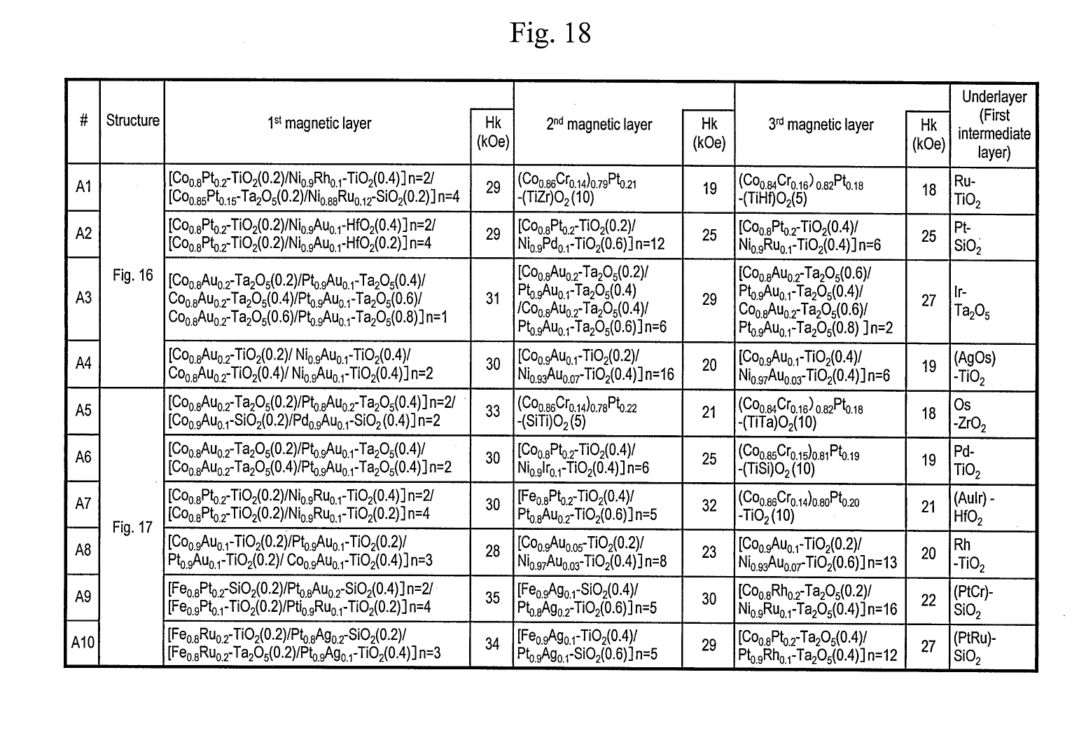

The following describes the structure of the magnetic recording head and the perpendicular magnetic recording medium of the present example. As shown in FIGS. 16 and 17, which schematically show the structure in cross section, segregation of oxides was minimized at the grain boundaries of the first magnetic layer 133 as the outermost layer of the recording layers, thus enabling relatively intense magnetic exchange interaction between magnetic crystalline grains and facilitating magnetization reversal at the outermost plane, while suppressing the rough surface and thus preferentially achieving flyability and anti-wear property. This magnetic recording medium was formed by an inline type multi-target sputtering apparatus including a chamber having a multi cathode to form a magnetic superlattice thin film, and in a chamber for the intermediate layer, the target (6) or (7) of Example 1 or the aforementioned multi-target {(5), (1)} was used as {A, C}, where Δ₁ and Δ₂ were set at 3% and 3%, respectively, thus forming the first intermediate layer. In the chamber to form the magnetic superlattice thin film, A in FIG. 12 was set at 1%, and the multi-sputtering target {(4), (4)} or {(4), (7)} was used as {A, B}, and the film made of materials and the structure shown in FIG. 18 was formed by DC sputtering or RF sputtering, if needed. Properties of the magnetic recording medium were evaluated with a microwave assisted magnetic recording head having the following structure.
slider 50: thin long femto type (1×0.7×0.2 mm³)
head overcoat (FCAC): 1.8 nm
read element 12: TMR (T_{wr}=30 nm)
read gap length Gₛ: 17 nm
first recording pole 122: FeCoNi (T_{ww}=60 nm),
second recording pole 124: FeCoNi
STO 40: Pt(3 nm)/Ru(3 nm)/[CoFe/FeCo](10 nm)/Cu(2 nm)/[Co/Ni](10 nm)/Ru(4 nm)/Cr(4 nm)
FGL width W_{FGL} and height H_{FGL}: W_{FGL}=34 nm, H_{FGL}=36 nm
medium substrate: 3.5-inch NiP plated Al alloy substrate
medium structure: lubricant film(1 nm)/C(2 nm)/{first magnetic layer}/{second magnetic layer}/{third magnetic layer}/(first intermediate layer) (5 nm)/second intermediate layer Ru(5 nm)/CoFeTaZr(10 nm)/Ru(0.5 nm)/CoFeTaZr(10 nm)

As schematically shown in FIGS. 16 and 17, the cross-sectional structure of Samples A1 to A10 includes the first magnetic layer 133 at the outermost surface of the recording layer having a grain boundary segregation layer of a slight thin thickness, thus increasing recordability, in which introduction of oxides was suppressed so as to suppress the rough surface of the medium due to segregation at the grain boundaries and reduce the head flying amount. That is, the additive amount of TiO₂, Ta₂O₅, SiO₂ or Hf was the least among the three layers for formation. That is, 10 volume %, 25 volume % and 17 volume % of the non-magnetic oxides were added to the first, the second and the third magnetic layers in Samples A1 to A4 (FIG. 16), and 7 volume %, 17 volume % and 25 volume % were added thereto in Samples A5 to A10 (FIG. 17).

To keep the medium S/N, in the structure of FIG. 16, for example, 25 volume % of (Ti_{0.95}Zr_{0.05})O₂, TiO₂, Ta₂O₅ was added to the second magnetic layer 139, the amount of which was the largest among the three layers, thus enhancing segregation at the grain boundaries and reducing exchange interaction between crystalline grains. Further in the structure of FIG. 16, 17 volume %, which was an intermediate amount between the first and the second magnetic layers, of (Ti_{0.98}Hf_{0.02})O₂, TiO₂, Ta₂O₅ was added to the third magnetic layer 134 for balance of recordability and S/N. In the structure of FIG. 17, unlike the materials of FIG. 16, the functions of the second magnetic layer and the third magnetic layer were exchanged (described in FIG. 18 in details).

Herein, to promote the crystalline orientation of the magnetic layers and grain boundary segregation of the non-magnetic material, the first intermediate layer in contact with the third magnetic layer was made of Ru—TiO₂, Pt—SiO₂, Ir—Ta₂O₅, (Ag_{0.8}Os_{0.2})—TiO₂, Os—ZrO₂, Pd—TiO₂, (Au_{0.8}Ir_{0.2})—HfO₂, Rh—TiO₂, (N_{0.8}Cr_{0.2})—SiO₂, (Pt_{0.9}Ru_{0.1})—SiO₂ (FIG. 18). The additive amount was set slightly smaller that in the third magnetic layer so as not to inhibit the heteroepitaxial growth of crystalline grains at the magnetic layers. Since Hk of the magnetic superlattice film depends on the perfection (flatness and degree of ordering) of the atomic arrangement at the interface, it is especially important to minimize the additive amount of a non-magnetic material at the intermediate layer or the like for the superlattice type magnetic recording medium of the present example. In this example, the amount was 15 volume % in Samples A1 to A4, and 22 volume % in Samples A5 to A10. When the multi cathode of the aforementioned non-magnetic material was A and the multi cathode including the second group was C, and Δ₁ and Δ₂ were set at 3% and 3%, respectively, for film formation of the manufacturing method of FIG. 13, the crystalline orientation of the magnetic film was improved, and higher Hk by about 5% was achieved, and so such a method was preferable. Similar effects were found when a nitride, a carbide or a boride such as Si₃N₄, TiN, TaN, TiC, ZrC, HfC, TaC, TiB, HfB or ZrB or the mixture of the foregoing was added.

FIG. 18 summarizes the materials and detailed structures of the first, the second and the third magnetic layers in Samples A1 to A10. The first magnetic layer in Samples A1, A2, A4 and A7 was a magnetic superlattice multilayered film including a Co-based alloy thin film and a Ni-based alloy thin film as sub-layers, where the compositions and the film thicknesses were changed to have two types or more of lamination units (the group of n=1). In Samples A3, A5 and A6, the magnetic superlattice film included a Co-based alloy, a Pd- or Pt-based alloy thin film as sub-layers, and in Sample A9 and A10, the magnetic superlattice film included a Fe-based alloy or a Pt-based alloy thin film as sub-layers, whose compositions and film thicknesses were changed similarly to the above to have two types or more of lamination units. In Sample A8, a Pt-based alloy was common, and two types of the lamination units with a Co-based alloy were used. All of them had a feature of providing two types or more of lamination units in the structure of the first magnetic layer, and especially in Samples A3, A4, A6, A8, A9 and A10, six types, four types, four types, four types, four types, and four types of sub-layers were included in the lamination units, respectively. In Sample A4, NiAu—TiO₂ had the same composition and film thickness, and in Sample A6, PtAu—Ta₂O₅ had the same composition and film thickness, and so their substantial types of sub-layers were three types. In A8, PtAu was common between the first and second lamination units, and so their substantial types of sub-layers were three types. Thereby, the number of types of target materials and film formation conditions can be reduced, and so such a structure is preferable. In Sample A3, the second and the third magnetic layers also had two types of more of lamination units similarly to the first magnetic layer by changing their compositions and film thicknesses, where sub-layers of the second and the third magnetic layers had four types and three types, respectively.

The second magnetic layer 139 in Samples A1 and A5 was a granular-structured single layer film of a Co-based alloy, and in Samples A2, A4, A6 and A8, it was a magnetic superlattice multilayered film including a Co-based alloy thin film and a Ni-based alloy thin film as sub-layers. In Sample A3, it was a multilayer film including a Co-based alloy thin film and a Pt-based alloy thin film as sub-layers. In Samples A7, A9 and A10, it was a multilayer film including a Fe-based alloy thin film and a Pt-based alloy thin film as sub-layers.

The third magnetic layer 134 in Samples A1, A5, A6 and A7 was a granular-structured single layer film of a Co-based alloy, and in Samples A2, A4, A8 and A9, it was a magnetic superlattice film including a Co-based alloy thin film and a Ni-based alloy thin film as sub-layers. In Samples A3 and A10, it was a magnetic superlattice film including a Co-based alloy thin film and a Pt-based alloy thin film as sub-layers. Herein in Samples A2, A3, A4, A8, A9 and A10, all of the three magnetic layers were magnetic superlattice multilayered films. In the structure of the third magnetic layer 134 as a magnetic superlattice thin film, similarly to Examples 3, 4 and 5, the film was formed using a multi cathode by the method of FIG. 13, whereby heteroepitaxial growth was promoted at the interface of sub-layers, and so Hk was improved by about 7%, and such a method was preferable. However, in the structure of the second magnetic layer as a magnetic superlattice, since the concentration of a non-magnetic layer in the present example was small of 10 volume % or less and the original heteroepitaxial growth rate was high, and so the effect of improving Hk by such a method was about 3%.

The average Hk of the layers in this example was a nearly Hk monotonic decrease type where the Hk was the highest at the first magnetic layer as shown in FIG. 18. As described in the above, the nearly Hk monotonic decrease type in this case further includes the structure where the average Hk at the second magnetic layer was higher than the average Hk at the first magnetic layer by about 10% as in Sample 7. In any structure, sufficient recording failed when the microwave assisting element did not operate.

The structure of the medium of the present example has the following features:

(1) it was made of magnetic layer materials and a structure so that the average Hk of the magnetic layers decreased nearly monotonously in the depth direction of the medium for easy forced oscillation of medium magnetization by microwave assisting; and

(2) for the easiest forced oscillation at the first magnetic layer, the first magnetic layer (the uppermost layer of the recording layer) had the smallest amount of segregation of a non-magnetic material between crystalline grains, which was a magnetic superlattice thin film including the lamination of two types or more of constituting units having different compositions and/or thicknesses, including one layer of atomic layer (corresponding to 0.2 nm) to four layers of them (corresponding to 0.8 nm), thus steeply changing Hk in the thickness direction at an atomic layer level.

(Advantageous Effect)

Such a control of the Hk distribution at the magnetic layers and the magnetic separation between magnetic crystalline grains enables a perpendicular magnetic recording medium having a structure where Hk decreases nearly monotonously, which has been found as effective to improve read/write characteristics in a 4-spin model. Further the first magnetic layer (uppermost layer) has a magnetic superlattice film structure including two or more types of lamination units, whereby many sub-layers each having different Hk can exist at a very narrow area of several atomic layers. Herein, since Hk depends on the state of interfaces at the magnetic superlattice, the number of interfaces in contact with different materials is important. STO high-frequency magnetic field has distribution and variations in oscillation frequency, and so the probability of forced oscillation and phase matching due to the high-frequency magnetic field increases for the sub-layers each having different Hk. As such, the magnetization reversal mechanism described in FIG. 6 can be generated in a shorter time and steeply. This can narrow a magnetic transition region, and so enables microwave assisted recording at a higher recording density and higher S/N.

As a result of the evaluation of the media of Samples A1 to A10 of the present example using the microwave assisted magnetic recording head of the present example, it was firstly confirmed that every medium shows surface flatness and the flyability of the magnetic recording head that were equal to or more of those of a conventional medium. Next the evaluation of read/write characteristics thereof showed that, in all of Samples A1 to A8, each layer was successfully reversed in the force vibration mode, and the recording track width was 38 nm, which was decided by the STO width of a narrow track (36 nm), and so such a medium was a preferable medium for microwave assisted recording (selective magnetization reversal).

Observation with a transmission electron microscope showed that, in the media of Samples A1 to A4, the first magnetic layer, the second layer and the third layer had segregation of the non-magnetic additives of about 0.8 nm, 1.7 nm and 1.4 nm, respectively. In Samples A5 to A10, the first magnetic layer, the second layer and the third layer had segregation of the non-magnetic additives of about 0.6 nm, 1.4 nm and 1.7 nm, respectively. The magnetic crystalline grains thereof had a so-called granular structure separated at the non-magnetic grain boundaries. As a result, magnetic exchange interaction between crystalline grains was controlled, and medium noise thereof decreased by 8 to 11 dB due to the microwave assisted magnetic recording, compared with a medium not including non-magnetic additives.

Comparison among properties of the structures of Samples A1 to A10 showed that Samples A3, A4, A6, A8 and A10 yielded higher medium S/N than other structures by 1 to 1.5 dB, and they were particularly preferable. This is because the first magnetic layers of Samples A3, A4, A6, A8 and A10 include three types or more of sub-layers in the lamination unit, which means that the number of sub-layers having different Hk values is the largest in the first magnetic layer having the most intense microwave assisted recording field, and the probability for frequency matching and phase matching of magnetization rotation at each atomic layer of a sub-layer with the high-frequency magnetic field having distribution increases in the precession movement of medium magnetization at an atomic layer level. That is, the probability of frequency matching and phase matching increases with the number of sub-layers having different Hk values, and so the SFD and the magnetic transition region thereof decrease, which means an increase in output at high density and conversely a decrease in medium noise. In any structure, the yield of the head obtained was higher by 10% or more than a conventional magnetic superlattice including a single one period of a first magnetic layer, e.g., [Co_{0.9}Au_{0.1}—TiO₂(0.2 nm)/Ni_{0.9}Au_{0.1}—TiO₂(0.4 nm)]ₙ=5. The structures of Samples A3, A4, A6 and A8 achieved still higher yield of the magnetic recording head by 3 to 5% than other structures, and so they were especially preferable.

The second and the third magnetic layers in the structure of Sample A3 included three or more types of sub-layers in its lamination unit, and so similar effects to the above were obtained. That is, as compared with the case of a conventional magnetic superlattice including a single one period of second and third magnetic layers, higher medium S/N by 0.4 dB and 0.2 dB was obtained, and so such a structure was preferable.

Finally, the magnetic recording media of the present example were mounted at a magnetic storage device, and heat-resistivity thereof was evaluated at a high temperature of 65° C. The result showed that all magnetic recording media had sufficient demagnetization durability against heat as well as corrosion resistance.

### Example 3

The present example describes a perpendicular magnetic recording medium having a V(-letter)-shaped Hk distribution and a microwave assisted recording head capable of microwave-assisted recording favorably on a perpendicular magnetic recording medium having a V-shaped Hk distribution especially.

(Microwave Assisted Recording Head)

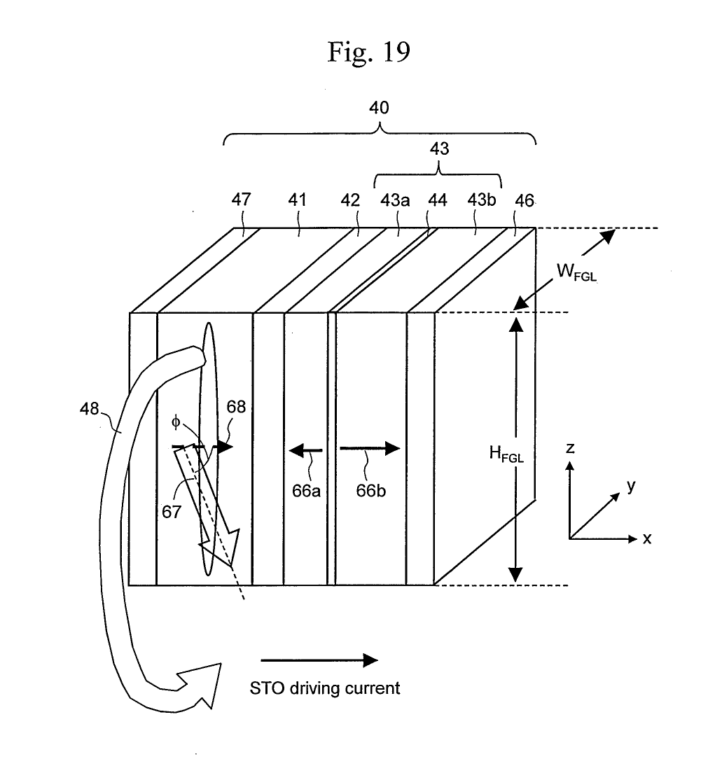

FIG. 19 shows the structure of a STO of the present example. A spin injection layer 43 has the lamination structure including two-layered perpendicular magnetic layers 43a and 43b, between which a non-magnetic intermediate layer 44 made of Ru or the like is inserted for antiparallel coupling of magnetization of the two layers, so as to suppress the generation of a magnetic domain structure at the spin injection layer. Then the product Ms(a)×t(a) of the saturation magnetization Ms(a) and the thickness t(a) of the first magnetic layer 43a closer to the FGL 41 was smaller than the saturation magnetization Ms(b)×t(b) of the saturation magnetization Ms(b) and the thickness t(b) of the second magnetic layer 43b that was more distant from the FGL 41. A non-magnetic intermediate layer 42 between the spin injection layer 43 and the FGL 41 preferably has a thickness of about 0.2 to 4 nm for higher spin injection efficiency.

In the microwave assisted recording head of the present example, magnetization of the FGL and the spin injection layer is rearranged in response to reversal of the STO oscillation controlled magnetic field. Although magnetization of the magnetic layers 43a and 43b making up the spin injection layer are antiparallel, their sum is directed in the direction of the STO oscillation controlled magnetic field. Herein, since the value of the product Ms×t at the first magnetic layer 43a was set smaller than that at the second magnetic layer 43b, magnetization of the first magnetic layer 43a (magnetic layer closer to the FGL) becomes antiparallel to magnetization of the FGL. Then, when STO driving current is applied from the FGL to the spin injection layer structure, the spin torque and spin injection efficiency thereof become very high. At this time, rotation of magnetization 67 at the FGL 41 is large rotation having large angle φ, meaning very stable oscillation, whereby intense high frequency magnetic field by about 1.5 times can be obtained. The spin injection layer 43, the FGL 41, the intermediate layer 42, the underlayer 47, and the cap layer 46 were made of similar materials and had similar thickness to those of Example 2. Another type of the structure of the spin injection layer 43 may be further provided in contact with the underlayer 47 on the opposite side of the FGL 41 in the order of 43b, 44, 43a and 47, from which higher spin injection efficiency can be obtained and so such a structure is preferable.

Next, simulation was performed for the intensity dependency (head-medium spacing dependency) of the high-frequency oscillation magnetic field in the medium depth direction while changing the thickness of the above FGL from 5 to 20 nm and the width W_{FGL} of the FGL from 20 to 50 nm. The result showed that the structure having the height of the FGL larger than the width W_{FGL} thereof enables magnetic flux 48 from a side face of the element at a higher FGL part to form a closed magnetic circuit with a deeper part of the perpendicular magnetic recording medium, thus enabling a high-frequency magnetic field component to reach a deeper part of the perpendicular magnetic recording medium. That is, it was confirmed that, in the structure where W_{FGL} was 20 to 40 nm, and the H_{FGL} of the FGL was 1.5 times or more, i.e., 30 to 60 nm or more at the position where the distance z in the medium depth direction from the FGL was set at 15 nm (z=−15 nm), the magnetic field (y component) from the upper side face of the FGL penetrated to the lowermost layer of the recording layer. Especially in the structure of the ratio of H_{FGL}/W_{FGL} that was two times or more, sufficient intense high-frequency magnetic field y component penetrated to the lowermost layer of the recording layer, which was especially preferable. In this way, the microwave assisted magnetic recording head having this configuration where the ratio of H_{FGL}/W_{FGL} was 1.5 or more was especially favorable in the combination with a magnetic recording medium of the present invention that can exert high performance when the entire recording layer generates forced oscillation by intense high-frequency magnetic field.

Such an advantageous effect leads to drawing of high-frequency magnetic field more effectively to a deep part of the medium (the third magnetic layer at the lowermost layer) by providing a magnetic intermediate layer for orientation control at the magnetic recording medium and decreasing the distance between a soft magnetic part and the magnetic recording head, thus causing forced oscillation of the magnetization at the lower layer of the medium more effectively and leading to excellent microwave assisted recording effect, and so such a combination is especially preferable.

(Magnetic Recording Medium)

The present example describes an exemplary perpendicular magnetic recording medium having a V-shaped Hk distribution that is excellent in thermal stability and improves the limit of recording density in a MAMR method.

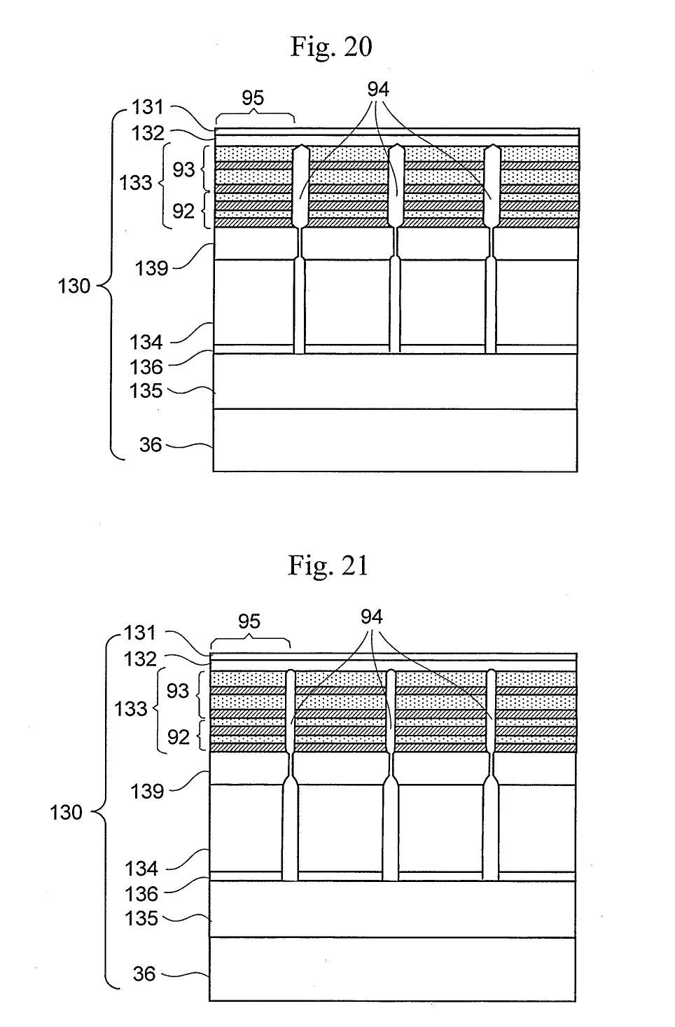

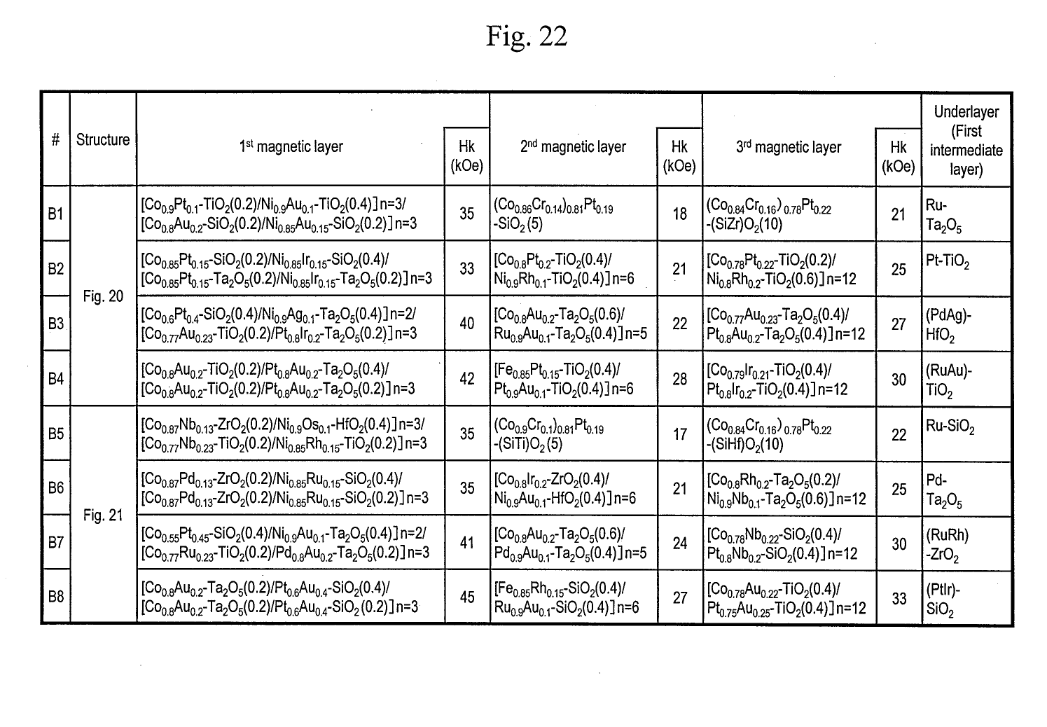

In Example 2, segregation of oxides was minimized at the grain boundaries of the first magnetic layer as the outermost layer of the recording layers, thus enabling relatively intense magnetic exchange interaction between magnetic crystalline grains and facilitating magnetization reversal at the outermost layer, while suppressing the rough surface and thus preferentially achieving flyability and anti-wear property. On the other hand, in the present example, as shown in FIGS. 20 and 21, the amount of non-magnetic additives for grain boundary segregation at the second magnetic layer as the intermediate layer was suppressed to 15 volume % or less, thus keeping large saturation magnetization and thus increasing the assist effect of demagnetization field generated in proportion to the saturation magnetization due to the magnetization reversal of the second magnetic layer for easy induction of magnetization reversal due to forced oscillation at the third magnetic layer as the lowermost layer of the recording layer and enabling an increase in Hk at the third magnetic layer, and preferentially increasing thermal stability of the magnetic recording medium. Herein, the amount of non-magnetic additives for grain boundary segregation at the first and the third magnetic layers was 20 volume % or more to promote grain boundary segregation, thus suppressing exchange interaction between magnetic crystalline grains and achieving high-S/N characteristics. Further in order to draw high-frequency magnetic field to a deep part of the medium (the lowermost layer), the second intermediate layer part of the intermediate layer 136 (corresponding to {first intermediate layer} (5 nm)/second intermediate layer Ru (5 nm) in Example 2) was partially substituted with a magnetic material for orientation control such as CoFeTa, CoNiTa to be a two-layered structure such as Ru/CoFeTa. Thereby, the thickness of the non-magnetic Ru-layer was substantially reduced, and magnetic spacing between the magnetic recording head and the soft magnetic underlayer was decreased while keeping the orientation of the third magnetic layer stacked thereon. Herein, the thickness of the first intermediate layer may be reduced as long as the recording characteristics of the magnetic layer can be achieved from the effect of alloy of the present invention.

The structure of the magnetic recording head and the perpendicular magnetic recording medium is described in the following. As shown in FIGS. 20 and 21, which schematically show the structure in cross-section, the magnetic recording medium is configured so that, to take advantage of the characteristics of the V-shaped Hk distribution, segregation of oxides was minimized at the grain boundaries of the second magnetic layer for relatively intense magnetic exchange interaction between magnetic crystalline grains, thus facilitating magnetization reversal preferentially.

The perpendicular magnetic recording media shown in FIGS. 20 and 21 were made of materials and had a structure shown in FIG. 22, the films of which were formed by an inline type multi-target sputtering apparatus including a multi-target sputtering cathode and a target. In the present example, the target {(5), (1)} of Example 1 was used for a target for multi-target sputtering cathode {A, C} in the intermediate layer formation chamber, the target {(3), (1)} or {(4)(a), (1)} of Example 1 was used for sub-layer {A, C} and the target {(3), (1)}, {(4), (1)}, {(6)(a), (1)} or {(7)(a), (1)} of Example 1 was used for sub-layer {B, C} in the magnetic superlattice thin film formation chamber, where Δ₁ and Δ₂ were set at 1% and 1%, respectively in the co-sputtering of FIG. 13, thus forming the magnetic recording medium. In the magnetic superlattice thin film formation chamber, the manufacturing method of FIG. 12 was used together, where Δ was set at 3% to suppress contamination between sub-layer materials of the magnetic superlattice. When 2 volume % or more and 10 volume % or less of a non-magnetic material made of an oxide, a nitride, a carbide or a boride of the first group element or the mixture of the foregoing was used in the target for multi-target sputtering (4)(a), (6)(a) and (7)(a), the effect to promote segregation can be achieved because the density of the non-magnetic material was 2 volume % or more, and heteroepitaxial growth and adhesiveness substantially equal to those of a pure metal material can be achieved because the density was 10 volume % or less, and Hk also can be achieved by co-sputtering of FIG. 13, and so such a method is especially preferable.
slider 50: thin long femto type (1×0.7×0.2 mm³)
head overcoat (FCAC): 1.8 nm
read element 12: TMR (T_{wr}=30 nm)
read gap length Gₛ: 17 nm
first recording pole 122: FeCoNi (T_{ww}=60 nm),
second recording pole 124: FeCoNi
STO recording element 40: Pt(3 nm)/Ru(3 nm)/[CoFe/FeCo](12 nm)/Cu(2 nm)/[Co/Ni](6 nm)/Ru(2)/[Co/Ni](8 nm)/Ru(3 nm)/Pt(3 nm)
FGL width and height: W_{FGL}=36 nm, H_{FGL}=55 nm
medium substrate: 3.5-inch NiP plated Al alloy substrate
medium structure: lubricant film(1 nm)/C(2 nm)/{first magnetic layer}/{second magnetic layer}/{third magnetic layer}/(first intermediate layer) (3 nm)/{second intermediate layer} (2 nm)/underlayer for orientation control CoFeTa (5 nm)/CoFeTa (7 nm)/CoFeTaZr(10 nm)/Ru(0.5 nm)/CoFeTaZr(10 nm)

Samples B1 to B8 of the present example had a V-shaped Hk distribution where Hk was low at the second magnetic layer 139. To maximize the feature of this structure for easy recording at the second magnetic layer, the amount of non-magnetic additives at the second magnetic layer was suppressed and the thickness of the grain boundary segregation layer was reduced for intense magnetic exchange interaction, and further the second magnetic layer was made of a material having high saturation magnetization so as to assist reversal of the third magnetic layer during the magnetization reversal thereof. Herein, the second magnetic layer, which was made of a magnetic material having high saturation magnetization, further included SiO₂, TiO₂, Ta₂O₅, (SiTi)O₂, ZrO₂ or HfO₂ as additives, where the amount of additives was the least of 9 volume %. Herein, in Samples B1 and B5, the second magnetic layer was Co-based alloy granular structured for simplification, and other layers were magnetic superlattice films.

For the first magnetic layer, Samples B4 and B8 included two types of sub-layer materials, and others included four types. Herein, sub-layers were three types or more, and the lamination units were two types or more. Then, segregation at the grain boundaries was made more intense than the second magnetic layer, thus reducing exchange interaction between crystalline grains for higher S/N. That is, the amount of TiO₂, SiO₂, Ta₂O₅ in Samples B1 to B4 (FIG. 20) was 27 volume % and the amount of TiO₂, SiO₂, Ta₂O₅, ZrO₂ or HfO in Samples B5 to B8 (FIG. 21) was 18 volume % so that their grain boundary segregation was more than the second magnetic layer (9 volume %) to reduce exchange interaction between crystalline grains. As shown in FIG. 11, the outermost surface of the first magnetic layer (outermost surface of the medium) had the highest Hk at an atomic layer level so that a microwave assisted effect having large attenuation acted most effectively there.

For the third magnetic layer, Samples B1 to B4 (FIG. 20) included 18 volume % of SiO₂, TiO₂, Ta₂O₅, (Si_{0.98}Zr_{00.2})O₂ for priority of recordability compared with the first magnetic layer. Samples B5 to B8 (FIG. 21) included more, i.e., 27 volume % of TiO₂, Ta₂O₅, (Si_{0.98}Hf_{0.02})O₂ to promote grain boundary segregation for higher S/N. In Samples B1 and B5, similarly to the second magnetic layer, had a Co-based alloy granular structure for simplification, and other samples included a multilayer film structured thin film including a plurality of sub-layers at the entire region of the magnetic layer.

The first intermediate layer in contact with the third magnetic layer was made of a material and had a structure so as to assist the third magnetic layer to have perpendicular magnetic anisotropy and have a predetermined crystalline grains separation structure. That is, the materials in the present example used were an element of the aforementioned second group and an oxide of an element selected from the elements of the first group that is difficult to dissolve in the element of the second group or an oxide of a compound of the foregoing, including Ru—Ta₂O₅, Pt—TiO₂, (PdAg)—HfO₂, (RuAu)—TiO₂, Ru—SiO₂, Pd—Ta₂O₅, (RuRh)—ZrO₂ or (PtIr)—SiO₂ added thereto. Herein the amount of addition was 16 volume % in Samples B1 to B4 and 25 volume % in Samples B5 to B8. Similar effects were found from the addition of a nitride, a carbide or a boride such as Si₃N₄, TiN, TaN, TiC, ZrC, HfC, TaC, TiB, HfB and ZrB or the mixture of the foregoing as well.

Such adjustment allowed the layers of these samples to have V-shaped Hk distribution as summarized in FIG. 22, where sufficient recording was not performed in any sample when the microwave assisting element was not operated.

(Advantageous effect)

Conventionally it has been considered difficult to increase the amount of non-magnetic substance at the uppermost layer of the recording layer from the viewpoint of flyability and anti-wear reliability of the magnetic recording head. As shown in the manufacturing method of FIG. 13 of the present invention, however, the amount of additives as a non-magnetic substance is suppressed at the lowermost layer interface of the intermediate layer (Δ₁:1%) and the uppermost layer interface (Δ₂:1%) as well as the lowermost layer interface of the recording layer (Δ₁:1%) and the interface of the uppermost layer of the recording layer with C overcoat (Δ₂:1%), thus suppressing mixture at the interface with the C overcoat and at the interface between the first intermediate layer and the magnetic layer, whereby a medium structure without problems about flyability and anti-wear reliability can be achieved even in the structure of FIGS. 20 and 21 including the increased amount of non-magnetic substance at the uppermost layer of the magnetic layer.

The magnetic recording medium for microwave assisted recording of the present example further includes the first magnetic layer as the uppermost layer of the recording layer that was a magnetic superlattice thin film made up of a plurality of lamination units and having Hk distribution. As compared with a conventional magnetic superlattice film having a periodic structure, the magnetic superlattice thin film of the present structure has a decreased number of sub-layers formed repeatedly, and so it has to be controlled more completely for the interface state (mixture) of the sub-layers and values of Hk. Then, in the present example, Δ was set at 3% in the manufacturing method of a magnetic superlattice thin film of FIG. 12, and sub-layers A and B of the magnetic superlattice thin film were formed by the method in combination with the film formation method of FIG. 13, where the sub-layer A was formed by co-sputtering of {A′, C} as the combination of multi targets and the sub-layer B was formed by a same manner using {B′, C}. Herein Δ₁ and Δ₂ were 2% and 2%, respectively. Such a film formation method suppressed mixture between sub-layer substances at the sub-layer interface of the magnetic superlattice thin film and promoted heteroepitaxial growth. Thus high Hk and a favorable Hk distribution were successfully kept at each lamination unit even when the amount of non-magnetic substance to the magnetic superlattice thin film at the uppermost layer (first magnetic layer) of the recording layer exceeded 10 volume %.

As a result, in every perpendicular magnetic recording medium in Samples B1 to B8, each layer reversed in a forced oscillation mode similarly to Example 2, and the recording track width was determined by the STO width of a narrow track. Further, magnetic crystalline grains were magnetically isolated at the uppermost layer of the recording layer where the recording magnetic field has the steepest distribution, and so the magnetic interaction decreased. Therefore compared with comparative example of Example 1 and Example 2, the magnetic transition region width at the recording bit border was decreased by 10% and 5%, respectively. Further, compared with magnetic recording media by a conventional film formation method using the method of FIG. 12 alone (Δ:3%) and Δ:0%, the magnetic recording medium whose magnetic superlattice film was formed by combining FIGS. 12 and 13 had higher S/N by 0.5 dB and 1 dB, respectively, and the yield of the microwave assisted recording head also was higher by 8% and 15%, respectively, due to the effect of the achieved Hk distribution.

In the present example, the density of magnetic elements at the second magnetic layer was increased, and the amount of non-magnetic substance added there was suppressed so as to increase the saturation magnetic flux density of the magnetic film, whereby the assist effect for reversal of the second magnetic layer was improved. As a result, as compared with the structure of Example 2 summarized in FIG. 18, the structure had higher Hk by 18% as average and achieved higher S/N characteristics by about 0.7 dB even when the amount of non-magnetic additives was reduced from Example 2 to reduce grain boundary segregation.

Next, to examine the effect of a magnetic underlayer for crystalline orientation CoFeTa, CoNiTa, CoFeNb or the like, a magnetic recording medium having the structure of Sample B1 and including a magnetic underlayer for crystalline orientation CoFeTa and a magnetic recording medium including an underlayer made of a thick Ru film only similarly to Example 2 were prepared, and their characteristics were evaluated. The result showed that the structure including a magnetic underlayer for crystalline orientation CoFeTa had high O/W characteristics by 3 dB, and so it was confirmed that the magnetic underlayer for crystalline orientation CoFeTa allowed STO magnetic field to reach the lowermost part of the recording layer without impairing the read/write characteristics of a magnetic recording medium.

Next, microwave assisted recording heads having different heights H_{FGL} of 18 nm, 36 nm, 54 nm, 72 nm and 90 nm while having a constant width W_{FGL} of 36 nm were prepared, and their read/write characteristics were evaluated using the medium of Sample B1. Then, the O/W characteristics of the magnetic heads having H_{FGL} of 18 nm, 54 nm, 72 nm and 90 nm were improved by −2 dB, 2 dB, 3 dB and 3 dB, respectively, relative to the magnetic head having H_{FGL} of 36 nm, and so it was confirmed that the height H_{FGL} of the FGL 1.5 times or more, preferably 2 times or more, the width W_{FGL} (=36 nm) leads to a higher write characteristic. In the case of a medium without a magnetic underlayer, such an effect was decreased by half. It was then confirmed that such an intense assist effect from the H_{FGL}/W_{FGL} ratio of 1.5 times or more becomes more remarkable in combination with a magnetic underlayer medium. It was further confirmed that this effect was further improved by 0.5 dB in the structure provided with a spin injection layer 43 on both sides.

Finally, such magnetic recording media were mounted at a magnetic storage device, which was then evaluated for their anti-wear reliability and heat resistance/corrosion resistance by a high-temperature/high-humidity test at 65° C. and 90% RH. Then degradation in error rate or the like was not found in any case, and all of the magnetic recording media in Samples B1 to B8 had sufficient anti-wear reliability, demagnetization durability against heat and corrosion resistance.

### Example 4

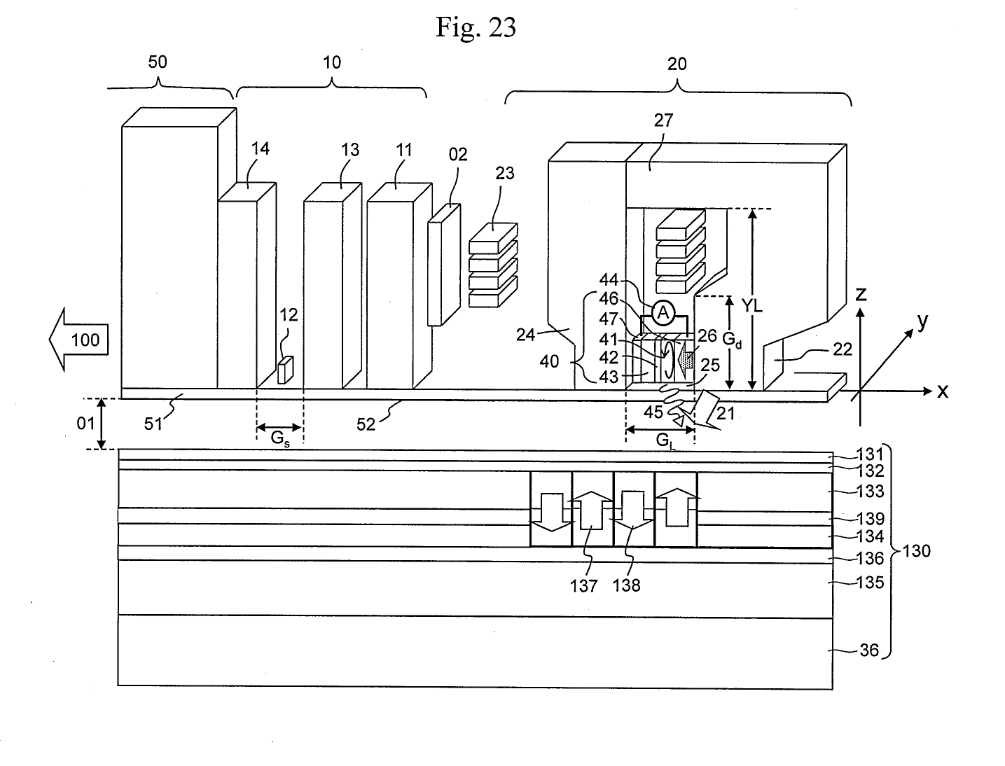

The present example describes a nearly uniform Hk type perpendicular magnetic recording medium, and a ring type magnetic pole structured microwave assisted recording head including a recording pole part and a STO part having the structure shown in FIG. 23.

(Microwave Assisted Recording Head)

A recording head part 20 of the microwave assisted recording head includes: a high-frequency magnetic field oscillation element (STO) 40 provided in a recording gap 25; first and second recording poles 22 and 24 having a width larger than that of the STO to generate recording field 21 and intense and uniform STO oscillation control magnetic field 26 (hereinafter called oscillation control magnetic field) at the recording gap 25; a coil 23 to excite the recording poles; a STO driving power supply 44 and the like. In this example, the first and second recording poles 22 and 24 are configured to have a large volume in the vicinity of the recording gap 25 and have a substantially magnetically-symmetrical ring type structure. High-frequency magnetic field 45 generated by the STO is controlled by the oscillation control magnetic field 26 for the rotation direction and the oscillation frequency. In this ring type pole structure, the oscillation control magnetic field 26 enters the STO film plane uniformly and perpendicularly, and so magnetization of the FGL 41 rotates smoothly in its ideal state, and high-frequency oscillation magnetic field that is more intense than conventional main pole-shield type pole structure by 10 to 20% is obtained stably, and so such a configuration is especially preferable. The recording field in the ring type structure concentrates on the recording gap, and so the magnetic recording depends on the recording gap. Therefore as long as a perpendicular magnetic recording medium is recordable, static recording thereon yields a recorded trace (footprint) that is a shape of a nearly recording gap. In this example, the coil 23 made of a Cu thin film, for example, is wound around the recording pole 24, which may be wound around a rear-end part 27 of the recording pole or around the first recording pole 22, or may be multilayer winding. The recording gap 25 may be made of a non-magnetic thin film such as an Al₂O₃ or Al₂O₃—SiO₂ film formed by sputtering or CVD.

The recording gap length G_{L} was determined while considering the thickness of STO 40, uniformity and intensity of the STO oscillation control magnetic field 26 in the recording gap, intensity and recording field gradient of the recording field 21, a track width, a gap depth G_{d} and the like. The gap depth G_{d} is preferably the track width and the gap length of the recording poles or more in terms of the uniformity of magnetic field, and so the track width of the first recording pole 22 on the trailing side (rear part in the head traveling direction) was 40 to 250 nm, the gap depth G_{d} was 40 to 700 nm and the gap length G_{L} was 20 to 200 nm. For uniform and intense in-gap field, magnetic layers of the magnetic poles in the vicinity of the gap had thicknesses of 40 nm to 3μm. For improved frequency response, smaller yoke length YL and smaller number of coil turns are preferable, and so the yoke length was 0.5 to 10 μm and the number of coil turns was 2 to 8. Especially in the case of a magnetic head for high-speed transferring magnetic storage device used for a server or enterprise purpose, the yoke length is 4 μm or less, and if needed, the magnetic head preferably has a multilayer structure including the lamination of magnetic thin films with high specific resistance or high-saturation magnetic flux magnetic thin films via a non-magnetic intermediate layer.

The first recording pole 22 includes a high-saturation magnetic flux soft magnetic film made of FeCoNi, CoFe, NiFe alloy or the like, which is formed by a thin-film formation process such as plating, sputtering or ion beam deposition to be a single layer or a multilayer. The width T_{ww} of the recording element may be designed suitably for the recording field and the recording density as targets and be processed by a semiconductor process, and may be about 30 nm to 200 nm in size. The magnetic pole in the vicinity of the recording gap may have a film structure that is flat and parallel to the recording gap face or may surround the STO. More preferably, a high-saturation magnetic flux material is used in the vicinity of the recording gap for improved recording magnetic field intensity, and the shape thereof is narrowed toward the recording gap. Similarly to the first recording pole 22, the second recording pole 24 also may include a soft magnetic alloy thin film made of CoNiFe alloy, NiFe alloy or the like, and may have a controlled shape.

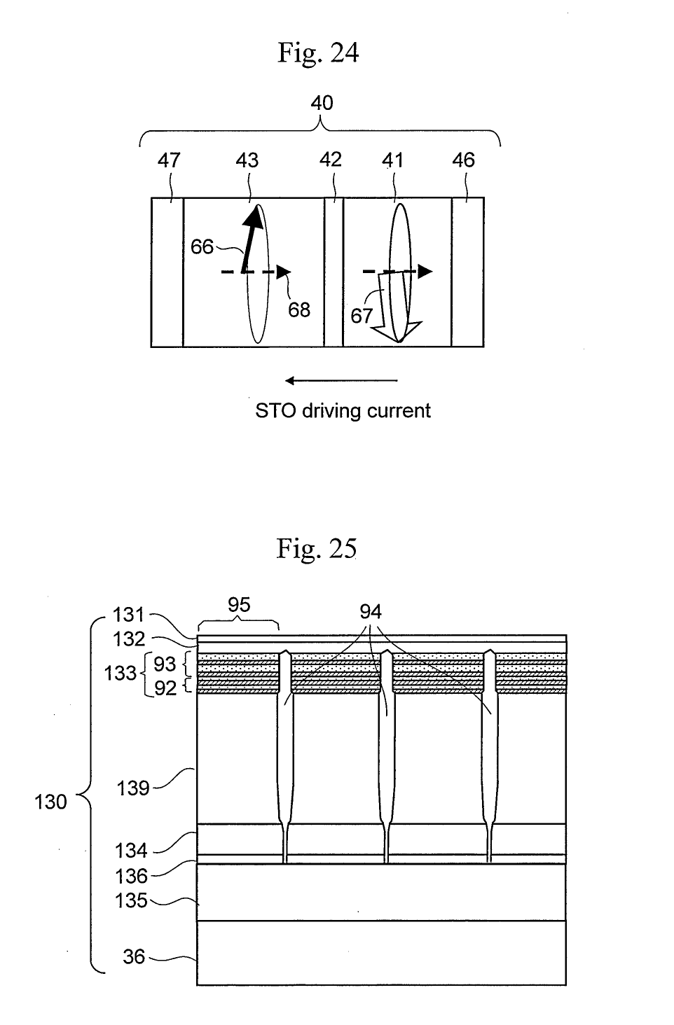

As shown in FIG. 24, the STO includes the lamination of the FGL 41 made of a magnetic material having negative magnetic anisotropy field like a magnetic superlattice thin film including Fe or Fe-based alloy such as Fe_{0.8}Co_{0.2} and Co or Co-based alloy such as Co_{0.94}Fe_{0.01}Pt_{0.05} so as to have a magnetic easy plane at the film plane effectively; a spin injection layer 43 that is a perpendicular magnetic layer made of a hard magnetic thin film having a magnetic anisotropy axis perpendicular to the film plane like a magnetic superlattice thin film made of Ni or Ni-based alloy such as Ni_{0.99}Rh_{0.01} or Ni_{0.9}Fe_{0.1} and Co or Co-based alloy such as Co_{0.9}Nb_{0.1}; and further a non-magnetic intermediate layer 42 sandwiched therebetween, including Au, Ag, Pt, Ta, Ir, Al, Si, Ge, Ti, Cu, Pd, Ru, Cr, Mo or W or an alloy including the foregoing as a major component.

Herein, the spin injection layer preferably includes the Co-based alloy magnetic layer that is thicker than the Ni-based alloy magnetic layer so that the magnitude of magnetic anisotropy field (68 denotes magnetic easy axis) resulting from materials and the magnitude of the effective demagnetizing field in the direction perpendicular of the film surface of the spin injection layer are substantially the same in opposite directions. Then, current was supplied from the FGL side to the spin injection layer side so that magnetization of both layers follows magnetization reversal and instantly leads to high-speed large rotation. Similarly to FIG. 1, a driving current source (or voltage source) and an electrode part of the STO are schematically represented with reference numeral 44, and the recording poles 22 and 24 may be used as electrodes by magnetically coupling the recording poles 22 and 24 at the rear-end part 27 of the recording head but electrically insulating and further by electrically connecting them with the side face of the STO at the gap. Herein, the FGL has a lower oscillation frequency than that of the spin injection layer when they are evaluated alone, but in the operation of the present structure, oscillation occurs immediately following the polarity reversion of the in-gap field with the same frequency.

Such a STO structure allows magnetization of the FGL layer having high crystalline orientation and negative magnetic anisotropy not to follow the magnetization reversal mechanism involving coercive force even when the STO oscillation control magnetic field reverses, but allows to remain in the rotation plane substantially by slightly changing the sign of its inclination angle and continue the high-speed rotation instantly. Such an effect is remarkable in the ring-type magnetic pole structure of the present example where the STO driving magnetic field enters perpendicularly the STO film plane, which was found in the recording pole structure of Example 1 as well.

Next, similarly to Example 3, high-frequency magnetic field generated from the STO was analyzed by simulation. The result showed that, although a preferable thickness of the non-magnetic thin film intermediate layer 42 in the structure of Example 3 was about 0.2 to 4 nm for higher spin injection efficiency, a thickness between the spin injection layer and the FGL in the structure of the present example, i.e., a thickness of the non-magnetic intermediate layer is larger than 4 nm, preferably larger than 5 nm because magnetization of the spin injection layer and magnetization of the FGL rotate at high-speed while keeping their antiparallel state, whereby a high-frequency magnetic field component can reach to a deeper part (lower layer) of the recording layer of the perpendicular magnetic recording medium. The thickness of the non-magnetic intermediate layer exceeding 25 nm, however, degrades the spin injection efficiency greatly, and so the thickness of the non-magnetic intermediate layer is desirably 25 nm or less, and preferably 20 nm or less.

That is, the thickness of the non-magnetic intermediate layer of larger than 4 nm and 25 nm or less, preferably 5 nm or more and 20 nm or less, in the STO having the structure of FIG. 24 enabled an x-component magnetic field from the STO to penetrate sufficiently intensely even at the position where the distance z in the medium depth direction from the STO was 15 nm (z=−15 nm), and so such a structure was preferable (note that a y-component magnetic field penetrated in Example 3). Similarly to Example 3, a CoFeTa magnetic underlayer may be added to the intermediate layer 136 of the magnetic recording medium, thus combining with an underlayer of at least three-layered structure like Ru/NiW/CoFeTa, whereby a high-frequency magnetic field can be drawn to a still deeper part of the medium recording layer (the third magnetic layer as the lowermost layer), and so such a structure is especially preferable. The first intermediate layer, Ru layer, in this case, preferably has a multilayer structure similarly to Example 2 so as to improve crystalline orientation and magnetic anisotropy of the magnetic layer.

(Perpendicular Magnetic Recording Medium)

The following describes nearly uniform Hk type media C1 to C8 of the present example, having a Hk characteristic distribution closer to that of a monolayer medium.

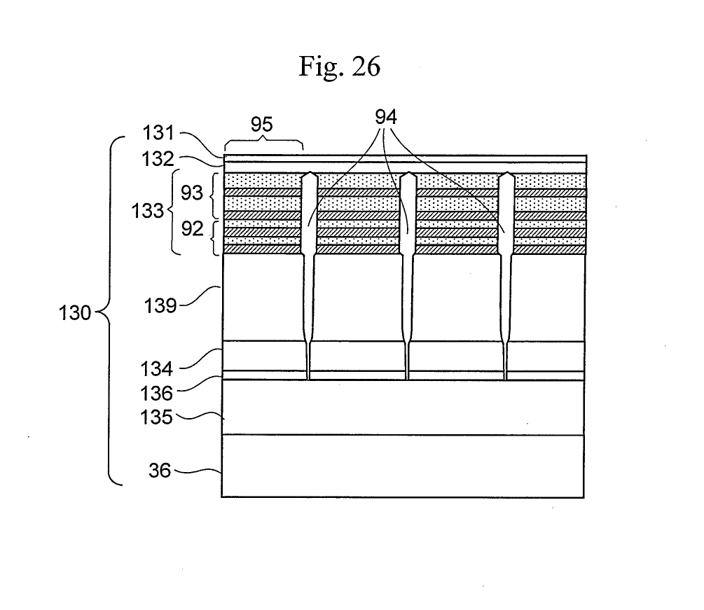

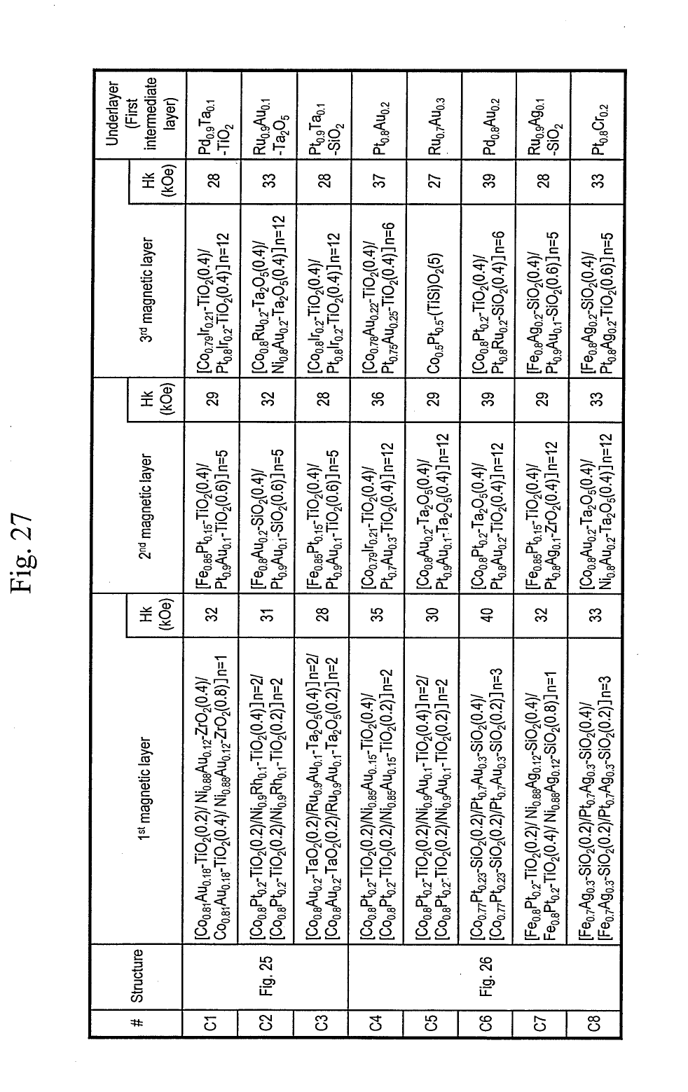

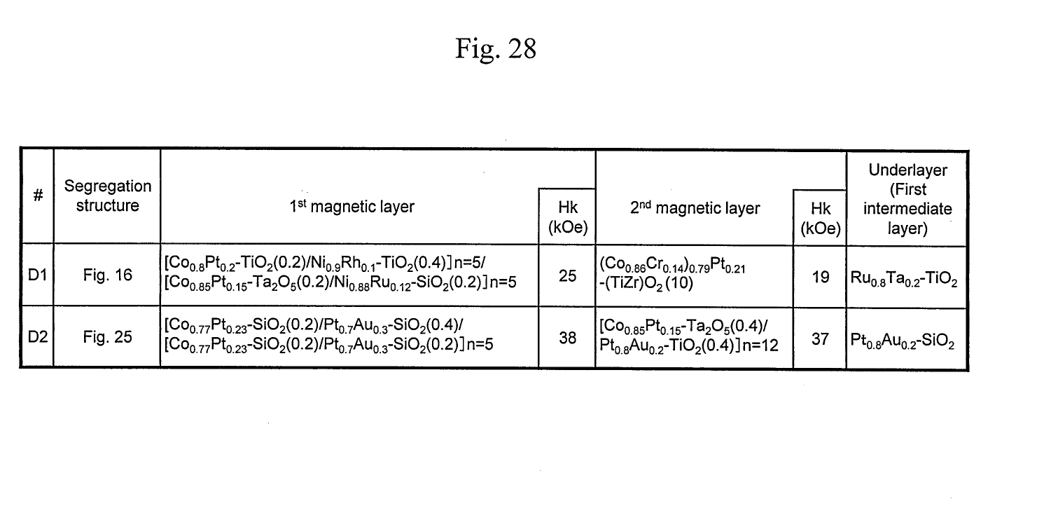

In Samples C1 to C3 (FIG. 25) and C4 to C8 (FIG. 26) of the present example, the amount of non-magnetic additives for grain boundary segregation at the third magnetic layer as the lowermost layer of the recording layer was suppressed to be 10 volume % or less for priority of easy reversal in a weak high-frequency magnetic field as well. In this structure, the second and the third magnetic layers had a function of implementing thermal stability and high S/N characteristics of the magnetic recording medium, and so the second and the third magnetic layers had larger Hk and their grain boundary segregation was promoted and exchange interaction between magnetic crystalline grains was suppressed by adding non-magnetic additives for grain boundary segregation of 15 volume % or more. The magnitude of Hk and exchange interaction between magnetic crystalline grains (corresponding to the amount of non-magnetic additives) was appropriately adjusted as described later in details for each structure of C1 to C3 (FIG. 25) and C4 to C8 (FIG. 26).

The perpendicular magnetic recording media shown in FIGS. 25 and 26 were made of materials and had a structure shown in FIG. 27, the films of which were formed similarly to Example 3 by an inline type multi-target sputtering apparatus including a multi-target sputtering cathode and a target. That is, in the present example, the target {(5), (1)} of Example 1 was used for a target for multi-target sputtering cathode {A, C} in the intermediate layer formation chamber, the target {(3), (1)} or {(4)(a), (1)} of Example 1 was used for sub-layer {A, C} and the target {(3), (1)}, {(4), (1)}, {(6)(a), (1)} or {(7)(a), (1)} of Example 1 was used for sub-layer {B, C} in the magnetic superlattice thin film formation chamber, where Δ₁ and Δ₂ were set at 5% and 5%, respectively in the co-sputtering of FIG. 13, thus forming the magnetic recording medium. In the magnetic superlattice thin film formation chamber, the manufacturing method of FIG. 12 was used together similarly to Example 3, where Δ was set at 5% to suppress mixture between sub-layer materials of the magnetic superlattice.

The following describes details of the magnetic recording head and the magnetic recording medium.
slider 50: thin long femto type (1×0.7×0.2 mm³)
FCAC 51: 1.8 nm
read gap length Gₛ: 16 nm
read element 12: Co₂Fe(Ga_{0.5}Ge_{0.5})/Ag_{0.79}Cu_{0.2}Au_{0.01}/Co₂Fe(Ga_{0.5}Ge_{0.5}) (T_{wr}=38 nm)
first recording pole 22: CoFe (T_{ww}=50 nm)
second recording pole 24: FeCoNi
STO recording element 40: Cu_{0.99}Pt_{0.01}(2 nm)/Cr_{0.9}Ti_{0.1}(2 nm)/[Co_{0.80}Fe_{0.19}Pt_{0.01}/Fe_{0.99}Rh_{0.01}](12 nm)/Cu_{0.99}Au_{0.01}(t nm)/[Co_{0.95}Pt_{0.05}/Ni_{0.95}Ru_{0.05}](4 nm)/Cu_{0.98}Hf_{0.02}(2 nm)/Ru_{0.9}Ti_{0.1}(2 nm)
FGL width: W_{FGL}=50 nm
medium substrate: 2.5-inch NiP plated Al alloy substrate
medium structure: lubricant film(1 nm)/C(2 nm)/{first magnetic layer}/{second magnetic layer}/{third magnetic layer}/(first intermediate layer) (1 nm)/second intermediate layer Ru (4 nm)/underlayer for orientation control CoFeNiTa (5 nm)/CoFeTa (7 nm)/CoFeTaZr(10 nm)/Ru(0.5 nm)/CoFeTaZr(10 nm)

Herein, the thickness t of the CuAu intermediate layer of the STO was 5 nm, 10 nm, 15 nm or 20 nm.

The first, the second and the third magnetic layers included 16 volume %, 22 volume % and 10 volume % of non-magnetic oxides added in Samples C1 to C3 (FIG. 25), respectively, and included 22 volume %, 16 volume % and 10 volume % of non-magnetic oxides in Samples C4 to C8 (FIG. 26), respectively, by multi-target sputtering described in Example 3.

The underlayer had a decreased thickness of the grain boundary segregation layer for improved recordability of the third magnetic layer to be formed thereon. That is, in Samples C1 to C3 and C7, 6 volume % of TiO₂, Ta₂O₅, and SiO₂ were added to Pd_{0.9}Ta_{0.1}, Ru_{0.9}Au_{0.1} and Pt_{0.9}Ta_{0.1} and Ru_{0.9}Ag_{0.1}, respectively, by multi-target sputtering similarly to the magnetic layers. The underlayer was made of Pd_{0.9}Ta_{0.1}—TiO₂, Ru_{0.9}Au_{0.1}—Ta₂O₅, Pt_{0.9}Ta_{0.1}—SiO₂ or Ru_{0.9}Ag_{0.1}—SiO₂, where in Samples C4˜C6 and C8, the underlayer was made of Pt_{0.8}Au_{0.2}, Ru_{0.7}Au_{0.3}, Pt_{0.8}Au_{0.2} and Pt_{0.8}Cr_{0.2}, to which no oxides were added. Similar effects were found from the structure including a nitride, a carbide or a boride such as Si₃N₄, TiN, TaN, TiC, ZrC, HfC, TaC, TiB, HfB or ZrB or the mixture of the foregoing.

In Samples C1 to C3 (FIG. 25), the first magnetic layer thereof included 16 volume % of TiO₂ and Ta₂O₅ added thereto, which was slightly less for easy forced oscillation by microwaves, and the second magnetic layer including a Fe-based alloy thin film and a Pt-based alloy thin film as sub-layers included 22 volume % of TiO₂ and SiO₂ to enhance segregation at the grain boundaries compared with the first magnetic layer and reduce exchange interaction between crystalline grains for a higher S/N structure. In this structure, Hk is the highest at the outermost plane as shown in FIG. 11 at an atomic layer level at the outermost surface of the medium recording layer. The third magnetic layer including sub-layers made of a Co-based alloy thin film and a Ni-based or Pt-based alloy thin film included the least amount of TiO₂, Ta₂O₅, SiO₂ added thereto that was 10 volume % for the easiest forced oscillation and magnetization reversal. Compared with the nearly Hk monotonic decrease type of Example 2 and the V-shaped Hk distribution type of Example 3, the distribution of additives for grain boundary segregation in the thickness direction of the present structure was suppressed as a whole, so that the grain boundary structure became closer to a single layer structure, i.e., a nearly uniform Hk type structure. Materials thereof also were selected so that their characteristics became closer among the layers.

In Samples C4 to C8 (FIG. 26), the amount of additives and the functions were exchanged between the first and the third magnetic layers in Samples C1 to C3. For the third magnetic layer of Sample C5, Co_{0.5}Pt_{0.5}—(Ti_{0.8}Si_{0.2})O₂ of 5 nm in thickness and including 10 volume % of (Ti_{0.8}Si_{0.2})O₂ added thereto was formed at 300° C., thus forming a thin film made of L1₁ type Co_{0.5}Pt_{0.5}-based ordered alloy (fcc structure) having the degree of ordering at 0.5. Herein, the L1ᵢ type Co_{0.5}Pt_{0.5}-based ordered alloy has the (111) plane that is the close-packed plane of a fcc structure having a lamination structure of two types of atomic layers of Co and Pt, having features that its magnetic easy axis is perpendicular to the close-packed plane of the atom and the control of crystalline grains orientation is easy. The degree of ordering indicates the ratio of the ordered structure in the lamination structure, and the present example uses a method that is used for powder X-ray diffraction analysis. Then the degree of ordering was found from the square root, {(Iₛ/I_{f})ₑₓₚ/(Iₛ/I_{f})_{cal}}⁵ of the ratio between the experimental value (Iₛ/I_{f})ₑₓₚ and the calculated value obtained for powder sample (Iₛ/I_{f})_{cal}, where Iₛ denotes superlattice reflection intensity in the lamination structure and I_{f} denotes basic reflection. The other second and third magnetic layers in Samples C4 to C6 were a magnetic superlattice thin film including a Co-based alloy thin film and a Pt-based alloy thin film, respectively, the second and third magnetic layers in Samples C7 and C8 were a magnetic superlattice thin film including a Fe-based alloy thin film and a Pt-based alloy thin film, respectively, and the second magnetic layer in Sample C8 was a magnetic superlattice thin film including a Co-based alloy thin film and a Ni-based alloy thin film,

Every magnetic recording medium in the above Samples C1 to C8 had high perpendicular magnetic anisotropy at their magnetic layers, and sufficient recording failed in any medium when the microwave assisting element was not operated.

Similar characteristics were obtained from a m-D0₁₉ type Co_{0.8}Pt_{0.2}—(Ti_{0.8}Ta_{0.2})O₂ ordered alloy (fct structure) having the degree of ordering 0.5 also. Herein, the aforementioned L1₁ type Co_{0.5}Pt_{0.5}-based ordered alloy and the m-D0₁₉ type Co_{0.8}Ptₒ (Ti_{0.8}Ta_{0.2})O₂ ordered alloy were especially preferable, because when using a Pt—Au alloy, a Pd—Au alloy, and a Ru—Au alloy of the present invention having a fcc structure and (111) oriented, a relatively low film formation temperature at 250 to 300° C. easily enabled ordering of the degree of ordering at 0.4 to 0.6 and high Hk of 20 kOe or more. Herein, they may include an oxide, a nitride, a carbide or a boride including at least one type of element selected from the first group consisting of Si, Ta, Ti, Zr and Hf or the mixture of the foregoing added thereto, or 10 to 50 at % of Ni may be added, from which excellent characteristics were obtained.

FIG. 27 summarizes the aforementioned structures and values of Hk, where values of Hk of the layers in each sample are substantially constant, i.e., a nearly uniform Hk type. In Samples C2 and C4, however, the average Hk increased by 1 kOe in the order of the first, the second and the third magnetic layers, which is due to enhanced effective recording field resulting from the exchange coupling field between the first and the second magnetic layers and the effect of demagnetization field as described in the above. The structure where Hk of the second and the third magnetic layers increases by 10% from the first magnetic layer also can exert a microwave assisted effect, and such case also can be dealt with as the nearly uniform Hk type.

(Advantageous Effects)

Similarly to Example 3, the present method for film formation did not pose any problems about flyability and anti-wear reliability in the structure including 10% or more of a non-magnetic substrate added to the magnetic superlattice thin film of the uppermost layer of the recording layer (first magnetic layer) as well, and each lamination unit thereof achieved high Hk, resulting in a favorable Hk distribution in the uppermost layer. Thus in every magnetic recording medium in Samples C1 to C8, each layer reversed in a forced oscillation mode similarly to Examples 1 to 3, and the recording track width was determined by the STO width of a narrow track due to the selective magnetization reversal effect from microwaves. Further, compared with magnetic recording media by a conventional film formation method using the method of FIG. 12 alone (Δ:5%) and Δ:0%, the magnetic recording medium whose magnetic superlattice film was formed by combining FIGS. 12 and 13 exerted the effect to achieve a favorable Hk distribution and had higher S/N by 0.4 dB and 0.8 dB, respectively, than the comparative examples and the yield of the microwave assisted recording head also was higher by 6% and 12%, respectively, than the comparative examples.

The present example was configured so that the density of magnetic elements in the third magnetic layer was increased and the amount of non-magnetic substance added thereto was suppressed, so as to achieve a certain degree of exchange interaction and a Hk distribution that was a nearly uniform distribution similar to a single layer magnetic film by adjusting the magnetic materials and the layer structure, whereby magnetization reversal easily occurred as a whole in spite of high Hk. As a result, Hk was higher by 30% and 10% as average than the structures of Examples 2 and 3 as in the magnetic recording medium of Sample C6, and thermal stability and recording density higher by 30% and 10% than these, respectively, were achieved by maximizing the microwave assisted function.

In the structure of the present example, however, the lowermost layer of the recording layer had difficulty in reversal, and compared with Examples 1 to 3, O/W thereof was lower by about 3 dB than the case of having equivalent Hk. However, characteristics at a practically acceptable level, i.e., O/W characteristics of about 26 to 30 dB were obtained by combining the present structure with a magnetic underlayer or by combining with the STO having the structure of Example 3.

To examine the effect of a magnetic underlayer for crystalline orientation, a magnetic recording medium having the structure of Sample C3 and including a CoFeNiTa magnetic underlayer for crystalline orientation and a magnetic recording medium including a thick Ru film only similarly to Example 2 as a comparative example were prepared, and their characteristics were evaluated. The result showed that the structure including a CoFeNiTa magnetic underlayer for crystalline orientation had higher O/W characteristics by 2.5 dB, and so it was confirmed that the CoFeTa magnetic underlayer for crystalline orientation allowed STO magnetic field to reach the lowermost part of the recording layer while keeping the characteristics of a perpendicular magnetic recording medium. Thereby, the feature of the present example that is a high S/N structure allowing a non-magnetic material to segregate at grain boundaries at the first magnetic layer as the uppermost layer of the recording layer having the highest Hk was utilized, and so compared with the structure of Example 2 (FIGS. 16 and 17), higher medium S/N by about 1 dB was obtained.

Further evaluation was performed using the medium of Sample C3 about characteristics of microwave assisted recording heads having different gaps between the spin injection layer and the FGL, i.e., the thicknesses of the intermediate layer t of 5 nm, 10 nm, 15 nm and 20 nm. Compared with the microwave assisted recording characteristics of a conventional example having t=2 nm, the O/W characteristics were improved by 1.5 dB, 2.5 dB, 2 dB and 1.5 dB for the thicknesses of the intermediate layer of 5 nm, 10 nm, 15 nm and 20 nm, respectively. In this way, it was confirmed that high recording characteristics were obtained from the thickness t of the intermediate layer of more than 4 nm and 20 nm or less. In the case of a medium without a magnetic underlayer for orientation control, such an effect was decreased by half, and so it was confirmed that such an effect from the increased gap between the spin injection layer and the FGL becomes especially remarkable in combination with a magnetic underlayer medium.

Finally, such magnetic recording media were mounted at a magnetic storage device, which was then evaluated for their heat resistance and corrosion resistance by a high-temperature/high-humidity test at 65° C. and 85% RH. Then all of the magnetic recording media had sufficient demagnetization durability against heat and corrosion resistance. They had no problems about flyability and anti-wear resistance of the magnetic recording head as well.

### Example 5

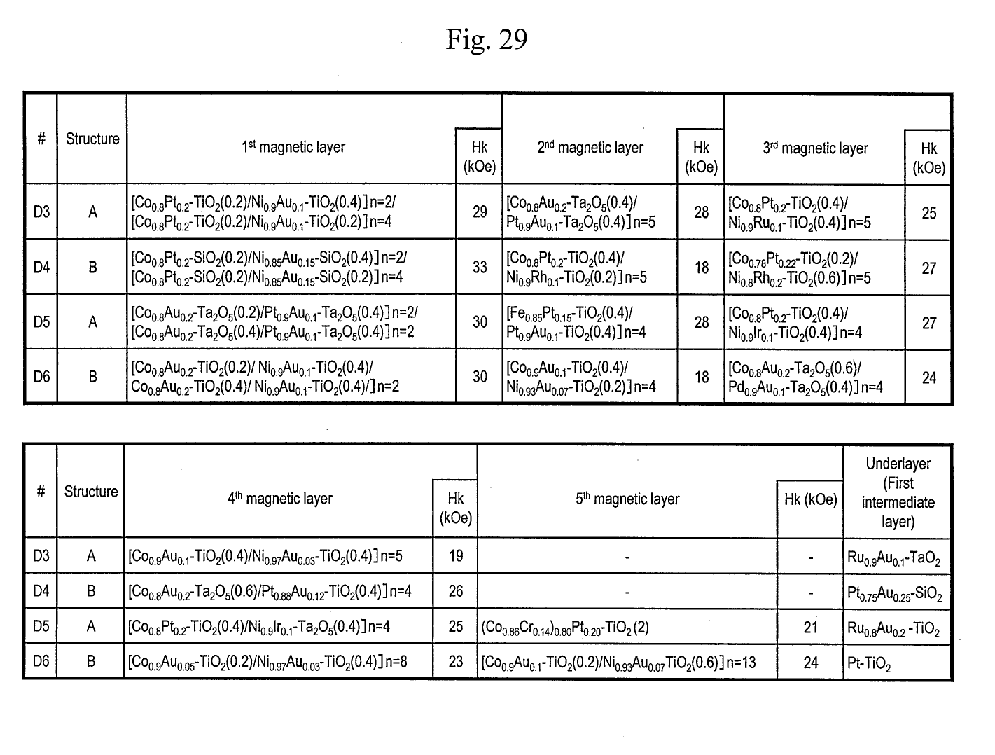

Examples 1 to 4 mainly describe examples having three-layer structured recording layer in the perpendicular magnetic recording media. Referring to FIGS. 28 and 29, the present example describes perpendicular magnetic recording media including two-layer, four-layer and five-layer structured recording layers.

(Perpendicular Magnetic Recording Medium)

Films were formed in the present example using an inline type sputtering apparatus including a multi-target sputtering cathode and a target similarly to Example 3. That is, in the present example, the target {(5), (1)} of Example 1 was used for a target for multi-target sputtering cathode {A, C} in the intermediate layer formation chamber, the target {(3), (1)} or {(4)(a), (1)} of Example 1 was used for sub-layer {A, C} and the target {(3), (1)}, {(4), (1)}, {(6)(a), (1)} or {(7)(a), (1)} of Example 1 was used for sub-layer {B, C} in the magnetic superlattice thin film formation chamber, where Δ₁ and Δ₂ were set at 3% and 1%, respectively in the co-sputtering of FIG. 13, thus forming the magnetic recording medium. In the magnetic superlattice thin film formation chamber, the manufacturing method of FIG. 12 was used together similarly to Example 3, where Δ was set at 2% to suppress mixture between sub-layer materials of the magnetic superlattice. The following describes basic structures of samples D1 and D2 (FIG. 28) where the recording layer has a two-layered structure indicated by { } in the following, samples D3 and D4 (FIG. 29) having a four-layered structure, and samples D5 and D6 (FIG. 29) having five-layered structure.
medium substrate: 3.5-inch Ni—P plated Al substrate
medium structure: lubricant film(1 nm)/C(2 nm)/{magnetic layer}/(first intermediate layer) (4 nm)/magnetic underlayer for orientation control CoFeTa (5 nm)/CoFeTaZr (10 nm)/Ru(0.5 nm)/CoFeTaZr(10 nm)

In the two-layer structured media D1 and D2 having the structure shown in FIG. 28, the first magnetic layers thereof were [Co-based alloy/Ni-based alloy], [Co-based alloy/Pt-based alloy] magnetic superlattice thin films having different compositions, and the second magnetic layers thereof were a CoCrPt granular magnetic film and a [Co-based alloy/Pt-based alloy] magnetic superlattice thin film. As materials of the grain boundary segregation layers, Sample D1 included 4 volume % of TiO₂, 5 volume % of Ta₂O₅, and 3 volume % of SiO₂ in the sub-layers of the first magnetic layer and 28 volume % of (Ti_{0.95}Zr_{0.05})O₂ in the sub-layers of the second magnetic layer, and Sample 2 included 4 volume % of SiO₂ in the sub-layers of the first magnetic layer and 26 volume % of Ta₂O₅ and 30 volume % of TiO₂ in the sub-layers of the second magnetic layer. Samples D1 and D2 further included (Ru_{0.95}Ta_{0.05})-26 volume % TiO₂ and Pt_{0.95}Au_{0.05}-18 volume % SiO₂, respectively, as the first intermediate layer (underlayer). In the intermediate layer film formation chamber, the aforementioned RuTa-based alloy or a PtAu alloy was provided at the multi-target A of FIG. 7, and TiO₂ or SiO₂ was provided at the multi-target C, and similarly to Examples 1 to 4, Δ₁ and Δ₂ (FIG. 13) were set at 2% and 1%, respectively. In the magnetic superlattice thin film formation chamber, the aforementioned Co-based alloy was provided at the multi-target A, the aforementioned Ni-based alloy or Pt-alloy was provided at the multi-target B and the aforementioned oxide was provided at the multi-target C, and similarly to Examples 1 to 4, Δ (FIG. 12) was set at 1.5%, and Δ₁ and Δ₂ (FIG. 13) were set at 1% and 2%, respectively, for film formation. Herein, Sample D1 had Hk of the first and the second magnetic layers that were 25 kOe and 19 kOe, respectively, and Sample D2 had Hk of the first and the second magnetic layers that were 38 kOe and 37 kOe, respectively. Sample D1 was a Hk monotonic decrease type (corresponding to Sample A) and Sample D2 was a nearly uniform Hk type (corresponding to Sample C). Sample D1 had the magnetic superlattice film of the first magnetic layer made of two types of lamination units, and Sample D2 had four types of lamination units, in each of which the lamination unit at the outermost plane of the recording layer had the highest Hk.

In the four-layer structured medium D3 having the structure shown in FIG. 29, the first magnetic layer thereof was [Co-based alloy/Ni-based alloy], the second magnetic layer was [Co-based alloy/Pt-based alloy], and the third and the fourth magnetic layers were [Co-based alloy/Ni-based alloy] magnetic superlattice thin films. In Sample D4, the first, the second and the third magnetic layers thereof was [Co-based alloy/Ni-based alloy] and the fourth magnetic layer was a [Co-based alloy/Pt-based alloy] magnetic superlattice thin film. As materials for the grain boundary segregation, Sample D3 included 5 volume %, 20 volume % and 10 volume % of TiO₂ in the sub-layers of the first, the third and the fourth magnetic layers, respectively, and included 20 volume % of Ta₂O₅ in the second magnetic layer, and Sample D4 included 5 volume % of SiO₂ in the sub-layers of the first magnetic layer, 20 volume % of Ta₂O₅ in the second and the third magnetic layers, and 25 volume % of Ta₂O₅ or TiO₂ in the fourth magnetic layer.

Samples D3 and D4 further included (Ru_{0.9}Au_{0.1})-8 volume % Ta₂O₅ and Pt_{0.75}Au_{0.25}-8 volume % SiO₂, respectively, as the first intermediate layer (underlayer). In the intermediate layer film formation chamber, the aforementioned RuAu alloy or a PtAu alloy was provided at the multi-target A of FIG. 7, and Ta₂O₅ or SiO₂ was provided at the multi-target C, and similarly to Examples 1 to 4, Δ₁ and Δ₂ (FIG. 13) were set at 2% and 2%, respectively, for film formation of these layers. In the magnetic superlattice thin film formation chamber, the aforementioned Co-based alloy was provided at the multi-target A, the aforementioned Ni-based alloy or Pt alloy was provided at the multi-target B and the aforementioned oxide was provided at the multi-target C, and similarly to Examples 1 to 4, Δ (FIG. 12) was set at 3%, and Δ₁ and Δ₂ (FIG. 13) were set at 2% and 2%, respectively. Herein, Sample D3 had Hk of the first, the second, the third and the fourth magnetic layers that were 29 kOe, 28 kOe, 25 kOe and 19 kOe, respectively, and Sample D4 had Hk of the first, the second, the third and the fourth magnetic layers that were 33 kOe, 18 kOe, 27 kOe and 26 kOe, respectively. Sample D3 was a Hk monotonic decrease type (corresponding to Sample A) and Sample D4 was a V-shaped Hk distribution type (corresponding to Sample B). Both of the samples had the first magnetic layer at the outermost plane of the recording layer made of two types of lamination units, in which the lamination unit on the outermost plane side had the highest Hk.

In the five recording layer structured medium D5 having the structure shown in FIG. 29, the first magnetic layer thereof was [Co-based alloy/Pt-based alloy], the second magnetic layer was [Fe-based alloy/Pt-based alloy], the third and the fourth magnetic layers were [Co-based alloy/Ni-based alloy] magnetic superlattice thin films, and the fifth magnetic layer was a CoCrPt granular magnetic layer. In Sample D6, the first, the second, the fourth and the fifth magnetic layers thereof was [Co-based alloy/Ni-based alloy] and the third magnetic layer was a magnetic superlattice thin film including the lamination unit of [Co-based alloy/Pt-based alloy]. As materials for segregation at the grain boundaries, Sample D5 included 4 volume % of Ta₂O₅ in the sub-layers of the first magnetic layer, 20 volume % of TiO₂ in the sub-layers of the second and the third magnetic layers, 10 volume % of TiO₂ or Ta₂O₅ in the sub-layers of the fourth magnetic layer and 15 volume % of TiO₂ in the granular layer of the fifth magnetic layer. Sample D6 included 5 volume %, 10 volume %, 10 volume % and 25 volume % of TiO₂ in the sub-layers of the first, the second, the fourth and the fifth magnetic layers, respectively, and 15 volume % of TiO₂ in the sub-layers of the third magnetic layer. Samples D5 and D6 further included (Ru_{0.8}Au_{0.2})-13 volume % TiO₂ and Pt-20 volume % SiO₂, respectively, as the first intermediate layer (underlayer).

In the intermediate layer film formation chamber, the aforementioned RuAu alloy or Pt was provided at the multi-target A of FIG. 7, and Ta₂O₅ or TiO₂ was provided at the multi-target C, and similarly to Examples 1 to 4, Δ₁ and Δ₂ (FIG. 13) were set at 2% and 1%, respectively, for film formation of these layers. In the magnetic superlattice thin film formation chamber, the aforementioned Co- or Fe-based alloy was provided at the multi-target A, the aforementioned Ni-based alloy, Pt alloy or Pd alloy was provided at the multi-target B and the aforementioned oxide was provided at the multi-target C, and similarly to Examples 1 to 4, A (FIG. 12) was set at 1%, and Δ₁ and Δ₂ (FIG. 13) were set at 1% and 1%, respectively. Herein, Sample D5 had Hk of the first, the second, the third, the fourth and the fifth magnetic layers that were 30 kOe, 28 kOe, 27 kOe, 25 kOe and 21 kOe, respectively, and Sample D6 had Hk of the first, the second, the third, the fourth and the fifth magnetic layers that were 30 kOe, 18 kOe, 24 kOe, 23 kOe and 24 kOe, respectively. Sample D5 was a Hk monotonic decrease type (corresponding to Sample A) and Sample D6 was a V-shaped Hk distribution type (corresponding to Sample B). Sample D5 had the magnetic superlattice film of the first magnetic layer made of two layers of lamination units, and Sample D6 had four layers of lamination units, in which the lamination unit on the outermost plane side had the highest Hk.

For every magnetic recording medium in Samples D1 to D6, sufficient recording was failed in any medium when the microwave assisting element was not operated.

It was confirmed that, when a magnetic pattern of 600 nm² in dot area was formed at the magnetic recording medium of the present invention by pattern etching, non-magnetic ion implantation or the like, thus forming a bit pattern medium, the sharp recording field gradient of microwave assisted recording was utilized, and so high-density of 1 to 2 Tb/in² or more was easily achieved. Herein, addition of a non-magnetic material of 10 volume % or more at the grain boundaries may cause the formation of magnetic domains in the magnetic dots, which may cause an error unfavorably, and so the amount of a non-magnetic material added is preferably 10 volume % or less.

(Advantageous Effect)

In every perpendicular magnetic recording medium in Samples D1 to D6 of the present example, each recording layer reversed in a forced oscillation mode similarly to Examples 1 to 4, and the recording track width was determined by the STO width of a narrow track due to the selective magnetization reversal effect from microwaves.

The structures of Samples D1 and D2 achieved higher medium S/N than the comparative example of Example 1 by 2 dB. However since they had a small total number of the magnetic layers (lamination units), it was difficult to obtain sufficient matching with the head-medium spacing dependency of the microwave assisted magnetic field intensity, and so their O/W was lower by about 4 dB compared with three-layer structured Examples 1 to 4 having equivalent Hk. However, characteristics at a practically acceptable level, i.e., O/W characteristics of about 26 to 29 dB were obtained by combining the present structure with a magnetic underlayer or by combining with the STO having the structure of Example 3. Further the present structure decreased the number of cathodes in the film formation facility and the types of sputtering target materials, and so the cost thereof was more advantageous than that of the three-layered structure by about 2%.

Magnetic recording media in Samples D3, D4 and D5, D6 easily achieved sufficient matching with the head-medium spacing dependency of the microwave assisted magnetic field intensity because they had a total number of the magnetic layers of four layers or five layers that were more than the three layers of Examples 1 to 4. Their O/W was higher by about 2 to 3 dB than media of Examples 1 to 4 having equivalent Hk and their medium S/N also was higher by 0.4 to 0.6 dB, and so they were the most preferable. Then the yield of the magnetic recording medium of the four-layered structure and the five-layered structure was increased by 3% and 4%, respectively, from that of the three-layered structure, which compensated for an increase in cost due to an increase of the number of chambers in the multi-target sputtering apparatus and the number of multi-targets, resulting in the effect to improve cost by 2% and 3%, respectively. Herein, for the number of layers more than five, such an improvement effect was not increased due to saturation, and so it was confirmed that five layers achieved practically sufficient effect to improve the O/W, S/N, yield and cost.

Finally, the magnetic recording media of the present example were mounted at a magnetic storage device, which was then evaluated for their heat resistance and corrosion resistance by a high-temperature/high-humidity test at 65° C. and 85% RH. Then all of the magnetic recording media had sufficient demagnetization durability against heat and corrosion resistance. They had no problems about flyability and anti-wear resistance of the magnetic recording head as well, and so excellent magnetic recording media for microwave assisted recording were obtained.

### Example 6

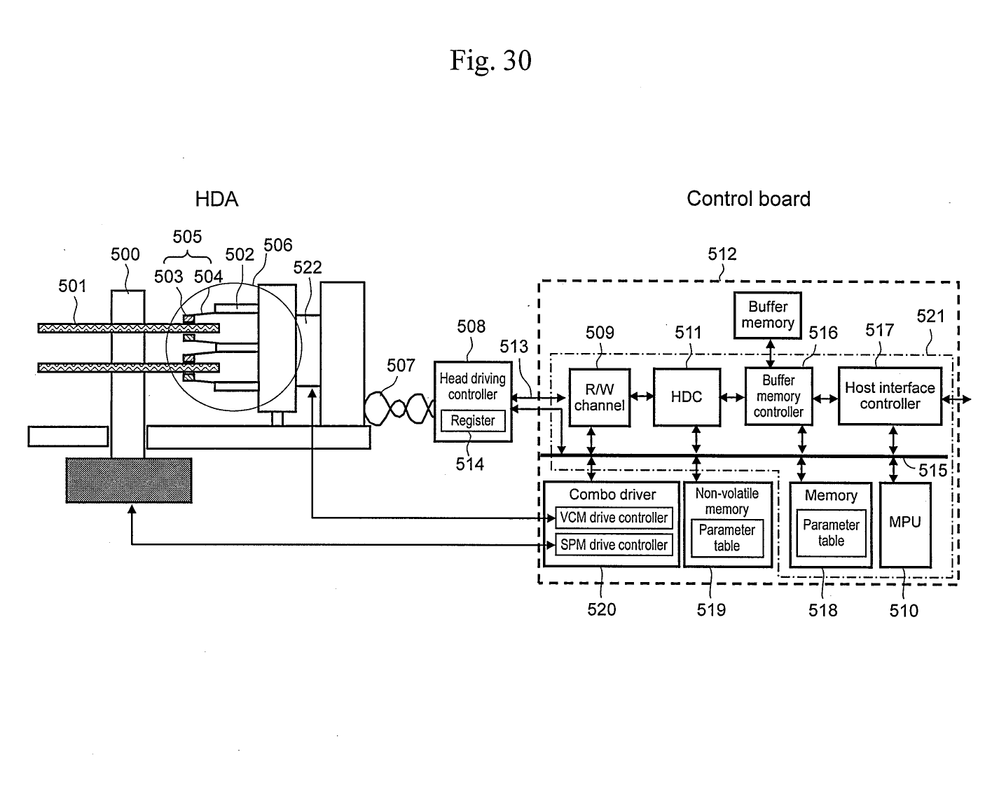

Referring to FIG. 30, the following describes an exemplary magnetic storage device including the magnetic recording media and microwave assisted recording heads described in Examples 1 to 5 mounted thereon.

(Magnetic storage device)

The magnetic storage device of FIG. 30 includes: a spindle motor 500; a perpendicular magnetic recording medium 501; a high-rigidity arm 502; a HGA (this may be simply called a magnetic recording head) 505; an head stack assembly (HSA) 506; a head driving controller (R/W-IC) 508; a R/W channel 509; a microprocessor (MPU) 510; a disk controller (HDC) 511; a buffer memory controller 516 that controls a buffer memory; a host interface controller 517; a memory 518 including a RAM or the like to store a control program and control data (parameter table); a non-volatile memory 519 such as a flash memory, a FROM or the like to store a control program and control data (parameter table); a combo-driver 520 including a VCM (Voice Coil Motor) driving controller, a spindle motor driver (SPM) drive controller and the like; a bus 515 of the MPU and the like.

The HGA 505 includes a slider 503 including a STO, a read/write element, a TFC and the like, and a high-rigidity suspension 504. The head driving controller 508 has a STO driving control function to generate a driving signal (driving current signal or driving voltage signal) to drive the STO, and includes a recording amplifier and a reproducing amplifier. The R/W channel 509 functions as a recording modulation unit and a RS (Reed Solomon) channel using Reed-Solomon codes as one kind of forward-direction error-correcting code, or a signal processing, reproducing modulation part such as a non-RS (Non Reed-Solomon) channel using the newest LDPC (low density parity check) code.

The HGA 505 is connected to the head driving controller 508 via a signal line, and selects one of the magnetic heads in response to a head selector signal based on a recording instruction or a reproducing instruction from a host (not illustrated) as a higher-level device for recording and reproducing. The R/W channel 509, the MPU 510, the HDC 511, the buffer memory controller 516, the host interface controller 517 and the memory 518 are configured as one LSI (SoC: System on Chip) 521. The LSI 512 includes a control plate with the LSI, a driver, a non-volatile memory and the like mounted thereon. If needed, the high-rigidity suspension and the high-rigidity arm may be made of a vibration-absorbing and suppressing body, to which a damper may be attached for further vibration suppression. The high-rigidity suspension 504 and the slider 503 may be preferably provided with a micro-position movement adjustment mechanism (dual stage actuator, micro-stage actuator) including a piezoelectric element, an electromagnetic element, a thermal deformation element or the like, because it enables high-speed and high-precision positioning for high-track density.

The MPU 510 is a main controller of the magnetic storage device, and performs servo control required for recording/reproducing operations and positioning of the magnetic heads. For instance, the MPU sets parameters required for such an operation at a register 514 included in the head driving controller 508. Each register, as described later, includes parameters set independently and as needed, the parameters including a predetermined temperature, a clearance control value for each perpendicular magnetic recording medium area (corresponding to TFC input power value), a STO driving current value, a preliminary current value, a recording current value, their overshoot values, timings, time constants for environmental change and the like.

The R/W channel 509 is a signal processing circuit. The R/W channel 509 outputs a signal 513 obtained by encoding recording information transferred from the disk controller 511 to the head driving controller 508 during information recording, and outputs a reproduction information, which is a reproduction signal output from the magnetic head 505, is amplified by the head driving controller 508 and then is decoded, to the HDC 511 during information reproduction.

The HDC 511 outputs a write gate to instruct the starting (recording timing) of information recording of the signal data 513 on the perpendicular magnetic recording medium to the R/W channel 509, thereby performing transfer control of recording/reproducing information, conversion of data format, and ECC (Error Check and Correction) processing.

The head driving controller 508 is a driving integrated circuit that, in response to the input of a write gate, generates at least one type of recording signal (recording current) at least corresponding to the recording data 513 supplied from the R/W channel 509 and supplies the recording signal together with a STO driving signal with a controlled current-application timing to the magnetic head. The head driving controller 508 includes at least a head driving circuit, a head driving current supplying circuit, a STO delay circuit, a STO driving current supplying circuit, a STO driving circuit and the like, and has a register including values set by the MPU, such as a recording current value, a STO driving current value, a TFC input power value and an operation timing. Each register value can be changed for each condition such as an area of the perpendicular magnetic recording medium, environment temperature, pressure or the like. The head driving controller preferably functions to supply bias recording current to the magnetic heads and starts a recording operation at timing of the write gate output from the HDC in response to a direct instruction from the MPU as an interface with the host system, the MPU controlling recording/reproducing operation (transfer of recording/reproducing data) and controlling positioning servo of the magnetic heads as a main controller of the magnetic storage device. In this way, the head driving controller can freely set operation timing of means that supplies bias recording current and recording signals and STO driving control means in response to the input from the MPU instructing an operation of the magnetic storage device and the input of a write gate instructing information recording, their current waveforms and current values, clearance control power and preliminary current and recording current to the recording poles. A temperature sensor is provided in the HDA, for example.

The drawing shows the case of including two perpendicular magnetic recording media and four magnetic head sliders, and one magnetic head slider may be provided for one perpendicular magnetic recording medium, or the number of the perpendicular magnetic recording medium or the magnetic head may be plural as needed suitably for the purpose. The magnetic storage device (HDD) casing including the HDA may be filled with He.

(How to Adjust Magnetic Storage Device)

Among the combination of the magnetic recording media and the microwave assisted magnetic recording heads described in Examples 1 to 5, four of the microwave assisted magnetic recording heads accepted in the selection test and two of the perpendicular magnetic recording media were mounted at 2.5″ or 3.5″ type HDA or magnetic storage device shown in FIG. 30, and predetermined servo information was recorded by a servo track writer or by a self servo write method.

In this servo information recording step, a servo track at a specific track pitch is formed in accordance with a specific track width of the magnetic head. In the present example, however, the magnetic storage device includes a plurality of magnetic heads each having a different recording track width, and so the track pitch is not always an optimum track pitch of another magnetic head having a different recording track width. Then, squeeze characteristics, Adjacent Track Interference (ATI) characteristics, Far Track Interference (FTI) characteristics, 747 characteristics and the like are evaluated for each magnetic head in the manufacturing process of a magnetic storage device, thus finding an optimum data track pitch (track profile) and finding a conversion equation from the servo track profile, and then a data track profile of a perpendicular magnetic recording medium is determined in accordance with this conversion equation. At this data track, user data is recorded/reproduced by a magnetic head positioned by the servo information and this conversion equation, and the data track is made up of a plurality of data sectors including a preamble servo part, a data part of 512 B or 4 kB, a parity, an ECC and CRC (Cyclic Redundancy Check) part and a data sector gap part.

Finally, margin is given to each other among magnetic heads and zones so that the error rate becomes substantially uniform at the entire zone of all magnetic heads in the range giving predetermined surface recording density, and their track density and linear recording density profile are determined (adaptive formatting) so as to achieve the best performance for the magnetic storage device as a whole. Then, such a parameter is stored in a memory as needed, thus configuring a magnetic storage device having predetermined capacity, and learning of necessary parameters for device operation is performed for each magnetic head.

Herein the width of the STO may be two or three times the recording track width, and the track pitch for magnetic recording may be ½ to ⅓ of the STO width so that recording is performed with a predetermined recording track width of the device to be a so-called shingle recording type magnetic storage device.

(How to Control Magnetic Storage Device)

The following describes a method for controlling of the present invention that is for recording/reproducing with respect to a magnetic storage device using the aforementioned data. In response to an instruction to record/reproduce information from a host or a higher-level system such as a PC and under the control of the MPU 510 as a main controller of the magnetic storage device, the perpendicular magnetic recording medium 501 is rotated by the spindle motor 500 at a predetermined number of revolutions. Then, a magnetic head Hₖ to perform recording/reproducing of predetermined information detects a position on the medium using a reproducing signal from servo information on the perpendicular magnetic recording medium. Based on the positional signal, a trace to a target position is calculated, and the VCM drive controller of the drive controller 520 controls a VCM 522, thus moving (seek operation) the high-rigidity actuator 506 and the magnetic recording head HGA 505 to a predetermined recording track at a predetermined zone 4 of the perpendicular magnetic recording medium rapidly and precisely, thus allowing the magnetic head to follow to the track position. Then, recording/reproducing of information is performed as follows by a firmware program of the MPU at a predetermined sector Sⱼ on the track.

For information recording, the host interface controller 517 receives a recording instruction from the host and recording data. Then, the MPU 510 decodes the recording instruction, and stores the received data in buffer memory if needed. In the case of a RS channel, after the addition of CRC at the HDC 511 and conversion of Run-Length Limited (RLL) coding, ECC coding is added. Then, the addition of parity and write precompensation, for example, are performed by a recording/modulation system of the R/W channel 509, thus forming recording data. In the case of a non-RS channel, after the addition of CRC at the HDC and conversion of RLL coding, LDPC is added by a R/W channel and write precompensation, for example, is performed, thus forming recording data.

Next, a write gate to instruct the starting (recording timing) of data recording by the magnetic head Hₖ (503) of the signal data 513 at sector Sⱼ on the perpendicular magnetic recording medium is issued from the HDC to the R/W channel 509, whereby a recording signal (recording current) corresponding to the signal data 513 supplied from the R/W channel 509 is generated in response to the input of the write gate, the recording current together with a STO driving signal (driving current signal or driving voltage signal) with a controlled current-application timing is supplied to the recording head part of the magnetic head Hₖ via FPC wiring 507, and so recording is performed by microwave assisted magnetic recording at sector Sᵢ in the recording track of the predetermined zone on the perpendicular magnetic recording medium. Herein, the optimum values SP_{TFC}(k,m), SI_{WB}(k,m) and SI_{STO}(k,m,n) of the TFC input power, the bias recording current and the STO driving current for magnetic head Hₖ at zone Zₚ, which are found by the above step, are stored in the register of the head driver from the memory, and the microwave assisted magnetic recording head is driven as follows using such data.

For information reproducing, the host interface controller 517 receives a reproduction instruction from the host. Then, the magnetic head Hₖ (503) selected and positioned similarly to the recording and having clearance controlled for reproduction reads a reproduction signal. The reproduction signal is then amplified by R/W-IC and is transferred to the R/W channel 509 such as a RS channel using Reed Solomon (RS) code or a non-RS channel using LDPC code. In the case of the RS channel, decoding by signal processing, decoding of parity and the like are performed, and then the HDC performs error correction by ECC, RLL decoding and checking the presence or not of an error by CRC. In the case of the non-RS channel, an error is corrected by LDPC in the R/W channel, and then the HDC performs RLL decoding and checking the presence or not of an error by CRC. Finally, such information is buffered in a buffer memory 521, and is transferred, as reproduction data, from the host interface controller 517 to the host. In this way, the magnetic storage device of the present invention is configured.

(Advantageous effect)

Due to the effect of microwave assisted recording, the magnetic storage device of the present example achieved sufficient read/write characteristics on a magnetic recording medium having high Hk, on which recording fails by the conventional technique as stated above. A reliability acceleration evaluation test by continuous seeking for anti-wear resistance showed that the magnetic storage device had characteristics equal to or more of the conventional magnetic storage device in terms of flyability of a magnetic recording head and anti-wear reliability.

The magnetic storage device of the present example including the magnetic recording medium and the microwave assisted recording head of Examples 1 to 5 of the present invention mounted thereon had assembly yield of the device that was higher by 5 to 15% than the perpendicular magnetic recording medium having a single period as the comparative example described in the section of advantageous effect in Example 1. When a medium having reduced mixture at the interface by multi-target sputtering of the present invention and a medium having a large number of lamination units were mounted, the device assembly yield was higher by 10 to 15% than the comparative example, which was especially preferable. Such a large difference in the device manufacturing yield from the magnetic recording medium as the comparative example, which was subjected to similar selection, was due to a large temperature change of Hk for a magnetic supper lattice, and so the medium as the comparative example had a high rejection rate in the temperature test of the device.

In the case of a He-filled magnetic storage device, the power consumption thereof was reduced more by 20% than the conventional device, and larger capacity by about 30% also was obtained by increasing the packaging density of the magnetic recording medium of the present invention. Then power consumption per unit capacity was reduced more by 45% than the conventional technique, and so such a structure was especially preferable.

Further when the magnetic storage device of the present example included the magnetic recording medium of the present example mounted thereon, the error rate was not degraded also in a high-temperature/high-humidity test at 60° C. and 90% RH, and so high reliability was shown.

### Example 7

(How to Adjust Magnetic Storage Device)

The present example describes how to adjust environmental temperatures for the magnetic storage device of Example 6.

The parameter table of Example 6 registers, as initial values, the control values at a room temperature (30° C.) in the device. Actually, however, the value of clearance changes due to thermal expansion when the temperature changes. Further, coercive force of perpendicular magnetic recording has large temperature dependency of about 20 Oe/° C., meaning that coercive force decreases as the temperature increases, and so it becomes easy to record, and so read/write characteristics deteriorate. On the other hand, at a low temperature, the coercive force increases, meaning difficulty in recording. Then the present example performs readjustment of control values in accordance with a change in temperature environment of the device.

That is, clearance evaluation test and read/write characteristics test were performed at various temperatures beforehand using a magnetic storage device separately assembled, and a conversion equation to a control value per unit temperature change was found by experiments. Finally, this parameter was incorporated into the parameter table of the magnetic recording device, and then a firmware program was created for temperature correction in accordance with such a table.

When the environment temperature of the magnetic storage device in actual operation changed, a temperature sensor provided in the device reads a temperature T, and a temperature difference ΔT from the room temperature was calculated. Then, a compensation value was added to the initial value to set an optimized control value for compensating a change in temperature environment of the device. That is, the TFC input power has temperature dependency such that the value increases as the temperature drops and the value decreases as the temperature rises, and the bias current is made substantially constant. The STO driving current has temperature dependency such that the value increases as the temperature drops and the value decreases as the temperature rises. Resonance of the mechanical system also changes greatly with temperatures, and so a thermal notch filter having characteristics changing with temperatures was concurrently introduced so as to suppress influences of Non-repeatable Run-Out (NRRO), thus learning as needed and configuring a more stable control system to position magnetic heads.

(Advantageous Effect)

The aforementioned control value readjustment against temperature change further improved recording performance especially at a low temperature, and so a magnetic material having higher magnetic performance (having higher anisotropic field and coercive force) was used and the flexibility of design was greatly improved. Actually a magnetic layer with decreased thickness increased the coercive force by about 10%, and so the average error rate was improved by about 1 digit.

The magnetic recording medium of the present invention including the lamination of ultra-thin magnetic films has larger temperature dependency of the magnetic characteristics than the conventional medium, and so it is especially effective to perform compensation of control values for temperature change at a device level so as to be suitable for the medium characteristics of the present invention. Such a control method, even considering variations in manufacturing, realized margin for FTI, ATI and the like at a high temperature of 65° C., or recording/reproducing was performed without problems at −5° C. In this way no errors occurred in a wide temperature range from −5° C. to +65° C., and so the reliability of the magnetic storage device was achieved.

The present control method increased the yield of the magnetic head described in Examples 1 to 5 by 8 to 15% and the yield of the magnetic recording medium by 2 to 5%. Similarly to Example 6, when a medium having reduced mixture at the interface by multi-target sputtering of the present invention and a medium having a large number of lamination units (ie, magnetic layers) were mounted, then the yield of the magnetic head was higher by 12 to 15% than the comparative example and the yield of the medium was higher by 4 to 5%, which was especially preferable.

The present invention is not limited to the above-described examples, and may include various modification examples. For instance, the entire detailed configuration of the embodiments described above for explanatory convenience is not always necessary for the present invention. A part of one embodiment may be replaced with the configuration of another embodiment, or the configuration of one embodiment may be combined with the configuration of another embodiment. The configuration of each embodiment may additionally include another configuration, or a part of the configuration may be deleted or replaced.

### REFERENCE SIGNS LIST

02: Thermal expansion element portion (TFC)
10: Reading head part
12: Sensor element
20: Recording head part
22, 122: First recording pole
24, 124: Second recording pole
26: STO oscillation control magnetic field
40: High-frequency oscillation element unit (STO)
41: High frequency magnetic field generation layer (FGL)
43: Spin injection layer
45: High frequency magnetic field
50: Slider
100: Head traveling direction
130: Magnetic recording medium
133: First magnetic layer
139: Second magnetic layer
134: Third magnetic layer
500: Spindle motor
505: Head Gimbal Assembly (HGA)
506: Head Stack Assembly (HSA)
522: Voice Coil Motor (VCM)

1. A perpendicular magnetic recording medium, comprising:
a recording layer including a plurality of magnetic layers on a substrate;
wherein
a magnetic layer as an uppermost layer of the recording layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer, and the magnetic layer as the uppermost layer includes a plurality of lamination unit layers each having different composition of sub-layers or a different film thickness.

2. The perpendicular magnetic recording medium according to claim 1, wherein
a lamination unit that is the closest to a surface of the medium has highest perpendicular magnetic anisotropy field Hk in the magnetic layer as the uppermost layer.

3. The perpendicular magnetic recording medium according to claim 1, wherein
the sub-layers include at least 1 volume % or more and 35 volume % or less of a non-magnetic material including an oxide, a nitride, a carbide or a boride of at least one type of element selected from a first group consisting of Si, Ta, Ti, Zr and Hf or a mixture of the foregoing.

4. The perpendicular magnetic recording medium according to claim 1, wherein
a set of the sub-layers include at least two types of sub-layers selected from a Co-based alloy, a Ni-based alloy and a Fe-based alloy including 50 at % or more of Co, Ni and Fe, respectively.

5. The perpendicular magnetic recording medium according to claim 1, wherein
the lamination unit of the magnetic layers includes lamination of sub-layers including (1) or (2):
(1) a thin film including at least one type of material selected from a Co-based alloy, a Ni-based alloy and a Fe-based alloy including 50 at % or more of Co, Ni and Fe, respectively; and
(2) a thin film including a material including 50% or more of at least one type of element selected from a third group consisting of Ru, Os, Rh, Ir, Pd, Pt, Ag and Au.

6. The perpendicular magnetic recording medium according to claim 1, wherein
the plurality of lamination unit layers have different compositions of sub-layers of at least one sub-layer among the lamination unit layers.

7. The perpendicular magnetic recording medium according to claim 1, wherein
the plurality of lamination unit layers have different film thicknesses of at least one sub-layer among the lamination unit layers.

8. The perpendicular magnetic recording medium according to claim 1, further comprising an underlayer in contact with a lowermost magnetic layer of the recording layer, the underlayer including 50% or more of at least one type of elements selected from a third group consisting of Ru, Os, Rh, Ir, Pd, Pt, Ag and Au, and a material of the following (1) or a material of the following (1) and a material of the following (2), and the underlayer being a (111) oriented thin film having a fcc structure:
(1) a material including 0.1 at % or more in total and 25 at % or less singly of at least one type of element selected from a second group consisting of Au, Cr, Ti, Zr, Hf, V, Nb, Ta, Ru, Os, Pd, Pt, Rh and Ir, and not included in the third group; and
(2) a material including at least 1 volume % or more and 35 volume % or less of a non-magnetic material including an oxide, a nitride, a carbide or a boride of at least one type of element selected from a first group consisting of Si, Ta, Ti, Zr and Hf or a mixture of the foregoing.

9. The perpendicular magnetic recording medium according to claim 1, wherein
a magnetic layer at a lowermost part of the recording layer includes an oxide, a nitride, a carbide or a boride of at least one type of element selected from a first group consisting of Si, Ta, Ti, Zr and Hf or a mixture of the foregoing, and is a thin film including a L1₁ type Co_{0.5}Pt_{0.5}-based ordered alloy or a m-D0₁₉ type Co_{0.8}Pt_{0.2} having a degree of ordering of 0.4 or more and 0.6 or less.

10. The perpendicular magnetic recording medium according to claim 1, wherein
a magnetic layer at an intermediate part or a magnetic layer at a lowermost part of the recording layer includes a thin film having a Co-based alloy granular structure, including 1 volume % or more and 35 volume % or less of an oxide, a nitride, a carbide or a boride of at least one type of element selected from a first group consisting of Si, Ta, Ti, Zr and Hf or a mixture of the foregoing.

11. The perpendicular magnetic recording medium according to claim 1, wherein
the plurality of magnetic layers of the recording layer each include a magnetic superlattice thin film including a set of sub-layers.

12. A magnetic storage device, comprising:
a magnetic recording medium;
a recording head including: a recording pole to generate recording field to write information on the magnetic recording medium; a high frequency magnetic field oscillation element disposed in the vicinity of the recording pole; and a magnetic read element to read information from the magnetic recording medium; and
a controller that controls a recording operation by the recording pole and the high frequency magnetic field oscillation element and a reading operation by the magnetic read element, wherein
the magnetic recording medium includes a plurality of magnetic layers on a substrate, wherein a magnetic layer as an uppermost layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer, and the magnetic layer as the uppermost layer includes at least two types of lamination unit layers each having different composition of sub-layers or a different film thickness of sub-layers.

13. The magnetic storage device according to claim 12, wherein
the high frequency magnetic field oscillation element includes a high-frequency magnetic field generation layer and a spin injection layer,
the high-frequency magnetic field generation layer has a height 1.5 times or more as long as a width, and
the spin injection layer includes two magnetic layers that are stacked via a non-magnetic intermediate layer so that the magnetic layers have mutually antiparallel magnetization.

14. The magnetic storage device according to claim 13, wherein
the magnetic recording medium includes: a soft magnetic underlayer; and a magnetic intermediate layer to control crystalline orientation disposed between the soft magnetic underlayer and recording layer including the plurality of magnetic layers.

15. The magnetic storage device according to claim 12, wherein
the high frequency magnetic field oscillation element includes a spin injection layer, a high-frequency magnetic field generation layer and an intermediate layer disposed between the spin injection layer and the high-frequency magnetic field generation layer, and
the intermediate layer has a thickness of more than 4 nm and 20 nm or less.

16. The magnetic storage device according to claim 12, wherein
the high frequency magnetic field oscillation element includes a spin injection layer having a magnetic anisotropy axis that is perpendicular to a film plane thereof, a high-frequency magnetic field generation layer having a magnetic easy plane at a film plane thereof effectively and a non-magnetic intermediate layer disposed between the spin injection layer and the high-frequency magnetic field generation layer,
the non-magnetic intermediate layer has a thickness of more than 4 nm and 20 nm or less, and
current is applied from the high-frequency magnetic field generation layer toward the spin injection layer.

17. The magnetic storage device according to claim 12, wherein
sufficient recording fails on the perpendicular magnetic recording medium only with recording field from the recording pole.

18. The magnetic storage device according to claim 12, further comprising a temperature sensor therein, wherein a value of recording current to excite the recording pole and a value of driving current of the high frequency magnetic field oscillation element are readjusted in accordance with a change in temperature environment of the device.

19. A method for manufacturing a perpendicular magnetic recording medium including a recording layer including a plurality of magnetic layers on a substrate; wherein a magnetic layer as an uppermost layer of the recording layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer, and the magnetic layer as the uppermost layer includes a plurality of lamination unit layers each having different composition of sub-layers or a different film thickness, the method comprising the steps of:
forming the first sub-layer using a first multi-sputtering target; and
forming the second sub-layer using a second multi-sputtering target,
wherein
an interval between ending time of the step to form the first sub-layer and starting time of the step to form the second sub-layer is 0.5% or longer of shorter time between film formation time of the first sub-layer and film formation time of the second sub-layer.

20. A method for manufacturing a perpendicular magnetic recording medium including a recording layer including a plurality of magnetic layers on a substrate; wherein a magnetic layer as an uppermost layer of the recording layer includes three or more of sub-layers each having thickness of more than 0 and 1 nm or less, the sub-layers including a first sub-layer and a second sub-layer to make up a lamination unit layer, the first sub-layer including, as a major element, 50% or more of at least one type of element selected from the group consisting of Co, Fe and Ni, the second sub-layer including, as a major element, an element different from the major element of the first sub-layer, and the magnetic layer as the uppermost layer includes a plurality of lamination unit layers each having different composition of sub-layers or a different film thickness of sub-layers, the method comprising the steps of:
forming the first sub-layer by co-sputtering of a first sputtering target including the major element of the first sub-layer as a major component and a second sputtering target including a non-magnetic material including an oxide, a nitride, a carbide or a boride of at least one type of element selected from the group consisting of Si, Ta, Ti, Zr and Hf or a mixture of the foregoing; and
forming the second sub-layer by co-sputtering of a third sputtering target including the major element of the second sub-layer as a major component and the second sputtering target,
wherein
in the step of forming the first-sub layer, film formation starting time by the second sputtering target is later than film formation starting time by the first sputtering target, and film formation ending time by the second sputtering target is earlier than film formation ending time by the first sputtering target, and
in the step of forming the second-sub layer, film formation starting time by the second sputtering target is later than film formation starting time by the third sputtering target, and film formation ending time by the second sputtering target is earlier than film formation ending time by the third sputtering target.

21. A multi-sputtering target including a non-magnetic material including an oxide, a nitride, a carbide or a boride of at least one type of element selected from the group consisting of Si, Ta, Ti, Zr and Hf or a mixture of the foregoing, wherein the multi-sputtering target is used for film formation in combination with another multi-sputtering target including at least another one type of material.

22. A multi-sputtering target, comprising:
50 at % or more of at least one type of element selected from a third group consisting of Ru, Os, Rh, Ir, Pd, Pt, Ag and Au; and
0.1 at % or more in total and 25 at % or less singly of at least one type of element selected from a second group of additives consisting of Au, Cr, Ti, Zr, Hf, V, Nb, Ta, Ru, Os, Pd, Pt, Rh and Ir, from which an element overlapping with the element selected form the third group is excluded.

23. A multi-sputtering target, comprising:
50 at % or more of at least one type of element selected from the group consisting of Ru, Os, Rh, Ir, Pd, Pt, Ag and Au; and
at least 2 volume % or more and 10 volume % or less of a non-magnetic material including an oxide, a nitride, a carbide or a boride of an element selected from the group consisting of Si, Ta, Ti, Zr and Hf or a mixture of the foregoing.

24. A multi-sputtering target, comprising:
50% or more of at least one type of element selected from a third group consisting of Ru, Os, Rh, Ir, Pd, Pt, Ag and Au;
0.1 at % or more in total and 25 at % or less singly of at least one type of element selected from a second group of additives consisting of Au, Cr, Ti, Zr, Hf, V, Nb, Ta, Ru, Os, Pd, Pt, Rh and Ir, from which an element overlapping with the element selected form the third group is excluded; and
at least 2 volume % or more and 10 volume % or less of a non-magnetic material including an oxide, a nitride, a carbide or a boride of an element selected from a first group consisting of Si, Ta, Ti, Zr and Hf or a mixture of the foregoing.

25. A multi-sputtering target, comprising: any one of Co, Ni and Fe, and 0.1 at % or more in total and 25 at % or less singly of at least one type of element selected from the group consisting of Au, Cr, Ti, Zr, Hf, V, Nb, Ta, Ru, Os, Pd, Pt, Rh and Ir.

26. A multi-sputtering target, comprising: any one of Co, Ni and Fe, and at least 2 volume % or more and 10 volume % or less of a non-magnetic material including an oxide, a nitride, a carbide or a boride of an element selected from the group consisting of Si, Ta, Ti, Zr and Hf or a mixture of the foregoing.

27. A multi-sputtering target, comprising: any one of Co, Ni and Fe, and 0.1 at % or more in total and 25 at % or less singly of at least one type of element selected from the group consisting of Au, Cr, Ti, Zr, Hf, V, Nb, Ta, Ru, Os, Pd, Pt, Rh and Ir, and,
at least 2 volume % or more and 10 volume % or less of a non-magnetic material including an oxide, a nitride, a carbide or a boride of an element selected from the group consisting of Si, Ta, Ti, Zr and Hf or a mixture of the foregoing.
